(19) United States
(12) Patent Application Publication
(10) Pub. No.: US 2025/0389407 A1
(43) Pub. Date: Dec. 25, 2025

(54) ROUND METAL HOUSING FOR A LIGHTING SYSTEM

(71) Applicant: DMF, Inc., Carson, CA (US)

(72) Inventors: Frederick William Kopitzke, Long Beach, CA (US); Ken Czech, Redondo Beach, CA (US); Bao Khoa Vinh, Garden Grove, CA (US); Amir Lotfi, Redondo Beach, CA (US); Morteza Nejad, Rancho Palos Verdes, CA (US)

(73) Assignee: DMF, Inc., Carson, CA (US)

(21) Appl. No.: 19/032,625

(22) Filed: Jan. 21, 2025

Related U.S. Application Data
(63) Continuation of application No. 17/378,214, filed on Jul. 16, 2021, now Pat. No. 12,203,631.
(60) Provisional application No. 63/052,915, filed on Jul. 16, 2020.
(60) Provisional application No. 63/061,160, filed on Aug. 4, 2020.
(60) Provisional application No. 63/123,334, filed on Dec. 9, 2020.

(51) Int. Cl. F21V 15/01; F21S 8/04; H02G 3/12

(52) U.S. Cl. CPC F21V 15/01; F21S 8/04; H02G 3/12

(57) ABSTRACT

A housing assembly for a lighting system includes a single metal housing that functions as a can housing and a junction box and has a round geometry to improve ease of installation and support trims with smaller flanges. The housing includes a top component and one or more sidewall components. The sidewall component defines the desired round shape of the housing while the top component provides one or more flat surfaces to support one or more knockout features. For a remodel installation, the housing assembly further includes a spring clip assembly with a mounting ring and multiple spring clamps to securely couple the housing assembly to a drywall panel of a ceiling. For a new construction installation, the housing assembly further includes a bar hanger assembly to couple the housing to one or more support structures within the ceiling.

### CROSS-REFERENCE TO RELATED APPLICATION(S)

The present application is a continuation of U.S. Non-Provisional application Ser. No. 17/387,214, filed Jul. 16, 2021, entitled “ROUND METAL HOUSING FOR A LIGHTING SYSTEM,” which claims priority to U.S. Provisional Application No. 63/123,334, filed Dec. 9, 2020, entitled “ROUND HOUSING FOR AN ELECTRICAL ASSEMBLY OR A LIGHTING ASSEMBLY,” U.S. Provisional Application No. 63/061,160, filed Aug. 4, 2020, entitled “ROUND HOUSING FOR A LIGHTING SYSTEM,” and U.S. Provisional Application No. 63/052,915, filed Jul. 16, 2020, entitled “ROUND HOUSING FOR A LIGHTING SYSTEM.” Each of the aforementioned applications is incorporated by reference herein in its entirety.

### BACKGROUND

A conventional lighting system (also referred to herein as a “lighting fixture”) typically includes a housing (also referred to as an “enclosure”) to contain a lighting module, which includes a light source, a driver, and/or one or more wires. The housing is typically supported by various components (e.g., a pan frame, bar hanger holders, bar hangers) to form a housing assembly. The supporting components include mounting features to facilitate installation of the housing assembly onto one or more support structures in the environment. The mounting features often vary depending on the type of installation (e.g., a remodel lighting fixture, a new construction lighting fixture) and the type of support structure disposed in the environment to support the housing assembly.

For example, a conventional housing assembly for a recessed lighting system typically includes a can housing to contain a light source and a junction box to receive and contain wires from an electrical power supply of a building and wire splices to electrically couple the wires to the light source.

In a new construction installation, the can housing and the junction box are generally supported by a pan frame and one or more adjustable bar hanger assemblies coupled to the pan frame to mount the housing assembly to various support structures located within a ceiling (e.g., a wood joist or stud, a metal joist or stud, a T-bar). Each bar hanger assembly generally includes (1) a pair of telescopically adjustable bar hangers slidably coupled to the pan frame and (2) a bar hanger head on each bar hanger with one or more mounting features to couple to various support structures. Once the housing assembly is mounted to the support structures, a piece of drywall panel is then installed to cover the ceiling and an opening is then cut to expose the housing. A lighting module may then be inserted into the housing with a trim to cover the opening formed in the ceiling.

In a remodel installation, the can housing and the junction box are supported by a frame and the housing assembly is inserted directly through an opening formed in the drywall panel previously installed in the ceiling. Said in another way, a remodel installation does not require access to support structures disposed within the ceiling for installation. The can housing typically includes multiple spring clips to directly mount the housing assembly to the drywall panel. Once the housing assembly is mounted to the drywall panel, the lighting module and the trim may be installed in the same manner as in the new construction installation.

### SUMMARY

The Inventors, via previous innovative designs of lighting systems, have recognized and appreciated recessed lighting systems offer several benefits for ambient and task lighting including, but not limited to, making the environment appear larger (e.g., low ceiling environments), greater flexibility in tailoring lighting conditions (e.g., wall wash, directional, accent, general lighting), and fewer limitations on the installation location (e.g., a sloped ceiling, a vaulted ceiling, a wall). However, the Inventors have also recognized several limitations in the design and use of conventional housing assemblies for recessed lighting systems.

First, conventional housing assemblies often include multiple housings to contain various components of a recessed lighting system. For example, a typical housing assembly includes a can housing to contain a light source, a junction box to contain various wiring connections, and a frame to mechanically support the can housing and the junction box. The inclusion of multiple housings results in more parts and sub-assemblies in the housing assembly, which, in turn, increases manufacturing time and cost. Additionally, conventional housing assemblies with multiple housings are often bulky in size and thus less easy to handle during installation. The separation of electrical wiring connections from the light source may also make maintenance of the lighting system more challenging since access to the junction box may be blocked once the drywall panel of the ceiling is installed.

In some applications, it may also be desirable for the housing assembly to meet various fire-rating standards set forth, for example, by the National Electric Code (NEC) or the Underwriter's Laboratory (UL). For conventional housing assemblies, an additional fire-rated enclosure (e.g., a firebox) is often included to enclose the can housing further increasing the overall size of the housing assembly and further limiting installation in smaller spaces.

Second, the housings in conventional housing assemblies for recessed lighting systems are often formed from sheet metal. A metallic housing provides a mechanically strong and durable enclosure to support a light source. The metallic housing is also able to withstand higher operating temperatures in response to the heat generated by the light source. Additionally, the metallic housing may provide a convenient electrical ground for the lighting module. However, housings formed from sheet metal are generally limited to relatively simple geometries with a limited set of structural features. This is due, in part, to conventional sheet metal forming processes being unsuitable for the production of complex-shaped components, such as a housing with rounded, enclosed walls with protruding structural features and/or flat sections. The formation of more complex structural features often entails additional processing steps, which can result in appreciably higher manufacturing costs.

For this reason, conventional junction boxes for recessed lighting systems are often polygonal in shape with flat sides supporting multiple knockout features. The junction boxes for recessed lighting systems are also often enclosed structures and, thus typically include a mechanism to open one side of the junction box for access, further adding complexity. In comparison, conventional can housings are often round in shape, but tend to have few, if any structural features along its respective surfaces.

The Inventors acknowledge housing assemblies with a single housing that combines together the functions of a can housing and a junction box have been demonstrated. However, the Inventors also recognized housing assemblies with a single housing are generally polygonal in shape similar to conventional junction boxes due, in part, to the integration of various cable routing features, such as knockouts, which are difficult to incorporate on a housing with a round shape. For example, the housing may have a square or an octagonal cross-sectional shape.

Although polygonal-shaped housings may reduce manufacturing costs, installation of such housings may be more challenging compared to round-shaped housings. For example, an installer may be required to cut an opening in the drywall panel of a ceiling or wall that corresponds in shape to the polygonal cross-section of the housing. A polygonal-shaped opening may be more challenging to cut compared to a round-shaped opening as the installer may be more prone to overshooting a vertex of the polygon when cutting the opening, resulting in a larger-sized opening in the drywall panel.

Additionally, the installer may also be required to cut a larger opening in the drywall panel to compensate for the polygonal-shaped housing compared to a round-shaped housing. For example, a round-shaped housing may have a characteristic diameter suitable to contain a round-shaped lighting module. The polygonal-shaped housing may thus have a width greater than or equal the characteristic diameter of the round-shaped housing to accommodate the same round-shaped housing, which results in a larger opening due to the corners of the polygonal-shaped housing. This may be compensated, in part, by the installation of a trim with a larger flange to cover the larger polygonal-shaped opening formed in the drywall panel. However, a trim with a larger flange may require more clearance in the environment (e.g., a lighting system installed in a ceiling may not be placed near a wall). The trim may also require more material for manufacture, thus increasing material costs. Additionally, a trim with a larger flange may not be aesthetically desirable. Said in another way, a lighting system with a polygonal-shaped housing supporting a light source may be unable to support a trim with a smaller flange without exposing a portion of the housing and/or limiting the margin for error when the installer is cutting the opening in the drywall panel.

In view of the foregoing limitations of conventional housings and housing assemblies, the present disclosure is directed to various inventive implementations of housing assemblies for a lighting system with a round-shaped metallic housing (also referred to herein as a “multi-piece housing” or an “outer casing”) configured to contain both a light source and associated electrical connections. This may be accomplished, in part, by assembling the housing from a sidewall component(s) and a top component that are separately fabricated. The sidewall component(s) defines the desired round shape of the housing. In some implementations, the housing may include a single sidewall component or as an assembly of two or more sidewall components. The top component encloses one end of the sidewall and may define the various junction box-related structural features disposed along the top and/or sides of the housing, such as circular trade size knockouts and Romex knockouts.

By strategically separating the desired structural features of the housing in this manner, the housings described herein may provide (1) the functionality of both a can housing and a junction box integrated into a single housing, thus simplifying the housing assembly, (2) a round-shaped geometry to facilitate greater ease of installation and support for trims with smaller flanges, and (3) a top component and a sidewall component that individually remain relatively simple in design and, hence, readily manufacturable using conventional sheet metal forming processes using few processing steps.

In one aspect, the integration of can housing-related structural features and junction box-related structural features into one housing may appreciably simplify the housing assembly, in part, by reducing the number of components in the housing assembly. For example, the housing assemblies described herein may not include a separate junction box or a frame (e.g., a pan frame). Instead, the housing assembly may only include mounting components directly coupled to the housing to facilitate installation of the housing onto one or more support structures in the ceiling space or the drywall panel of the ceiling. The simplified housing assembly may also be more compact in size and, hence, able to accommodate smaller ceiling spaces compared to conventional housing assemblies. Additionally, the housing assembly may be lighter in weight, thus improving ease of handling during installation.

Although the housing may contain a light source and associated electrical connections, it should be appreciated that the housing may still be used together with a pan frame and a separate junction box in some installations. For example, a junction box may provide wiring connections for multiple housings and/or lighting systems. In another example, the lighting system may include a ballast containing a battery to provide an alternate source of electrical power to the light source in the event the electrical power supplied by an external power supply system (e.g., building mains) is disrupted. Thus, the housing and the emergency ballast may both be mounted on a pan frame. Additionally, it should be appreciated that, in some applications, the housing assemblies described herein may also be used as a standalone electrical outlet box (also referred to as a “junction box” or an “electrical junction box”). For example, the housing may contain various electrical wires and wire connections (e.g., wire splices) and the housing assembly may include a cover plate to enclose the opening formed on the ceiling instead of a trim.

In another aspect, the round shape of the housing may improve the ease of installation of the housing assembly and may more readily accommodate round trims with a smaller flange. Specifically, the bottom portion of the sidewall disposed near or within the opening formed in the ceiling after installation may have a round shape. Thus, the opening formed in the ceiling may similarly have a round shape. In some implementations, the sidewall may have a circular cross-sectional shape. More generally, the cross-section of the sidewall may include, but is not limited to, a circular section, an elliptical section, a straight section, or any combination of the foregoing.

The round-shaped opening formed in the ceiling may be easier to cut compared to previous polygonal shaped housings. The round shaped housing may also support a round-shaped trim with a smaller flange (e.g., a flange where the difference between an inner radius and an outer radius of the flange is less than or equal to ½ inch) to cover the opening in the ceiling while still providing the installer room to overshoot when cutting the opening in the drywall panel. Additionally, the round-shaped housing may more readily conform in shape with a round-shaped lighting module, which, in turn, may result in a smaller opening formed in the drywall compared to a polygonal-shaped housing with a similar characteristic width.

In some implementations, the cross-sectional shape of the sidewall may remain substantially similar or the same from the bottom end to the top end. For example, the sidewall component(s) forming the sidewall may be shaped as a tube. However, it should be appreciated that, in some implementations, a portion of the sidewall may be substantially flat in shape to accommodate one or more knockouts. For example, the top portion of the sidewall may include one or more flat sections to accommodate corresponding knockouts formed on corresponding tabs of the top component. In some implementations, the sidewall component(s) may have notches to provide space for corresponding tabs of the top component during assembly of the sidewall component(s) and the top component.

In some implementations, the housing may be dimensioned to accommodate a particular trade size housing assembly and/or lighting system (e.g., a 2-inch trade size lighting installation, a 3-inch trade size lighting installation, a 4-inch trade size lighting installation, a 5-inch trade size lighting installation, a 6-inch trade size lighting installation, a 7-inch trade size lighting installation, an 8-inch trade size lighting installation). For example, the housing may be 4-inch trade size housing that fits within an opening having a diameter of approximately 4 inches. In some implementations, the housing may have an exterior width of about 4.2 inches. More generally, the exterior width may range between about 4 inches and about 4.5 inches. In some implementations, the housing may have an exterior height of about 4.5 inches. More generally, the exterior height may range between about 4 inches and about 5 inches.

The housing may also be dimensioned to provide a sufficiently large volume to contain a lighting module, at least a portion of a trim, a desired number of electrical wires of a particular gauge, and a desired number of wire splices. In some implementations, the housing may be dimensioned such that, after a lighting module and a trim are inserted into the cavity of the housing, the remaining portion of the cavity provides a volume allowance to contain a specific number of wires of a particular gauge as specified by Article 314 of the 2020 NEC and, in particular, Section 314.16 entitled, “Number of Conductors in Outlet, Device, and Junction Boxes, and Conduit Bodies.” For example, the housing may be dimensioned to provide a volume allowance to contain at least nine 12 AWG wires after a lighting module and a trim are installed.

In some implementations, the housing in the housing assembly may be tailored for a remodel installation where the housing assembly is inserted through an opening in a drywall panel and directly mounted to the drywall panel without requiring removal of the drywall panel. For remodel installations, the housing may not include knockouts formed along the side of the housing to prevent misuse and/or an improper installation. The housing assembly may include a mounting ring with a flange disposed around the bottom end of the housing to abut an bottom surface of a drywall panel. The housing assembly may further include one or more spring clips that are actuated from within the cavity of the housing such that a bent portion of the spring clips physically contacts a top surface of the drywall panel. As a result, the flange and the spring clips together clamp the housing assembly to the ceiling.

In some implementations, the housing in the housing assembly may be tailored for a new construction installation where the housing assembly is installed into a ceiling space prior to be enclosed by a drywall panel. Compared to the remodel installation, the housing for a new construction installation may include knockouts disposed along the sides of the housing. The housing assembly may further include a bar hanger assembly with one or more pairs of bar hangers, a crossmember (or bar hanger head), and bar hanger holders to couple the bar hangers to the housing. Each pair of bar hangers may be telescopically coupled to one another and slidably coupled to the bar hanger older, which enables the bar hangers to traverse a gap between the support structures and the respective crossmembers (or bar hanger heads) for attachment. In some implementations, the bar hanger holders may also be slidably coupled to the housing along an axis different from the longitudinal axes of the bar hangers. For example, the bar hanger holders may be slidably coupled to the housing along a vertical axis while the bar hangers are movable along a horizontal axis. The bar hanger holders may further include a locking mechanism to lock the relative positions of the housing, the bar hanger holders, and the bar hangers.

For both new construction and remodel installations, the housing assemblies described herein may readily accommodate a drywall panel with a thickness ranging between about 0.25 inches and about 2.5 inches and, more preferably, between about 0.5 inches to about 1.75 inches. The housings may also generally provide tool-free adjustment features. For example, the housing a for a new construction installation may include a thumbscrew/nut to adjust the position of the housing relative to the bar hanger holders by hand. In another example, the housing for a remodel installation may include a hand-actuated spring clip to engage the drywall panel once the housing assembly is inserted through the opening of the drywall.

In some implementations, the housing may satisfy one or more standards set forth by various organizations including, but not limited to, the NEC, the UL, the American Society for Testing and Materials (ASTM), and the National Fire Protection Association (NFPA). For example, the housing may satisfy UL1598 for luminaires by providing, in part, a housing with sufficient electrical grounding, volume for sufficient number of wires and/or wire splices, and appropriate suitable connectors (e.g., UL listed connectors) for connection to the lighting module. In another example, the housing may satisfy UL514 for electrical junction boxes when fire-rating certification is desired. This may be accomplished, in part, by tailoring the housing so that only compliant components (i.e., components specified on a label as being compliant with the housing assembly) may be installed into the housing. In other words, the housing may only provide mounting features to support compliant components in order to prevent the installation of non-compliant components. The housing may further be insulation contact (IC) rated and/or sound-rated.

The top and sidewall components of the housing may generally be formed of various metals including, but not limited to, steel alloys (e.g., galvanized steel), aluminum, brass, copper, and any combinations of the foregoing. In some implementations, the thickness or gauge of the sidewall and top components may be thicker than conventional can housings and/or thinner than conventional electrical junction boxes. However, it should be appreciated that, in other implementations, the thickness of the housing may be similar to the thickness of conventional electrical junction boxes, particularly if the housing is being qualified as an electrical junction box (in addition to being qualified as a luminaire housing) in accordance with various NEC, UL, ASTM, and/or NFPA standards. The thickness and material may also vary depending on whether the housing is fire-rated. Typically, the sidewall and top components may have a larger thickness and/or greater galvanization (e.g., a thicker zinc coating) when fire-rated and a smaller thickness and/or less galvanization when not fire-rated. Generally, the thickness of the sidewall component and the top component may generally range between about 0.6 mm and about 2.0 mm when the sidewall and top components are formed from galvanized steel.

As noted above, the top and sidewall components may also be formed from sheet metal. Thus, various sheet metal forming processed may be utilized to fabricate the top and sidewall components. For example, the curved shape of the sidewall components may be formed using a rolling process to bend a sheet into the desired round shape and/or a deep drawing process where the sheet metal is radially drawn into a forming die with the desired curved geometry. The various knockouts formed on the top component may be formed via a stamping process. Furthermore, additional structural features may be more readily integrated into the sidewall component, especially the curved portions of the sidewall component, using the same or similar sheet metal forming processes, such as textured surfaces (e.g., a row of notches) and/or recessed/protruding lips. Once the top and sidewall components are fabricated, they may then be joined together using, for example, one or more rivet connections and/or welding.

Although the exemplary remodel and new construction installations of the housings and housing assemblies described herein are for a ceiling installation, it should be appreciated the same or similar housings and housing assemblies may be installed on a wall or a floor. Furthermore, the housings and housing assemblies are not limited for use with a drywall panel, but may also be used with a wood panel, and flooring materials.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows a cross-sectional view of a conventional housing assembly with a can housing and a junction box and an exemplary lighting module.

FIG. 2A shows a cross-sectional view of a representative housing according to the inventive implementations of this disclosure.

FIG. 2B shows an exemplary lighting module with electrical wires and wire splices.

FIG. 2C shows a cross-sectional view of a representative lighting system that includes the housing of FIG. 2A and the lighting module of FIG. 2B.

FIG. 3A shows another exemplary lighting module with electrical wires and an electrical connector.

FIG. 3B shows another exemplary lighting module with an electrical connector integrated directly on the module housing.

FIG. 3C shows an exemplary UL-listed electrical connector.

FIG. 3D shows another exemplary UL-listed electrical connector.

FIG. 4 shows a table summarizing the minimum thickness of a housing for various dimensions and materials as set forth by UL standard UL1598 for luminaires.

FIG. 5 shows a cross-sectional front view of a housing, with a module housing positioned inside the housing, coupled to bar hangers according to one embodiment.

FIG. 6 shows a cross-sectional side view of the embodiment of FIG. 5.

FIG. 7 shows a top view of the embodiment of FIG. 5.

FIG. 8 shows an overhead perspective view of a housing, bar hanger holders, and a mounting ring according to one embodiment.

FIG. 9 shows a bottom perspective view of the embodiment of FIG. 8 with the mounting ring inserted into the cavity of the housing.

FIG. 10 shows a cross-sectional side view of a housing with bar hanger holders and a mounting ring according to one embodiment.

FIG. 11 shows a top view of the embodiment of FIG. 10.

FIG. 12 shows a cross-sectional side view of a housing, a module housing, a trim, and two friction clips according to one embodiment.

FIG. 13A shows a top, front, left perspective view of another exemplary round-shaped housing with multiple sidewall components.

FIG. 13B shows a bottom, rear, right perspective view of the housing of FIG. 13A.

FIG. 13C shows a top view of the housing of FIG. 13A.

FIG. 13D shows a bottom view of the housing of FIG. 13A.

FIG. 13E shows a front view of the housing of FIG. 13A.

FIG. 13F shows a right-side view of the housing of FIG. 13A.

FIG. 13G shows a cross-sectional front view of the housing corresponding to the plane A-A of FIG. 13C.

FIG. 13H shows a cross-sectional right-side view of the housing corresponding to the plane B-B of FIG. 13C.

FIG. 13I shows an exploded top, front, left perspective view of the housing of FIG. 13A.

FIG. 13J shows an exploded bottom, rear, left perspective view of the housing of FIG. 13A.

FIG. 14A shows a top, front, right perspective view of the sidewall component in the housing of FIG. 13A.

FIG. 14B shows a bottom, rear, left perspective view of the sidewall component of FIG. 14A.

FIG. 14C shows a top view of the sidewall component of FIG. 14A.

FIG. 14D shows a bottom view of the sidewall component of FIG. 14A.

FIG. 15A shows a top, front, left perspective view of a top component in the housing of FIG. 13A.

FIG. 15B shows a bottom, rear, right perspective view of the top component of FIG. 15A.

FIG. 15C shows a top view of the top component of FIG. 15A.

FIG. 15D shows a bottom view of the top component of FIG. 15A.

FIG. 15E shows a front view of the top component of FIG. 15A.

FIG. 15F shows a right-side view of the top component of FIG. 15A.

FIG. 16 shows a cross-sectional view of the housing of FIG. 13A with a bar hanger assembly and a trim coupled to the housing.

FIG. 17 shows a top front, left perspective view of another exemplary round-shaped housing with a single sidewall component.

FIG. 18A shows a top, front, right perspective view of an exemplary housing assembly that includes a housing with a single sidewall component for a remodel installation.

FIG. 18B shows a bottom, rear, left perspective view of the housing assembly of FIG. 18A.

FIG. 18C shows a top view of the housing assembly of FIG. 18A.

FIG. 18D shows a bottom view of the housing assembly of FIG. 18A.

FIG. 18E shows a front view of the housing assembly of FIG. 18A.

FIG. 18F shows a left-side view of the housing assembly of FIG. 18A.

FIG. 18G shows a cross-sectional front view of the housing assembly of FIG. 18A corresponding to the plane A-A of FIG. 18C.

FIG. 18H shows an exploded top, front, left perspective view of the housing assembly of FIG. 18A where a mounting ring is separated from the housing.

FIG. 18I shows an exploded top, front, left perspective view of the housing in the housing assembly of FIG. 18A with a top component separated from the sidewall component. The mounting ring and spring clips are not shown for clarity.

FIG. 18J shows an exploded bottom, rear, left perspective view of the housing of FIG. 18I.

FIG. 19A shows a top, front, left perspective view of the sidewall component in the housing assembly of FIG. 18A.

FIG. 19B shows a top view of the sidewall component of FIG. 19A.

FIG. 20A shows a top, front, right perspective view of the top component in the housing assembly of FIG. 18A.

FIG. 20B shows a right-side view of the top component of FIG. 20A.

FIG. 21A shows a cross-sectional front view of the housing assembly of FIG. 18A corresponding to the plane A-A of FIG. 18C where the housing assembly is inserted into an opening of a ceiling.

FIG. 21B shows the cross-sectional front view of FIG. 21A where a spring clip is actuated by a fastener to securely couple the housing assembly to the ceiling.

FIG. 22A shows a cross-sectional front view of an exemplary captive fastener to actuate the spring clip in the housing assembly of FIG. 18A with a partially threaded shank and a nut.

FIG. 22B shows a cross-sectional front view of another exemplary captive fastener to actuate the spring clip in the housing assembly of FIG. 18A with a partially threaded shank and an e-clip.

FIG. 23A shows a top, front, right perspective view of another exemplary housing assembly that includes a housing with a single sidewall component and two spring clips with respective push flanges for a remodel installation.

FIG. 23B shows a bottom, rear, left perspective view of the housing assembly of FIG. 23A.

FIG. 23C shows a top view of the housing assembly of FIG. 23A.

FIG. 23D shows a bottom view of the housing assembly of FIG. 23A.

FIG. 23E shows a front view of the housing assembly of FIG. 23A.

FIG. 23F shows a left-side view of the housing assembly of FIG. 23A.

FIG. 23G shows a cross-sectional front-side view of the housing assembly of FIG. 23A corresponding to the plane A-A of FIG. 23F.

FIG. 23H shows an exploded top, front, left perspective view of the housing assembly of FIG. 23A where a mounting ring and the spring clips are separated from the housing.

FIG. 24A shows a top, front, left perspective view of one of the spring clips in the housing assembly of FIG. 23A.

FIG. 24B shows a bottom, front, right perspective view of the spring clip of FIG. 27A.

FIG. 25A shows a cross-sectional front view of the housing assembly of FIG. 23A corresponding to the plane A-A of FIG. 23F where the housing is inserted into a ceiling.

FIG. 25B shows the cross-sectional front view of FIG. 25A where the spring clips are pushed outwards to engage the ceiling.

FIG. 25C shows the cross-sectional front view of FIG. 25A where the spring clips are locked in place to securely couple the housing assembly to the ceiling.

FIG. 26A shows a top, front, right perspective view of an exemplary housing assembly that includes a housing with a single sidewall component and three spring clips with respective push flanges for a remodel installation.

FIG. 26B shows a bottom, rear, left perspective view of the housing assembly of FIG. 26A.

FIG. 26C shows a top view of the housing assembly of FIG. 26A.

FIG. 26D shows a bottom view of the housing assembly of FIG. 26A.

FIG. 26E shows a front view of the housing assembly of FIG. 26A.

FIG. 26F shows a right-side view of the housing assembly of FIG. 26A.

FIG. 26G shows an exploded top, rear, right perspective view of the housing assembly of FIG. 26A.

FIG. 27A shows a top, front, left perspective view of one of the spring clips in the housing assembly of FIG. 26A.

FIG. 27B shows a bottom, front, right perspective view of the spring clip of FIG. 27A.

FIG. 28A shows a top, front, right perspective view of an exemplary housing assembly that includes a housing with a single sidewall component for a new construction installation.

FIG. 28B shows a bottom, rear, right perspective view of the housing assembly of FIG. 28A.

FIG. 28C shows a top, front, right perspective view of the housing assembly of FIG. 28A with the bar hanger assembly removed.

FIG. 28D shows a bottom, rear, right perspective view of the housing assembly of FIG. 28C.

FIG. 28E shows a top view of the housing assembly of FIG. 28C.

FIG. 28F shows a bottom view of the housing assembly of FIG. 28C.

FIG. 28G shows a front view of the housing assembly of FIG. 28C.

FIG. 28H shows a right-side view of the housing assembly of FIG. 28C.

FIG. 28I shows a cross-sectional right-side view of the housing assembly of FIG. 28C corresponding to the plane A-A of FIG. 28G.

FIG. 28J shows a cross-sectional front view of the housing assembly of FIG. 28C corresponding to the plane B-B of FIG. 28H.

FIG. 28K shows an exploded top, front, right perspective view of the housing assembly of FIG. 28C with bar hanger holders, a cover plate, and a yoke separated from the housing.

FIG. 28L shows an exploded bottom, rear, left perspective view of the housing assembly of FIG. 28K.

FIG. 28M shows an exploded top perspective view of a housing in the housing assembly of FIG. 28A with a top component separated from the sidewall component. The bar hanger holders, the cover plate, and the yoke are not shown for clarity.

FIG. 28N shows an exploded bottom, front, right perspective view of the housing of FIG. 28M.

FIG. 29A shows a top, front, right perspective view of another exemplary housing assembly that includes a housing with a single sidewall component for a new construction installation.

FIG. 29B shows a bottom, front, left perspective view of the housing assembly of FIG. 29A.

FIG. 29C shows a top view of the housing assembly of FIG. 29A with the bar hanger assembly removed.

FIG. 29D shows a bottom view of the housing assembly of FIG. 29C.

FIG. 29E shows a front view of the housing assembly of FIG. 29C.

FIG. 29F shows a right-side view of the housing assembly of FIG. 29C.

FIG. 29G shows a cross-sectional front view of the housing assembly of FIG. 29C corresponding to the plane A-A of FIG. 29F.

FIG. 30A shows a top, front, left perspective view of an exemplary housing assembly with two deep-drawn components.

FIG. 30B shows a bottom, rear, right perspective view of the housing assembly of FIG. 30A.

FIG. 30C shows a top view of the housing assembly of FIG. 30A.

FIG. 30D shows a bottom view of the housing assembly of FIG. 30A.

FIG. 30E shows a front view of the housing assembly of FIG. 30A.

FIG. 30F shows a right-side view of the housing assembly of FIG. 30A.

FIG. 30G shows a cross-sectional front view of the housing assembly corresponding to the plane A-A of FIG. 30F.

FIG. 30H shows a cross-sectional right-side view of the housing assembly corresponding to the plane B-B of FIG. 30E.

FIG. 30I shows an exploded top, front, right perspective view of the housing assembly of FIG. 30A.

### DETAILED DESCRIPTION

Following below are more detailed descriptions of various concepts related to, and implementations of, a housing assembly for a lighting system with a housing that integrates together the functionality of a can housing (e.g., the housing may contain a lighting module) and an electrical junction box (e.g., the housing may contain various wire splices and/or electrical connections). The housing may have a round exterior shape to provide greater ease of installation (e.g., cutting a round-shaped opening in a drywall is less prone to error) and an improved aesthetic appearance (e.g., the trim has a smaller flange). It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of inventive lighting systems, housing assemblies, and housings are provided, wherein a given example or set of examples showcases one or more particular features of a lighting module, a sidewall component, a top component, a bottom component, a spring clip assembly, a bar hanger assembly, a trim, a yoke, and a cover plate. It should be appreciated that one or more features discussed in connection with a given example of a lighting system, housing assembly, or housing may be employed in other examples of lighting systems, housing assemblies, or housings according to the present disclosure, such that the various features disclosed herein may be readily combined in a given lighting system, housing assembly, or housing according to the present disclosure (provided that respective features are not mutually inconsistent).

Certain dimensions and features of the housing, housing assembly, and the lighting system are described herein using the terms “approximately,” “about,” “substantially,” and/or “similar.” As used herein, the terms “approximately,” “about,” “substantially,” and/or “similar” indicates that each of the described dimensions or features is not a strict boundary or parameter and does not exclude functionally similar variations therefrom. Unless context or the description indicates otherwise, the use of the terms “approximately,” “about,” “substantially,” and/or “similar” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

A Housing Assembly with a Single Housing

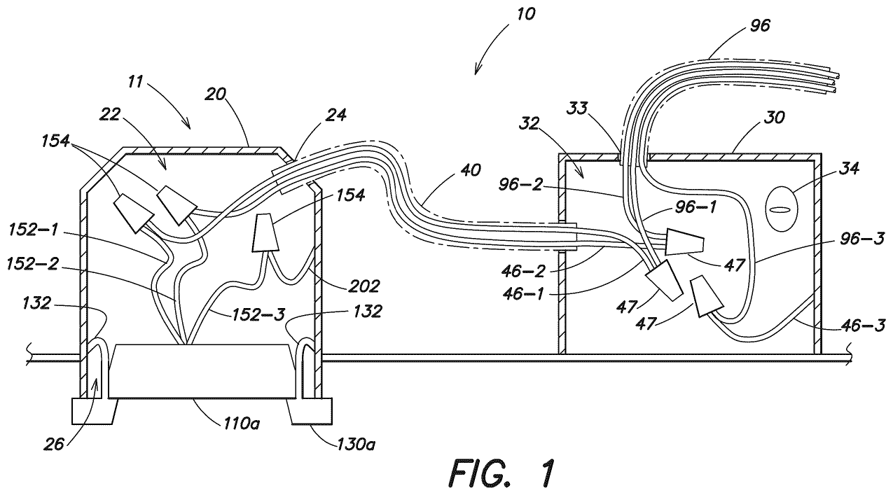

Conventional housing assemblies for recessed lighting systems typically include multiple housings to contain various components of the lighting system. For example, FIG. 1 shows a recessed lighting system 10 with a conventional housing assembly 11 and an exemplary lighting module 110a. As shown, the housing assembly 11 includes a can housing 20 to contain the lighting module 110a and a portion of a trim 130a, a junction box 30 to receive a cable 96 from an external power supply system or power source (e.g., building mains), a conduit cable 40 to electrically couple the lighting module 110a to the cable 96, and a pan frame 12 to mechanically support the can housing 20 and the junction box 30.

As shown, the junction box 30 includes multiple knockouts 34, one of which is removed to form an opening 33 for the cable 96 to pass into a cavity 32 of the junction box 30. The cable 96 includes multiple wires 96-1, 96-2, and 96-3. The wires 96-1 and 96-2 supply electrical power to the lighting system 10 and the wire 96-3 provides a ground connection to an external electrical ground. The wires 96-1 and 96-2 are spliced with wires 46-1 and 46-2, respectively, of the conduit cable 40 via wire nuts 47. Thus, the conduit cable 40 supplies electrical power to the lighting module 110a. The wire 96-3 is spliced with a ground cable 46-3 via a wire nut 47 and the ground cable 46-3, in turn, is connected to a wall of the junction box 30, thus electrically grounding the junction box 30 to the external electrical ground.

The can housing 20 includes an opening 24 to receive the conduit cable 40. As shown in FIG. 1, the lighting module 110a is mounted to the trim 130a. During installation, the lighting module 110a and the trim 130a are inserted into the cavity 22 of the can housing 20 through an opening 26. The trim 130a includes multiple friction clips 132 to mount the lighting module 110a and the trim 130a to the walls of the can housing 20. The lighting module 110a includes wires 152-1 and 152-2, which are spliced with the wires 46-1 and 46-2, respectively, of the conduit cable 40 via wire nuts 154. The lighting module 110a also includes a ground wire 152-3 connected to a ground cable 202 via a wire nut 154. The lighting module 110a is electrically connected to the conduit cable 40 before inserting the lighting module 110a and the trim 130a into the cavity 22 of the can housing 20.

The inclusion of multiple housings in a conventional housing assembly may have several drawbacks for general lighting installations. First, the can housing 20, the junction box 30, and the pan frame 12 are typically manufactured as separate sub-assemblies with multiple parts, which results in a longer manufacturing time and greater material costs. Second, the housing assembly 11 is often bulky in size and heavy, thus making installation more difficult since the installer is often required to hold the housing assembly 11 in place when mounting the housing assembly 11 to various support structures in the environment. Additionally, the housing assembly 11 may be unable accommodate smaller, more confined spaces. Third, the inclusion of multiple wire splices in the can housing 20 and the junction box 30 may make maintenance of the lighting system 10 more difficult since the user would be unable to access the wire splices within the junction box 30 without first removing the drywall panel from a ceiling in the case of a new construction installation or removing the housing assembly 11 in its entirety in the case of a remodel installation.

To address these limitations, the present disclosure describes various inventive implementations of a housing assembly with a single housing that may contain a lighting module, a trim, a cable from an external power supply system, and various electrical connections between the cable and the lighting module. In other words, the housing may consolidate the respective functions of a conventional can housing and a conventional junction box, thus appreciably simplifying the overall design of the housing assembly, in part, by reducing the number of parts and sub-assemblies in the housing assembly.

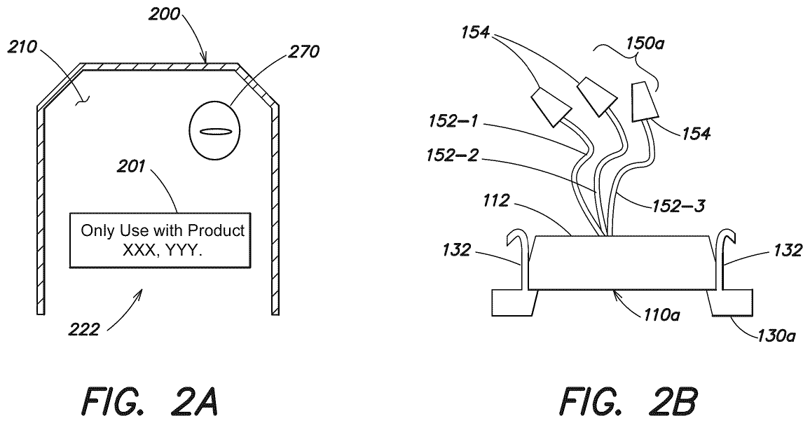

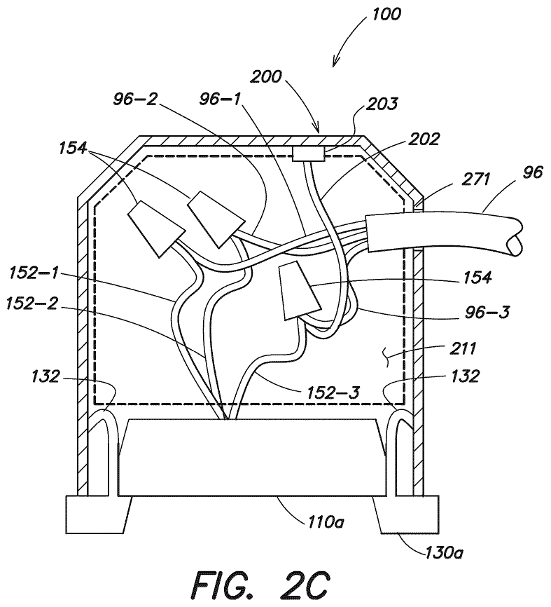

FIG. 2A shows a general example of a housing 200 representative of the inventive implementations described herein. As shown, the housing 200 may define a cavity 210 with a bottom opening 222 to receive and contain a lighting module and at least a portion of a trim. The housing 200 may further include one or more knockouts 270, which when removed may receive a cable from an external power supply system supplying electrical power to the lighting module.

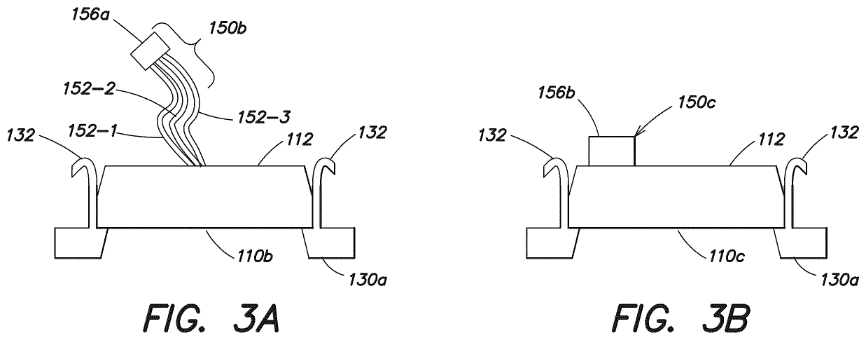

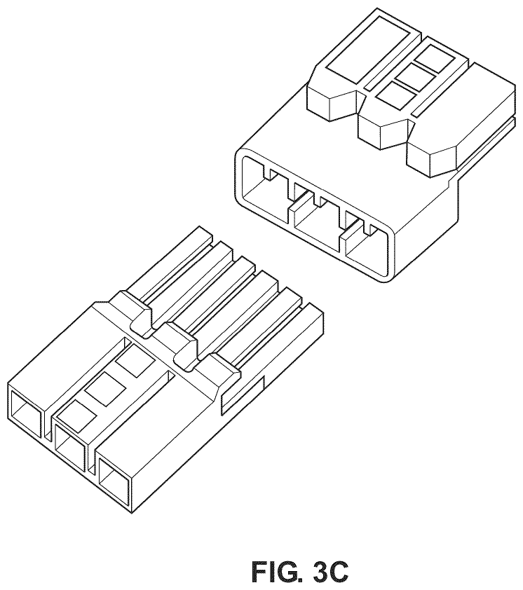

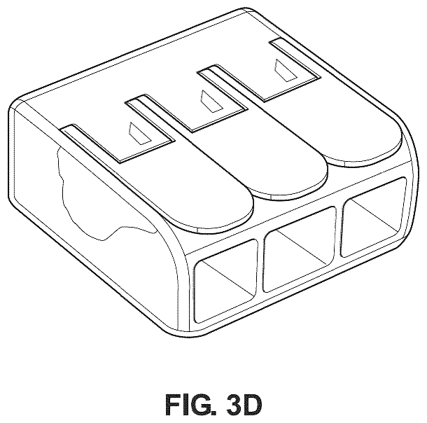

The housing 200 may generally accommodate and support different lighting modules and trims. For example, the housing 200 may support the lighting module 110a. FIG. 2B shows another view of the lighting module 110a and the trim 130a, which includes an electrical connection mechanism 150a with multiple wires 152-1, 152-2, and 152-3 and corresponding wire nuts 154 as described above. In some implementations, the wires 152-1, 152-2, and 152-3 may be 18 AWG wires. In another example, FIG. 3A shows another lighting module 110b with an electrical connection mechanism 150b that includes wires 152-1, 152-2, and 152-3 connected to an electrical connector 156a. In yet another example, FIG. 3B shows another lighting module 110c with an electrical connection mechanism 150c that includes an electrical connector 156b integrated directly onto the module housing 112 such that there are no wires outside the module housing 112. The lighting module 110a may generally include a LED light source (not shown) and a driver (not shown) with a module housing 112 that functions as a heat sink. The trim 130a may also be formed of a thermally conductive material (e.g., aluminum) to dissipate heat generated by the lighting module 110a.

FIG. 2C shows an exemplary lighting system 100 that includes the lighting module 110a, the trim 130a, and the cable 96 supported by the housing 200. As shown, the lighting module 110a may be disposed in the cavity 210 and supported by the trim 130a, which is mounted to the housing 200 via multiple friction clips 132. The cable 96 may be inserted through an opening 271 formed by the removal of one of the knockouts 270. The wires 96-1, 96-2, and 96-3 of the cable 96 may be spliced with the wires 152-1, 152-2, and 152-3, respectively, of the lighting module 110a via the wire nuts 154. The housing 200 may additionally include a ground cable 202 connected at one end to a wall of the housing 200 via a fastener 203. The ground cable 202 may be spliced with the wire 152-3 and the wire 96-3 via the same wire nut 154, thus electrically grounding the lighting module 110a and the housing 200 to an external electrical ground.

In a typical installation, the housing 200 is mounted to a support structure in the environment (e.g., a wood/metal joist, a T-bar, a hat channel, a drywall panel). The cable 96 may be inserted into the cavity 210 of the housing 200 before or after the housing 200 is mounted to the ceiling depending, in part, whether the installation is a new construction installation or a remodel installation. Once the housing 200 is installed, the lighting module 110a may then be electrically connected to the cable 96 and subsequently inserted into the cavity 210 of the housing 200 together with the trim 130a.

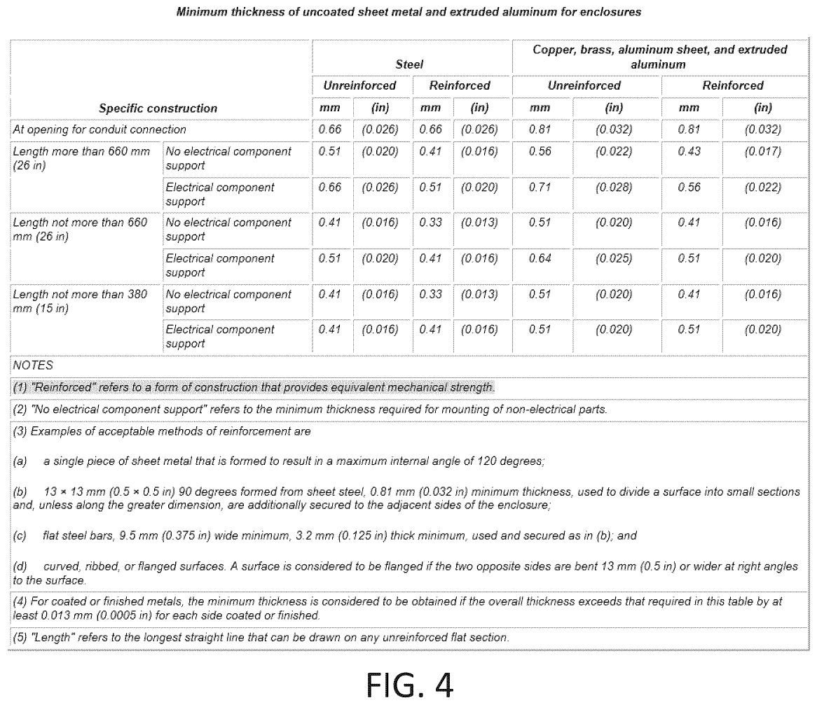

In some implementations, the housing 200 may be designed to qualify as both an electrical junction box and a luminaire enclosure in accordance with various standards and regulations. In one example, the housing 200 may meet the requirements of UL514 for metallic outlet boxes and/or UL1598 for luminaires. For example, the housing 200 may be formed from galvanized steel with wall thickness of 1.6 mm ( 1/16 inches) if the housing 200 is fire-rated or 1.0 mm if the housing 200 is not fire-rated. In some implementations, the thickness may range between about 0.6 mm to about 2.0 mm when the sidewall and top components are formed from galvanized steel. The thickness of the walls forming the housing 200 may be chosen, in part, to satisfy the thickness specifications for enclosures in accordance with UL1598, which is summarized in the table shown in FIG. 4. It should be appreciated the housing 200 may be formed of other materials including, but not limited to, steel alloys, aluminum, brass, copper, and any combinations of the foregoing. The wall thicknesses of the housing 200 may be tailored based on the material used to form the housing 200 in accordance with FIG. 4.

The housing 200 may also be dimensioned such that the portion 211 of the cavity 210 remaining after the lighting module 110a and the trim 130a are mounted to the housing 200 is sufficiently large to contain a specific number of wires of a particular gauge and wire splices specified by the various standards and regulations. The number of wires and wire gauge may generally vary depending, in part, on the trade size of the housing. For example, the portion 211 of the cavity 210 may provide space to contain at least nine 12 AWG wires for a 4-inch trade size installation. This may be accomplished, in part, by dimension the housing 200 such that the portion 211 has a volume greater than or equal to 21 cubic inches. The nine 12 AWG wires may further correspond to three sets of wires that each provide positive, negative, and ground connections for (1) the receipt of electrical power from an external power supply system and (2) the branching of wire connections to two other lighting systems. More generally, the dimensions of the housing 200 and, in particular, the volume of the portion 211 of the cavity 210 may be chosen to comply with the requirements set forth in Article 314 of the 2020 NEC and, in particular, Section 314.16 entitled, “Number of Conductors in Outlet, Device, and Junction Boxes, and Conduit Bodies.” The ground connection provided by the housing 200 via the ground cable 202 may also help satisfy the UL standards for electrical junction boxes and/or luminaires. In some implementations, the volume of the cavity 210 may range between about 30 cubic inches and about 80 cubic inches. The term “about,” when used to describe the volume of the housing 200, is intended to cover manufacturing tolerances. For example, “about 30 cubic inches” may correspond to the following dimensional ranges: 29.7 to 30.3 cubic inches (+/−1% tolerance), 29.76 to 30.24 cubic inches (+/−0.8% tolerance), 29.82 to 30.18 cubic inches (+/−0.6% tolerance), 29.88 to 30.12 cubic inches (+/−0.4% tolerance), 29.94 to 30.06 cubic inches (+/−0.2% tolerance).

It should also be appreciated the lighting module 110a may include components that are also compliant with various standards and regulations (e.g., the UL1598 standard) so that the lighting system 100, when installed, meets these standards and regulations. For example, the lighting module 110a includes UL-listed wire nuts. In another example, the lighting module 110b includes a UL-listed electrical connector 45a connected to the wires 152-1, 152-2, and 152-3. In yet another example, the lighting module 110c includes a UL-listed electrical connector 45b integrated directly onto a module housing of the lighting module 110c. FIGS. 3C and 3D further show exemplary electrical connectors that are compliant with UL standards. Specifically, FIG. 3C shows an Ideal PowerPlug 3-Pole Luminaire Disconnect Model 183 (100-Box). FIG. 3D shows a WAGO 221 electrical connector.

In some implementations, the housing 200 may include a label 201 disposed on an interior side of the walls that further specifies the components (e.g., the lighting module, the trim) that are compatible with the housing 200 to meet the various standards and regulations. For example, the label 201 may explicitly state “Only Use with Product XXX, YYY” where XXX and YYY refer to specific products that are deemed compliant with the housing 200.

A Housing Assembly with a Round-Shaped Housing

The housing 200 may generally have a round shape, which provides several benefits to the design and installation of a lighting system. First, the round-shaped opening formed in the ceiling during installation may be easier to cut compared to previous polygonal shaped housings since the installer can continuously guide a saw blade along a curve when cutting whereas a polygonal-shaped opening typically requires the installer to intermittently reposition the sawblade to avoid overshooting a vertex of the polygon. The round shaped housing may also support a round-shaped trim with a smaller flange to cover the opening in the ceiling. A trim with smaller flange may be lighter in weight and smaller, thus enabling lighting installations closer to a corner of an environment (e.g., a corner between a ceiling and a wall). For example, the flange may have an inner radius defining an aperture for light to pass through the trim and an outer radius that defines the lateral extent of the flange. The difference between the inner and outer radii may be less than or equal to ½ inch. Although the flange may be smaller, the trim may still provide room to overshoot when cutting an opening in the drywall. Additionally, lighting modules typically include a round-shaped module housing. Thus, the round-shaped housing may more readily conform in shape with the round-shaped module housing of the lighting module. This, in turn, may allow a smaller opening to be formed in the drywall compared to a polygonal-shaped housing with a similar characteristic width.

Examples of round-shaped housings for housing assemblies and recessed lighting system may be found in U.S. application Ser. No. 15/132,875, filed on Apr. 19, 2016, entitled, “OUTER CASING FOR A RECESSED LIGHTING FIXTURE,” which is incorporated by reference herein in its entirety.

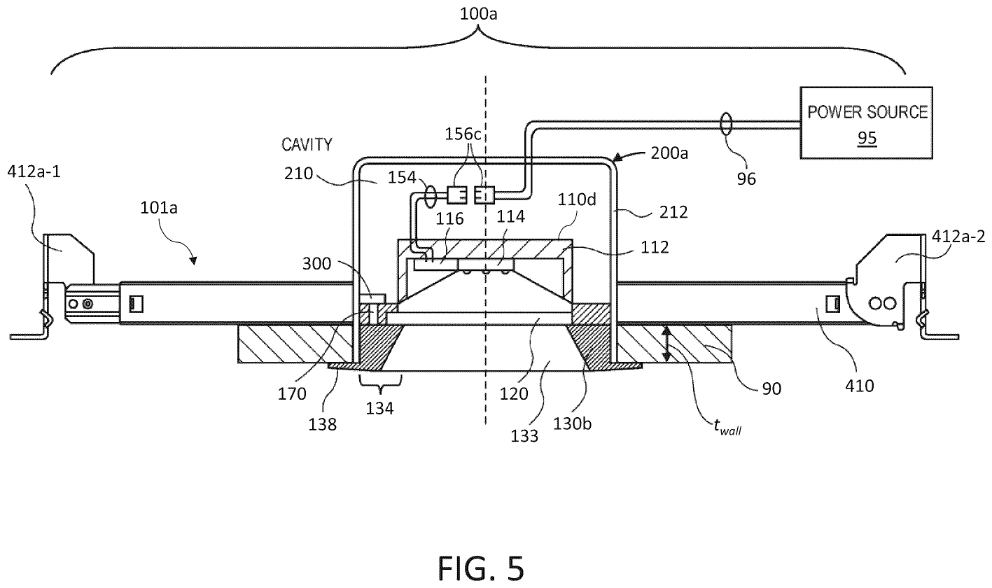

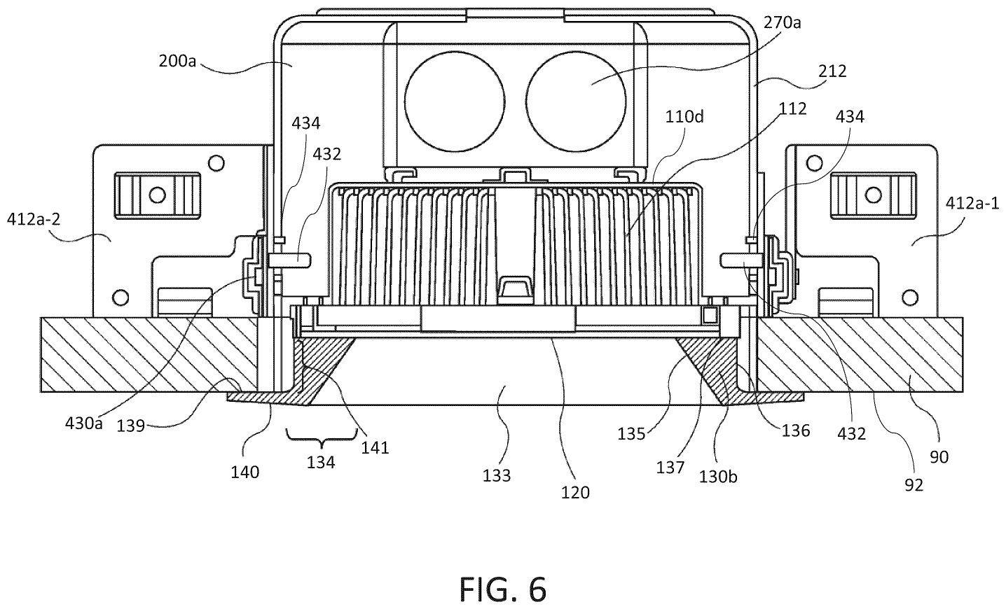

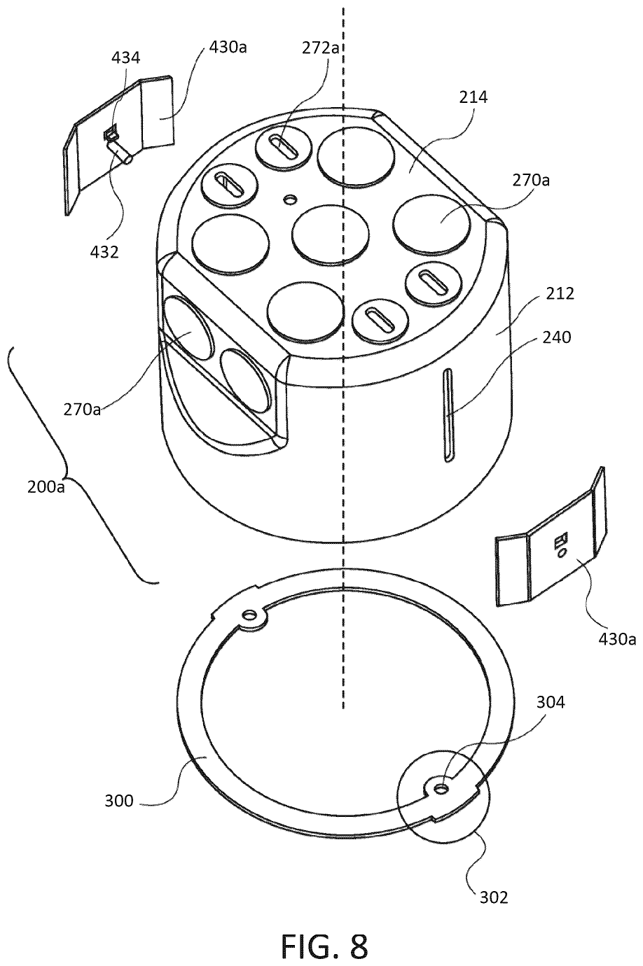

FIG. 5 shows a cross-section view of a recessed lighting fixture or system 100a installed so that the exposed edge of the ceiling or wall 90, where a hole is formed, is covered. The recessed lighting fixture 100a may include an outer casing 200a (also referred to herein as “a housing 200a”), a unified casting 112 (also referred to more generally herein as a “module housing 112”) for a lighting module 110d, a trim 130b, and bar hanger assemblies 400a that include a set of hanger bars 410 (also referred to herein as “bar hangers 410”) and a set of hanger holders 430 (also referred to herein as “bar hanger holders 430”) shown in a side view in FIG. 6 and also in FIG. 8. The outer casing 200a, the bar hangers 410, and the bar hanger holders 430 may form a housing assembly 101a. The unified casting 112 may house both a light source module 114 (e.g., a module of several LED elements) and a driver 116 in a single compact unit. The light source module 114 is referred to more generally herein as a light source 114. The trim 130b serves the primary purpose of covering the exposed edge of the ceiling or wall 90 where a hole is formed in which the recessed lighting fixture 100a resides while still allowing light from a light source module 114 to be emitted into a room through an aperture 133 of the trim 130b to illuminate the room. In doing so, the trim 130b helps the recessed lighting fixture 100a appear seamlessly integrated into the ceiling or wall. The trim 130b may be attached to the outer casing 200a also to hide at least the periphery at the bottom edge of the outer casing 200a from view. This can be seen in FIG. 5 where a flange 138 extends outward from a trim base 134 so as to hide from view (below the light fixture) the bottom edge of the casing 200a. As will be described in further detail below, the recessed lighting fixture 100a provides a more compact and cost effective design that also allows the outer casing 200a to be moved so that its position relative to the hanger bars 410 can be adjusted, while complying with various building and safety codes/regulations. Each of the elements of the recessed lighting fixture 100a will be explained by way of example below.

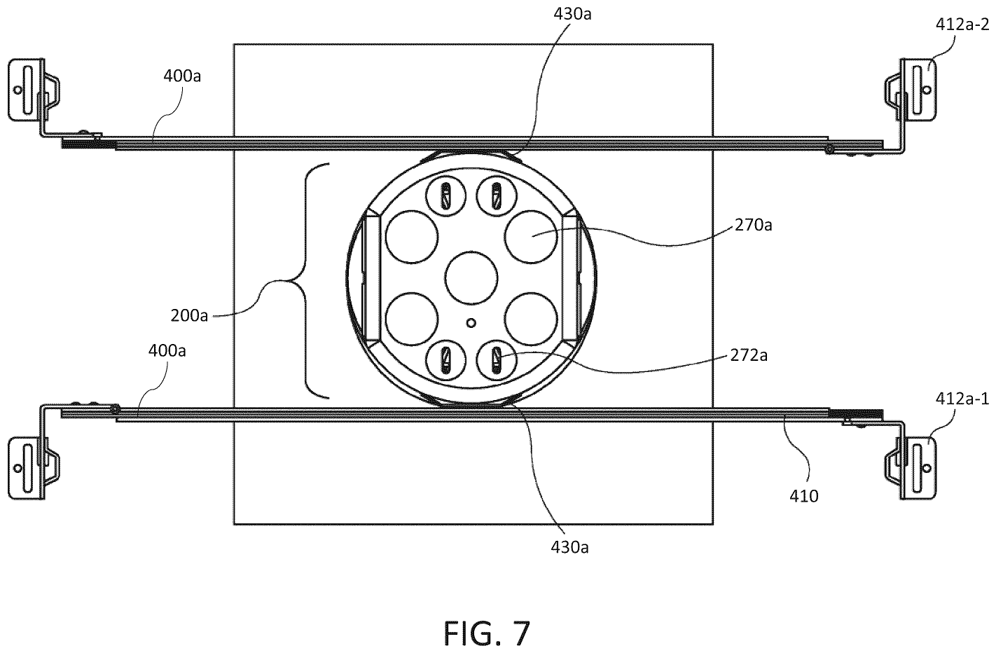

Instead of using a junction box that is mounted along with a can to a horizontal platform (which is in turn attached to a joist or other structural member behind the ceiling or wall 90), as is already known in the art, the outer casing 200a may be used in such a way that obviates the need for a separate junction box and that also eliminates the horizontal platform. As seen FIG. 6 and in FIG. 7, the outer casing 200a, and in particular its sidewall 212, is directly attached to a hanger bar 410 via a hanger holder 430. The hanger bar 410 is in turn attached directly to a joist, beam, or other structural member behind the ceiling or wall 90 at a mounting block 412a-1, 412a-2 (collectively referred to herein as “mounting blocks 412a” or as “bar hanger heads 412a”), so that the aperture 133 of the trim 130b will be aligned with and covers the hole in the wall 90. The outer casing 200a may serve as both a protective barrier between wall insulation materials and wiring junctions inside its cavity, and as a luminaire enclosure. As shown in FIG. 5, the outer casing 200a is a structure that separates the inner components of the recessed lighting fixture 100a, i.e., those that are located inside the outer casing 200a, including electrical wires/cables 96, 154 and connectors 146a that electrically connect a driver 116 in the unified casting 112 to an external power source 95, from items such as thermal/heat insulation materials and the power source 95 that are outside of the outer casing 200a and inside a ceiling or crawl space in which the outer casing has been installed. In one embodiment, the outer casing 200a may accommodate a wall thickness (tₑₙᵥ) of the ceiling or wall 90 of ½ inch to 2½ inches. The outer casing 200a may have a fire rating of up to two hours without any need for modification, where the fire rating is described in the National Electrical Code (NEC) and by the Underwriters Laboratories (UL) such as specified in UL 263. The outer casing 200a may receive electrical wires 96 into its cavity from the power source 95, such as an electrical power distribution system (e.g., 120 VAC or 277 VAC) within a building or structure in which the recessed lighting fixture 100a is installed. There may be one or more wire connectors 146a inside the outer casing 200a that join one or more wires 96 which carry 120/277 VAC power and that extend into the casing, to deliver 120/277 VAC power from a circuit breaker or wall switch to the driver 116. The electrical wires 96 from the power source 95 may thus be connected inside the outer casing 200a to corresponding wires 154 of the driver 116 which is inside the unified casting 112, as will be described in greater detail below.

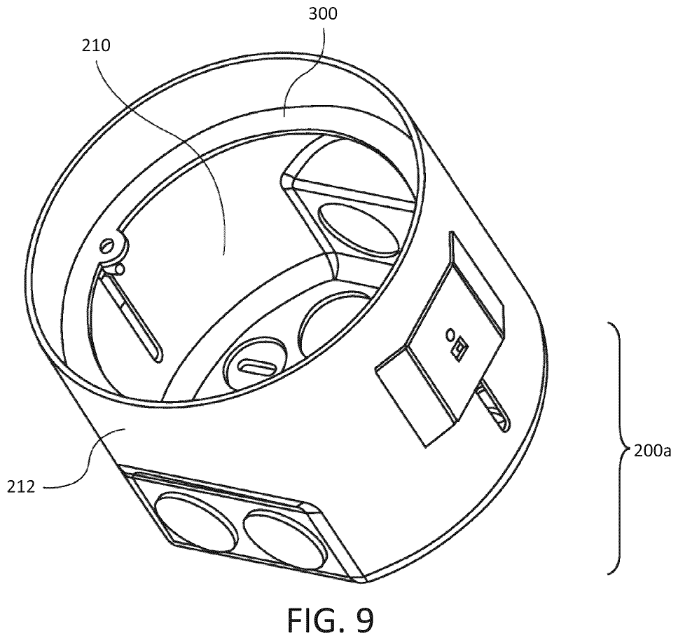

As shown in FIG. 8, the outer casing 200a may have a side wall 212 that extends from and is joined at its upper edge (or upper end) to a closed base end 214, which together define a cavity 210 therein (see FIG. 5 and FIG. 9). The side wall 212 may surround the cavity 210, with its lower edge (or lower end) defining the perimeter of an opening through which various components can be placed inside the cavity 210, including for example, a ring 300, the unified casting 112, and the trim 130b, as shown in FIG. 8, FIG. 9, and in FIG. 5. In one embodiment, as shown in FIG. 9, the lower edge (lower end) of the sidewall 212 is devoid of any tabs that extend inward (towards a center vertical axis that is shown as a dotted line). While the side wall 212 is depicted in the relevant figures here as being cylindrical, in other embodiments the side wall 212 of the outer casing 200a have any suitable shape, including a polyhedron, ellipsoid, frusto-conical, or otherwise curved. The cavity 210 that is formed in the outer casing 200a is larger than the outside dimensions of the unified casting 112 such that the entirety of the unified casting 112 fits into the cavity 210—see the front and side views in FIG. 5 and FIG. 6. The unified casting 112 may or may not come into direct contact with the side wall 212 of the outer casing 200a. The outer casing 200a is less than 5 inches in height between its base end and the other end of its sidewall.

As seen in FIG. 8, the outer casing 200a may have on its base end 214 one or more knockouts 270a as shown. The knockouts 270a may be punched through and removed to leave an opening behind on the base end 214, for electrical wires 96 or 154 to be inserted through the opening (which wires serve to deliver power to the driver 116). As shown in the top view of FIG. 7, one or more knockouts 270a may also have smaller openings 272 in them (e.g., a slit, slot, etc., that is smaller than the opening that results when the knockout 270a has been removed from the base end 214) that may allow the electrical wires 96 or 154 to be inserted through without the need to punch through the knockouts 270a. The knockout 270a may have a trade size greater than ½ inches resulting in a diameter larger than ½ inches. In one embodiment, one or more of the knockouts 270a allow for the installation therethrough of a non-metallic sheathed cable (as the wires 96). As shown in FIG. 8, one or more of the knockouts 270a may also be positioned on the side wall 212 of the outer casing 200a.

In one embodiment, as shown in FIG. 5, the electrical wires 96 received by the outer casing 270a from a power source 95 (e.g., the electrical system of a building or structure) may be connected to the electrical wires 154 of the unified casting 112. As shown, the electrical wires 96 and 154 are connected together through the use of connectors 146a that may be contained within the outer casing 200a (together with the unified casting 112). The term “connector” here is used broadly to not just interlocking or mating connector pairs but also cover wire terminal blocks and wire caps or other devices. In one embodiment, the connectors 146a may be kept outside the outer casing 200a (while the unified casting 112 is retained inside) if the wires 154 are long enough to reach outside of the casing 200a. The electrical wires 154 of the unified casting 112 may terminate in a connection with the driver 116 installed within the unified casting 112. When the wires 96 and 154 are connected to each other, electricity may pass from the power source 95 to the driver 116 to enable the driver 116 to power the light source module 114. In one embodiment, the driver 116 has three or more current carrying electrical wires 154.

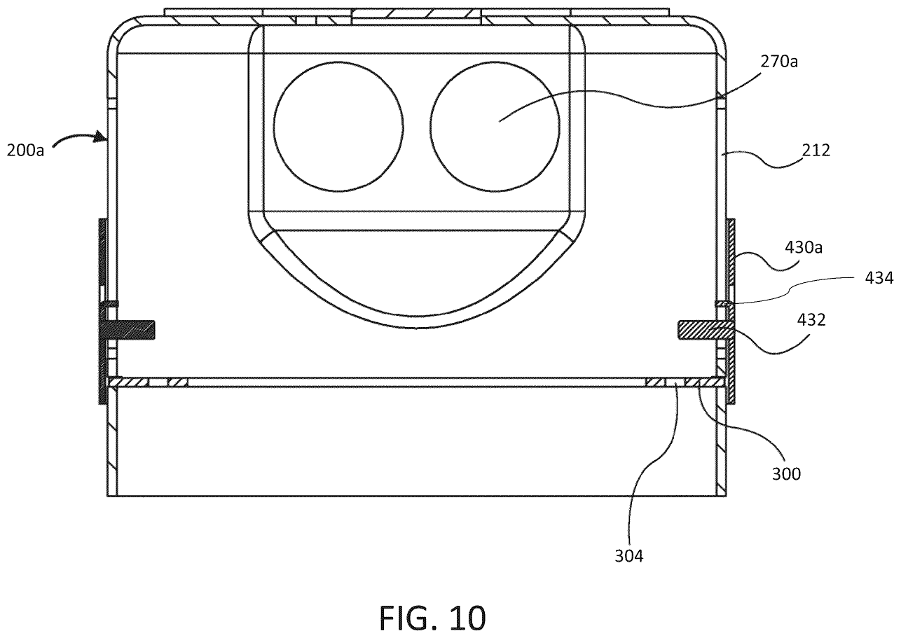

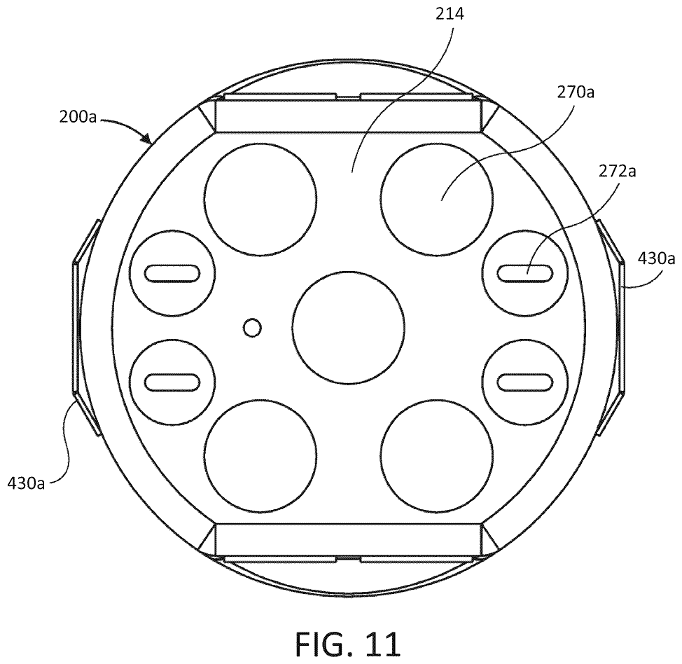

As seen in FIG. 9, the outer casing 200a may have within its cavity 210 a ring 300. The ring 300 maybe shaped as a circle (shown), a polygon, or an ellipsoid, where it conforms to the sidewall 212 of outer casing 200a. The ring 300 may be inserted into the cavity 210 of the outer casing 200a through the open end of the sidewall 212, and then secured to the inner surface of the sidewall 212 of the outer casing 200a as seen in FIG. 10. Once the ring 300 has been secured, the unified casting 112 may be inserted into the cavity 210 (through the same open end of the sidewall 212) and then attached to the ring 300 so as to secure the unified casting 112 to the outer casing 200a and prevent the unified casting 112 from falling out of the outer casing. The ring 300 has one or more tabs 302 formed as a flat segment of the ring, each having an opening 304 that passes through the ring 300 (from one face to the other face)—see FIG. 8 and FIG. 10. These are used for coupling (fastening) the outer casing 200a to the unified casting 112—see FIG. 5. In the embodiment of FIG. 8, there are two tabs 302 located sally opposite each other (along the circumference of the ring). When the ring 300 is fitted inside the casing 200a (as seen in FIG. 9), each tab 302 may extend inward from and is perpendicular to an inner surface of the sidewall 212 of the outer casing 200a. Each tab 302 and its opening 304 serves to receive a fastener 170, so as to firmly hold the weight of the unified casting 112 including the light source module 114 and the driver 116 contained in the unified casting 112. The fastener 170 may be a screw, bolt, pin, or the like. In other embodiments, the tabs 302 may incorporate other types of fastening mechanisms (to fasten the unified casting 112 to the outer casing 200a), such as a twist-and-lock friction connection that does not require the use of separate tools or other devices. The ring 300 should be affixed inside the cavity so that its tabs 302 may be further recessed inside the cavity 210, towards the base end 214, so that the unified casting 112 and trim 130b may also be further recessed inside the outer casing 200a.

In another embodiment, the tab 302 is formed as a portion of the sidewall 212 that has been bent inward, without the need for a ring 300. In this embodiment, the ring 300 is not necessary, as long as the unified casting 112 can otherwise be secured to the outer casing 200a via the tab 302, so as to be prevented from falling out of the outer casing 200a.

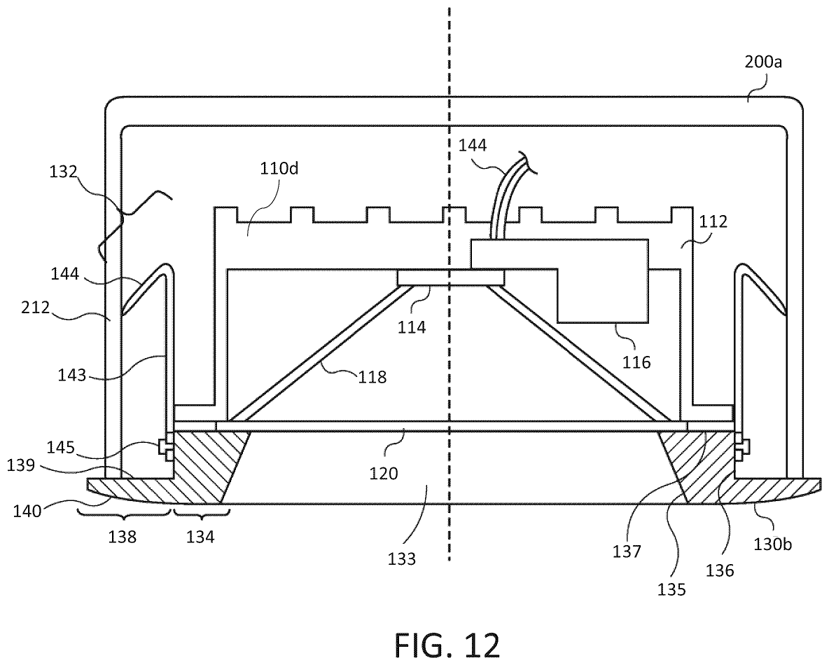

In other embodiments, as shown in FIG. 12, the unified casting 112 may be held inside the outer casing 200a, without being directly fastened to any tabs 302. Friction clips 132 (or tension clips) may be utilized to retain the unified casting 112 inside the outer casing 200a. Each friction clip 132 may be attached via a screw 145 (or other fastening mechanism such as a bolt, resin, glue, or the like) to a trim base 134 of the trim 130b, or directly to the unified casting 112. The friction clip 132 may be flexible and resilient. The friction clip 132 may be a piece of metal that has a straight portion 143 extending from the screw 145 and is then bent backward to form a bent portion 144. The bent portion 144 of the friction clip 132 may directly contact the inner surface of the sidewall 212 of the outer casing 200a, as shown, preventing the unified casting 112 and the trim 130b from falling out of the outer casing 200a.

The unified casting 112 is a shell and/or enclosure that further prevents the exposure of heat from the light source module 114 and the driver 116 to the items inside a ceiling or crawl space (e.g., insulation) in which the recessed lighting fixture 100a has been installed. The unified casting 112 may be formed of metals, polymers, metal alloys, and/or other heat insulating materials. As shown in FIG. 5, the unified casting 112 may be a cylindrical structure; however, in other embodiments, the unified casting 112 may be any suitable shape, including an ellipsoid, cone, or polyhedron that is capable of housing the light source module 114 and the driver 116.

In one embodiment, the unified casting 112 includes one or more heat sinks to dissipate heat generated by the light source module 114 and/or the driver 116. Although the heat sinks are shown as fins (in FIG. 6 and FIG. 12) which are passive components (formed on the outer surface of the end wall and/or the side wall of the unified casting 112) that cool the combined unified casting 112, light source module 114, and driver 116, by dissipating heat into the surrounding air, active heat sinks (e.g., fans) may also be used. In one embodiment, the heat sinks are defined by a set of fins surrounding the unified casting 112, which are formed in the same casting (manufacturing) process that results in the unified casting 112 being formed. The heat sinks may be composed of any thermally conductive material. For example, the heat sinks may be made of aluminium alloys, copper, copper-tungsten pseudoalloy, AlSiC (silicon carbide in aluminium matrix), Dymalloy (diamond in copper-silver alloy matrix), E-Material (beryllium oxide in beryllium matrix), and/or thermally conductive plastics or ceramics.

Still referring to FIG. 12, the recessed lighting fixture 100a may include the driver 116 contained within the unified casting 112. The driver 116 is an electronic circuit or device that supplies and/or regulates electrical energy to the light source module 114 and thus powers the light source module 114 to emit light. The light source module 114 and the driver 116 may be coupled to the end wall of the unified casting 112 as shown in FIG. 12, using any suitable connecting mechanism, including screws, resins, clips, or clamps. The driver 116 may be any type of electrical power supply, including power supplies that deliver an alternating current (AC) or a direct current (DC) voltage to the light source module 114. Upon receiving electricity through the wires 144, the driver 116 may regulate current or voltage to supply a stable voltage or current within the operating parameters of the light source module 114. The driver 116 receives an input current from the power source 95 and may drop the voltage of the input current to an acceptable level for the light source module 114 (e.g., from 120V-277V to 36V-48V). The driver 116 may transfer electrical power to the light source module 114 through an electrical connector (not shown). For example, the driver 116 may deliver electricity to the light source module 114 through an electrical cable (not shown) coupled between the light source module 114 and the driver 116 through removable or permanent connectors or soldered leads originating from the driver 116. The driver 116 may include a magnetic transformer or additional or alternative circuitry for voltage conversion and for regulating the input current or voltage to the light source module 114.

The light source module 114 may be any electro-optical device or combination of devices for emitting light. For example, the light source module 114 may have a single type of light emitting element, as a light emitting diode (LED), organic light-emitting diode (OLED), or polymer light-emitting diode (PLED). In some embodiments, the light source module 114 may have multiple light emitting elements (e.g., LEDs, OLEDs, and/or PLEDs). The light source module 114 receives electricity from the driver 116, as described above, such that the light source module 114 may emit a controlled beam of light into a room or surrounding area. The driver 116 is designed to ensure that the appropriate voltage and current are fed to the light source module 114 to enable the emission of light by the one or more light sources within the light source module 114.

In some embodiments, the recessed lighting fixture 100a may include a reflector 118 contained in the unified casting 112, as shown in FIG. 12. The reflector 118 may surround the entire light source module 114 as shown, or it may surround just a light emitting element of the light source module 114, to adjust the way light emitted by the light source module 114 is directed into a room or surrounding area. In one embodiment, the reflector 118 surrounds the entirety of the light source module 114 and also separates the light source module 114 from the driver 116. This separation allows light from the light source module 114 to be emitted into a room or surrounding area, while shielding the driver 116 from being exposed to the room or surrounding area. For example, in one embodiment, the reflector 118 and the unified casting 112 may together create a sealed structure to shield the driver 116 from the outside environment and the light source module 114. By shielding the driver 116 from the outside environment, the reflector 118 might reduce the risk of fire or other dangers and may help ensure the recessed lighting fixture 100a complies with building and safety codes/regulations. The reflector 118 may be formed of any fire retardant material, including steel, aluminum, metal alloys, calcium silicate, and other similar materials.

The reflector 118 may be formed in any shape that may direct and/or focus light. For example, the reflector 118 may be parabolic or spherical. In one embodiment, the front surface of the reflector 118 may be coated with a reflecting material or include one or more reflecting elements that assists in the adjustment of light emitted by the light source module 114. For example, the reflector 118 may be coated with a shiny enamel or include one or more mirrors or retroreflectors or a microcellular polyethylene terephthalate (MCPET) material to adjust the focus of light emitted by the light module 8. In other embodiments, the reflector 118 may include various other optic elements to assist in the focusing of light emitted by the light source module 114.

Still referring to FIG. 12, in one embodiment, the recessed lighting fixture 100a may include a lens 120. The lens 120 may be formed to converge or diverge light emitted by the light source module 114. The lens 120 may be a simple lens 120 comprised of a single optical element or a compound lens 120 comprised of an array of simple lenses 120 (elements) with a common axis. In one embodiment, the lens 120 also provides a protective barrier for the light source module 114 and shields the light source module 114 from moisture or inclement weather. The lens 120 may also assist in the diffusion of light and increase the uniformity of light over the surface of the recessed lighting fixture 100a. The lens 120 may be made of any at least partially transparent material, including glass and hard plastics. In one embodiment, the lens 120 and the reflector 118 are contained in a single indivisible unit of the unified casting 112, to work in conjunction to focus and adjust light emitted by the light source module 114. In one embodiment, the reflector and the lens are housed together with the driver and the light source module in the unified casting 112 as a single, indivisible unit. In other embodiments, the lens 120 and the reflector 118 may be separate, divisible elements.

Still referring to FIG. 12, in one embodiment, the recessed lighting fixture 100a may include a trim 130b. The trim 130b may be attached directly to the unified casting 112 as well as to the outer casing 200a as shown, while in other embodiments the trim 130b is to only be attached to the outer casing 200a (where in that case the unified casting 112 is separately attached to the casing 200a, as in FIG. 5 for example). The trim 130b may be attached to the unified casting 112 and/or the outer casing 200a using any suitable connecting mechanism, including resins, clips, screws, bolts, or clamps. In one embodiment, the trim 130b may include grooves and/or slots that are designed to engage with corresponding bumps or tabs of the unified casting 112 and/or the outer casing 200a to form a rotate and lock (or friction lock) connection which prevents axial separation (in FIG. 12, in the vertical or longitudinal direction) of the trim 130b and the outer casing 200a, and without the use of separate tools or other devices.

In one embodiment, the entire height 141 of the trim 130b, which may or may not be attached to the casting 112, may be inserted into the cavity 210 of the outer casing 200a. This is where the unified casting 112 is positioned further (deeper) into the outer casing 200a so that glare from the emitted light is reduced. As seen in FIG. 5 and FIG. 6, for example, the trim 130b may have a trim base 134 (an annular segment) having a height 141, with an inner circumferential surface 135 that is open to the central, light passing aperture 133 and an outer circumferential surface 136 that is closer to the sidewall 212 of the outer casing 200a. The trim base 134 may have a top surface 137 that extends, in a lateral or horizontal direction, from the inner surface 135 to the outer surface 136 and may be in contact with the lower most surface of the unified casting 112. The height 141 of the trim base 134 may be increased so as to position the lens 120 further into the outer casing 200a. It is preferred that the height 141 of the trim base 134 is less than. The trim 130b may have a flange 138 that extends laterally outward from the base 134, with a top surface 139 and a bottom surface 140 as shown. In one embodiment, referring now back to FIG. 5, the trim base 134 may be shaped and sized such that the outer surface 136 thereof conforms to an inner surface of the sidewall 212 of the outer casing 200a so that the trim 130b and the outer casing 200a are in direct contact. In one embodiment, the trim 130b may be fitted tightly to the sidewall 212 of the outer casing 200a (friction fit) so that the trim 130b does not fall out of the outer casing 200a (when the trim 130b is not also separately attached to the unified casting 112). In another embodiment, the outer surface 136 of the trim base 134 of the trim 130b may be attached to the inner surface of the sidewall 212 of the outer casing 200a through any connecting mechanism. The trim 130b may be pushed into the outer casing 200a so that the bottom end or edge of the sidewall 212 of the outer casing 200a comes into direct contact with the top surface 139 of the flange 138 of the trim 130b, for a tight, snug fit as shown in FIGS. 5 and 6. However, it is not necessary for the end of the sidewall 212 of the outer casing 200a to directly contact the top surface 139 of the flange 138 of the trim 130b. In yet another embodiment, the outer surface 136 of the trim base 134 need not contact the inner surface of the sidewall 212 of the outer casing 200a (e.g., when friction clips 132 are used as shown in FIG. 12).

In one embodiment, different diameter trims 130b may be capable of being coupled to the same unified casting 112 and/or the same outer casing 200a, where the diameter is measured at the periphery of the flange 138. The size and design of the trims 130b may depend on the size of the hole the wall 90 in which the recessed lighting fixture 100a has been fitted to cover the exposed wall or ceiling edge that defines the hole. The recessed lighting system 100a may include two or more trims 130b of different sizes to cover ceiling or wall openings of different sizes. The trim 130b may need to meet the aesthetic demands of the consumer. The trim 130b may be made of aluminum plastic polymers, alloys, copper, copper-tungsten pseudoalloy, AlSiC (silicon carbide in aluminum matrix), Dymalloy (diamond in copper-silver alloy matrix), and E-Material (beryllium oxide in beryllium matrix).

In one embodiment, the recessed lighting fixture 100a may include a set of hanger bars 410 as shown in FIG. 5. The hanger bars 410 may be rigid, elongated members that are connected to adjacent joists and/or beams in the walls or ceilings of a structure. In one embodiment, each of the hanger bars 410 may be telescoping such that each hanger bar 410 may be extended or retracted to meet the gap between the joists and/or beams. In one embodiment, each of the hanger bars 410 may include a set of mounting blocks 412a. The mounting blocks 412a may be used to directly attach the hanger bars 410 to the joists and/or beams in the walls or ceilings of a structure. For example, as shown in FIG. 5, the mounting blocks 412a may include holes for receiving screws and/or nails or other fasteners that enable the hanger bars 410 to be securely attached to a building structure. Although shown in FIG. 5 and described above in relation to holes and screws, in other embodiments, other mechanisms of attachment may be used in conjunction with the mounting blocks 412a, including resins, clips, or clamps to attach the bars 410 to the building structure. In one embodiment, the mounting blocks 412a may be integrated in one indivisible structure along with the hanger bars 410, while in other embodiments, as shown in FIG. 5, the mounting blocks 412a may be coupled to the hanger bars 410 through the use of one or more attachment mechanisms (e.g., screws, bolts, resins, clips, or clamps). Using the above telescoping and mounting features, the recessed lighting fixture 100a may be installed in almost all the 2″×2″ through 2″×18″ wood joist constructions, metal stud constructions, and T-bar ceiling constructions.

In one embodiment, referring back to FIG. 7, the recessed lighting fixture 100a may have a mounting mechanism that includes a set of hanger holders 430 (two are shown) that couple the outer casing 200a to the hanger bars 410, respectively. The hanger holder 430 may be a plate that is configured to slide substantially horizontally or otherwise move along the length of a corresponding hanger bar 410 that has a fixed length. Alternatively, the hanger holder 430 may be fixed to a telescoping section of the hanger bar (having a variable length).

FIG. 8 shows a perspective view of the hanger holder 430 according to one embodiment. The hanger holder 430 has an attachment mechanism 432 for coupling with the outer casing 200a, so that the outer casing 200a can be coupled to a hanger bar 410, as seen in FIG. 10. The attachment mechanism 432 may be a pin attached to and extending inward from the inner face of the plate of hanger holder 430. The attachment mechanism 432 may be inserted into an elongated opening 240 (e.g., slot, slit, etc.) in the sidewall 212 of the outer casing 200a. The hanger holder 430 may also include a tab 434 located near the attachment mechanism 432 that is inserted into the opening 240. The opening 240 may be vertically or substantially vertically oriented (parallel to the direction of the wall thickness tₑₙᵥ, or perpendicular to the longitudinal axis of the hanger bar 410—see FIG. 5) so that when the outer casing 200a is coupled to the hanger holder 430, the outer casing 200a may be moved up or down as desired (while restricted in the sideways or lateral direction due to the attachment mechanism 432 being captured within the elongated opening 240). The outer casing 200a may be moved along the length of the elongated opening 240 before being locked in a particular position. It is preferred that the elevation of the casing 200a behind the ceiling or wall 90 be adjusted in this manner so that the flange 138 of the trim 130b is flush with the ceiling or wall 90 as seen in FIG. 5 (i.e., the top surface 139 of the trim 130b physically contacts and is coplanar with a bottom surface 92 of the ceiling 90).

In another embodiment, the attachment mechanism 432 may be a screw that couples the hanger holder 430 to the outer casing 200a. When the screw is inserted into the opening 240 of the outer casing 200a and turned, the outer casing 200a may move up or down relative to the hanger bar 410 depending on the direction the screw is turned. Accordingly, the outer casing 200a, along with the light source module 114 and the driver 116, may be moved and adjusted so that the flange 138 is flush or sufficiently close to the ceiling or wall during installation. In yet another embodiment, the location of the attachment mechanism 432 and the elongated opening 240 are reversed, so that the opening 240 is formed in the hanger holder 430 rather than in the sidewall 212 of the outer casing 200a, and the attachment mechanism 432 is affixed to and extending outward from the outside surface of the sidewall 212 of the casing 200a.

By being moveably coupled to the hanger holders 430, the outer casing 200a, along with the light source module 114 and the driver 116 therein, may be moved in a length direction of the hanger bars 410 to a desired location. The outer casing 200a may also be moved substantially vertically relative to the hanger bars 410. For example, the outer casing 200a may be adjusted vertically more than one inch upwards and one inch downwards. The hanger holders 430 may then be fixed to the hanger bars 410 so that they no longer move substantially horizontally or vertically relative to the hanger bars 410.

As described above, the combination of a hanger bar 410 and a hanger holder 430 allows the outer casing 200a to be moved in a direction parallel to a longitudinal axis of the hanger bar 410, as well as in a direction not parallel (e.g., perpendicular) to the hanger bar 410. Accordingly, the outer casing 200a may be moved to a preferred location between a set of joists or beams in a structure and at a desired height before the being locked into position using the attachment mechanism 432. The unified casting 112 is then positioned inside the outer casing 200a, by being inserted into the cavity 210 through the opening defined by the lower end, edge or periphery of the sidewall 212. By being configured such that the outer casing 200a, along with the light source module 114 and the driver 116 therein, is coupled to a unified set of moveable elements that assist in positioning the combined structure, the recessed lighting fixture 100a eliminates the added bulk and size of traditional recessed lighting fixtures. In particular, the recessed lighting fixture 100a allows adjustment of the position of the light source module 114 between joists or beams, without the need for both a compartment or can that is dedicated to housing the light source module 114 and a separate compartment that is dedicated to housing the driver 116. Instead, the light source module 114 may be housed along with the driver 116 in the same cavity 210 of the outer casing 200a, where the latter itself can be directly moved to a desired position. This compact design provides an affordable design by cutting the cost of raw materials and other components and reduces shipping costs by reducing bulk. Also, by having the driver 116 and the light source module 114 placed in the same cavity of the outer casing 200a, serviceability and replacement of the driver 116 will be easier to perform and more convenient. In contrast, traditional housings have the driver 116 mounted on the outer casing 200a and contractors are forced to spend a significant amount of time removing parts to gain access to the outer casing 200a and the driver 116.

A Round-Shaped Housing with Multiple Sidewall Components

The housing 200, as described above, may generally be formed of metal. In some implementations, the housing 200 may be preferably formed of sheet metal to facilitate manufacture using various sheet metal forming processes. Although the housing 200 may appreciably simplify the overall design of the housing assembly and improve the ease of installation by combining (1) the functions of a conventional can housing and a conventional junction box together with (2) a round shape, the fabrication of a curved sheet metal component with complex structural features using conventional sheet metal forming processes can be challenging and costly if not designed carefully. Herein, the housing 200 may be an assembly of several components that together provide the desired structural features described above while each component remains relatively simple in design and, hence, readily manufacturable.

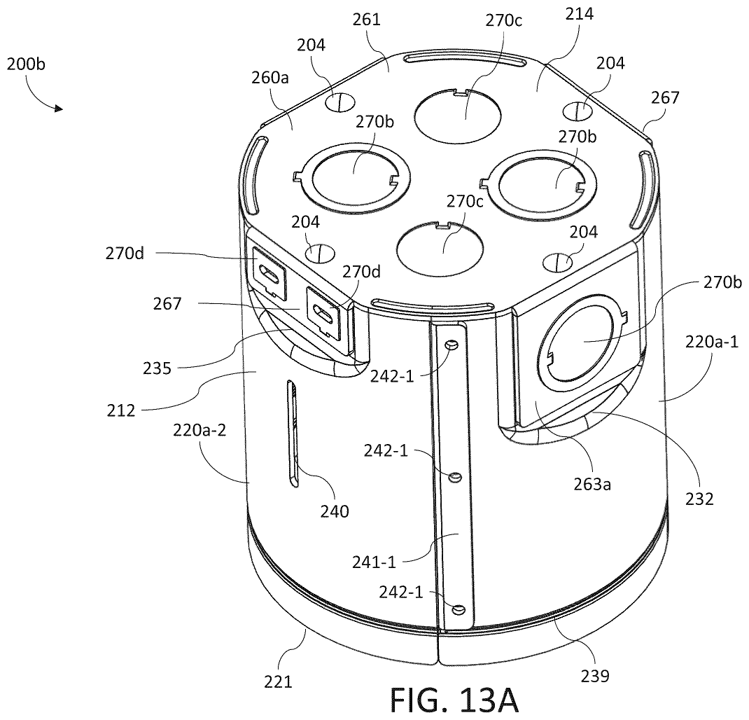

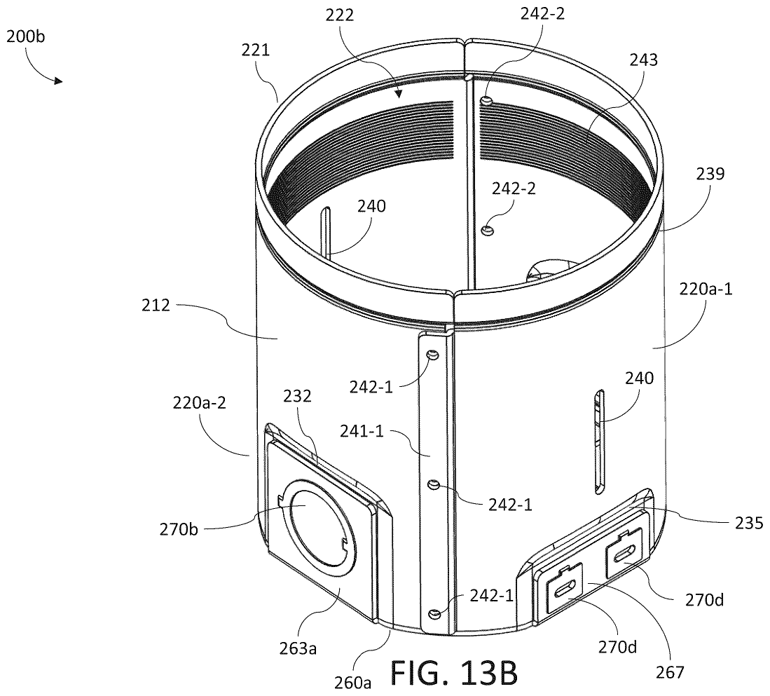

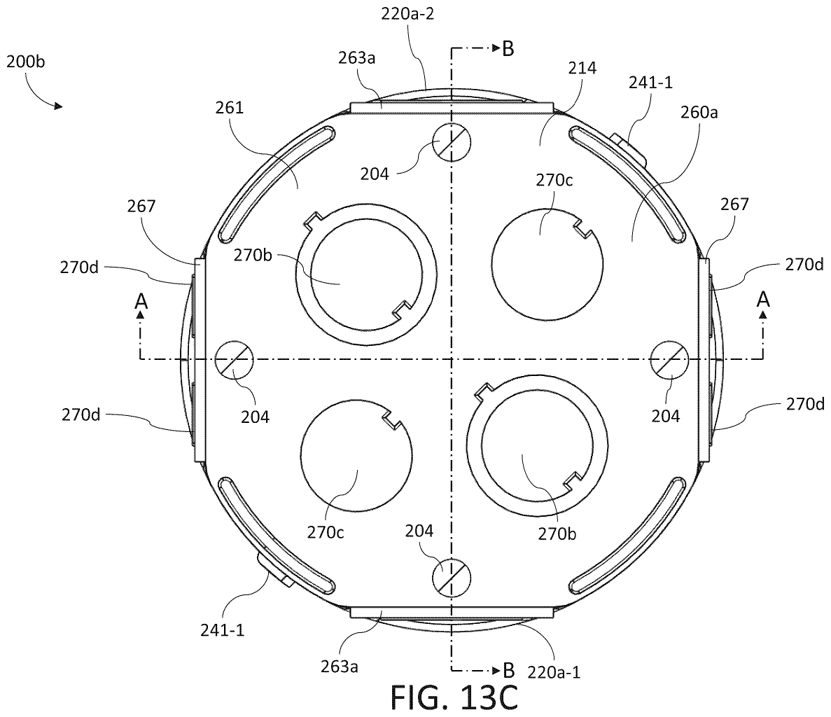

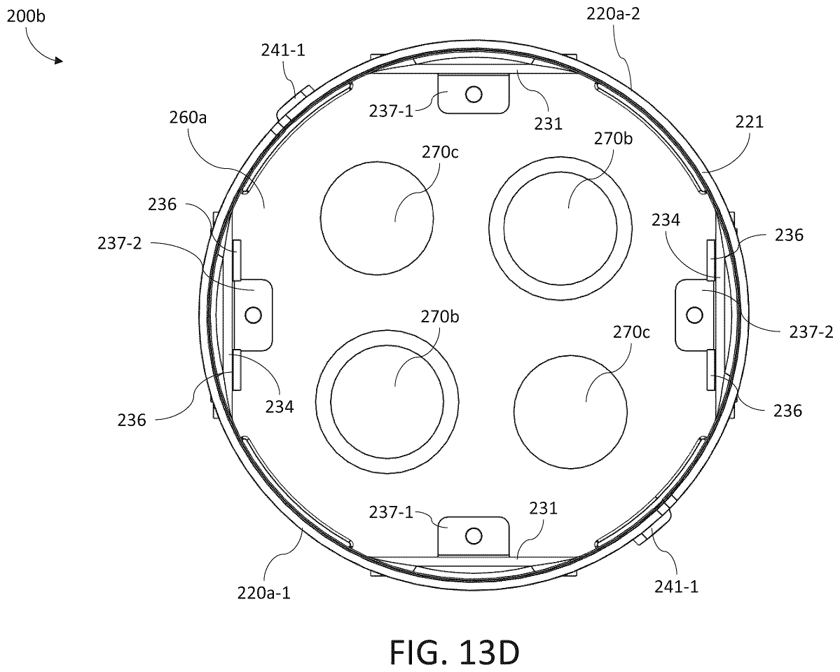

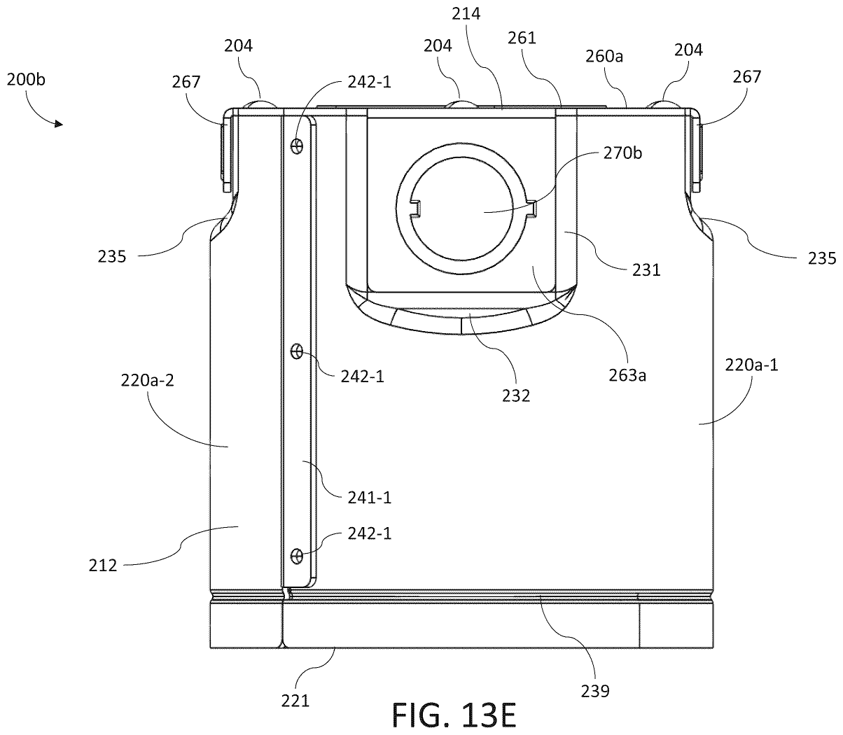

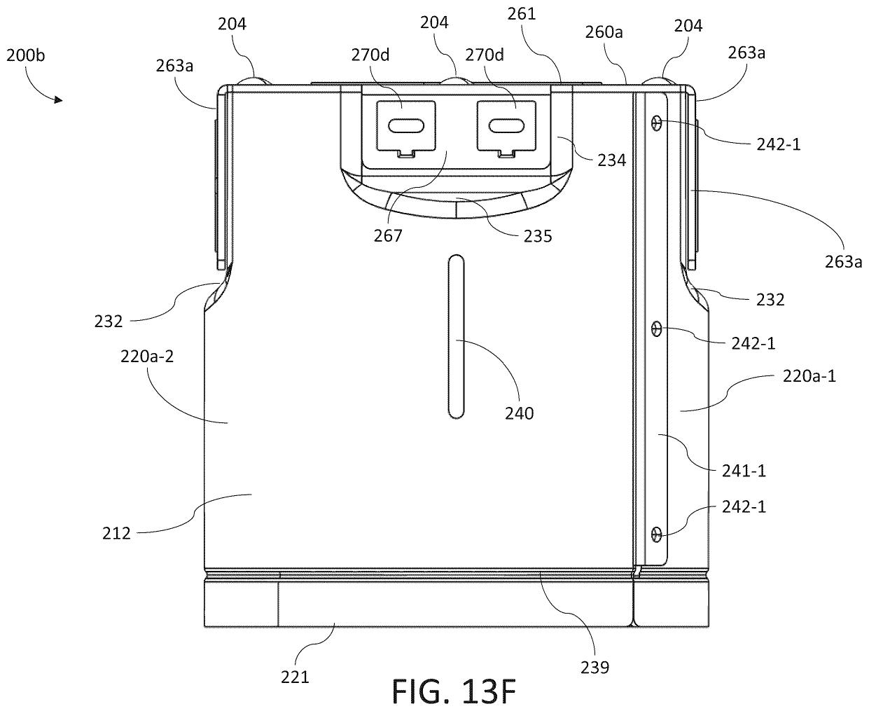

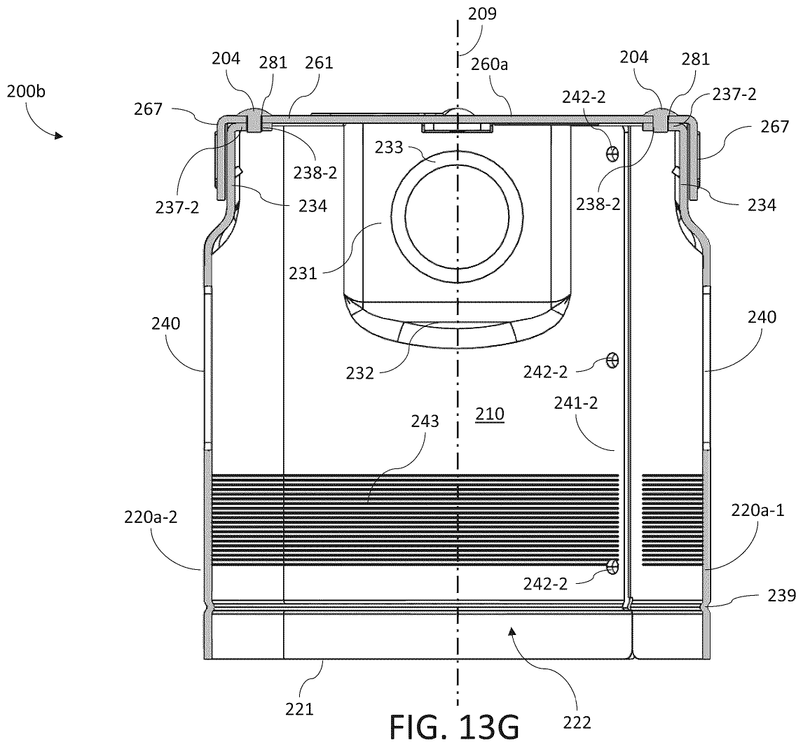

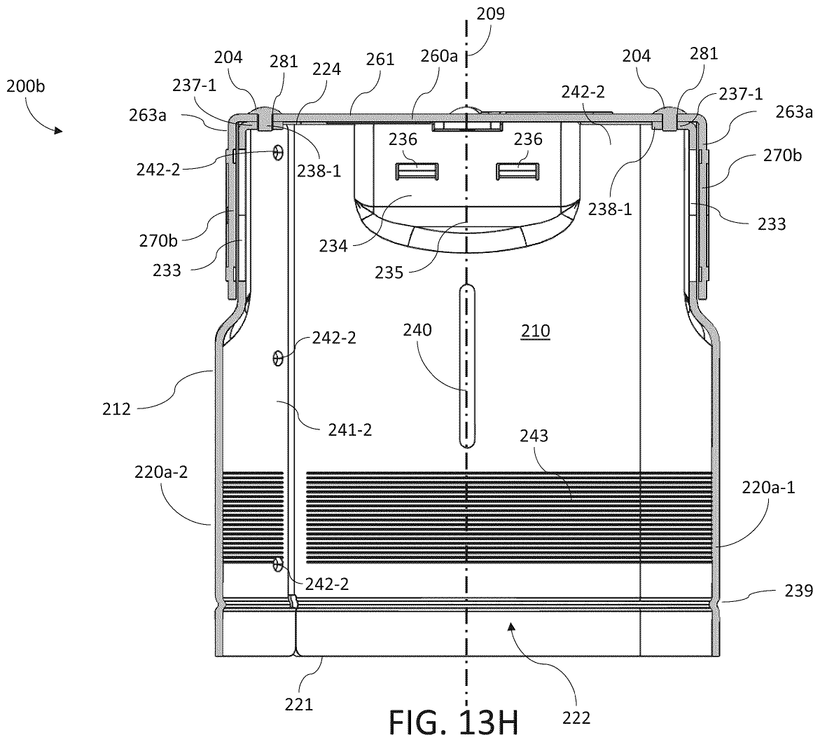

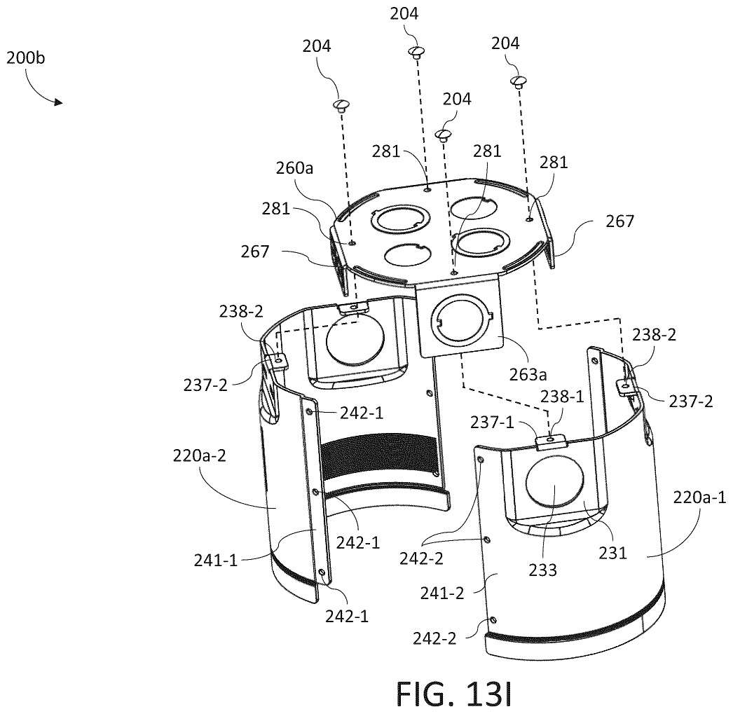

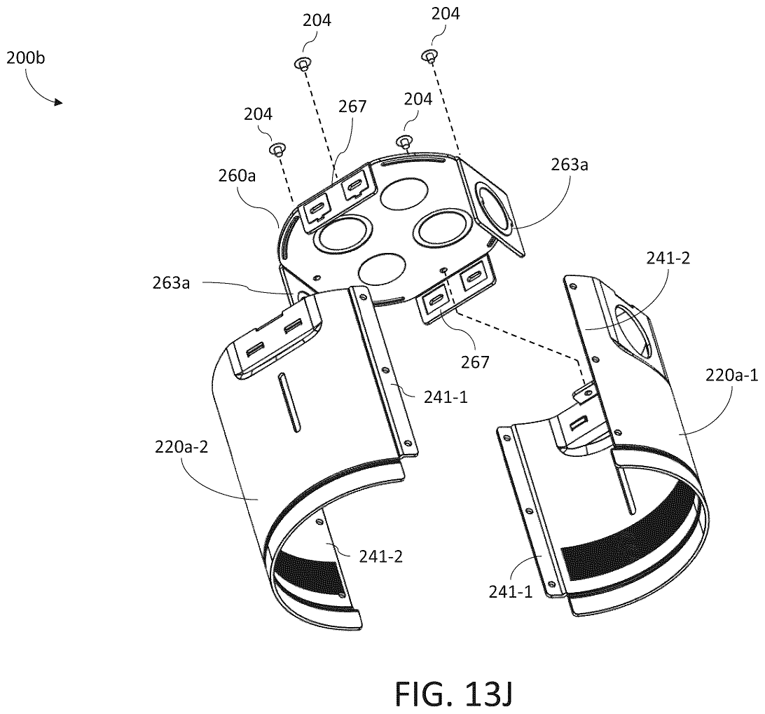

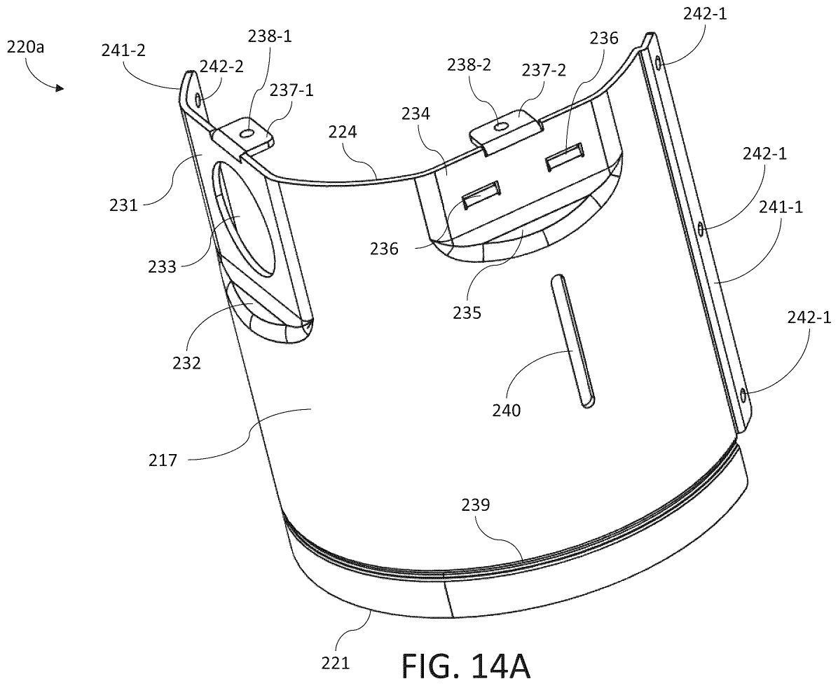

For example, FIGS. 13A-13J show several views of an exemplary housing 200b for a housing assembly 101b and a recessed lighting system 100b assembled from multiple sidewall components 220a-1 and 220a-2 (collectively referred to herein as “a sidewall component 220a”) and a top component 260a. As shown, the sidewall components 220a-1 and 220a-2 may define the round shape of the sidewall 212 of the housing 200b when joined together. The top component 260a may include substantially flat or flat sections that define, in part, the base end 214 of the housing 200b and support various junction box-related structural features, such as circular knockouts 270b and 270c and Romex knockouts 270d. By dividing the curved round-shaped structure and the more complex structural features (e.g., the junction-box related features) between the sidewall components 220a and the top component 260a, respectively, each of the sidewall components 220a and the top component 260a may be simpler in design and easier to manufacture.

It should be appreciated that, in the housing 200b, the top component 260a may include knockout tabs 263a and Romex tabs 267 disposed along the sides of the housing 200b and hence, may overlap portions of the sidewall components 220a-1 and 220a-2. However, for the purposes of defining the sidewall 212 and the base end 214, the sidewall components 220a-1 and 220a-2 may be viewed as defining together the sidewall 212 of the housing 200b and the top component 260a may be viewed as defining the base end 214 of the housing 200b.

The housing 200b may generally be shaped and/or dimensioned to contain a lighting module, at least a portion of a trim, one or more electrical wires, and one or more wire splices. As described above, the housing 200b, in some implementations, may be dimensioned to provide a volume allowance in accordance with Article 314.16 of the 2020 NEC. In some implementations, the housing 200b may have an exterior width of about 4.2 inches. More generally, the exterior width may range between about 4 inches and about 4.5 inches. In some implementations, the housing may have an exterior height of about 4.5 inches. More generally, the exterior height may range between about 4 inches and about 5 inches. The term “about,” when used to describe the exterior dimensions of the housing 200, is intended to cover manufacturing tolerances. For example, “about 4 inches” may correspond to the following dimensional ranges: 3.96 to 4.04 inches (+/−1% tolerance), 3.968 to 4.032 inches (+/−0.8% tolerance), 3.976 to 4.024 inches (+/−0.6% tolerance), 3.984 to 4.016 inches (+/−0.4% tolerance), 3.992 to 4.008 inches (+/−0.2% tolerance).

In some implementations, the sidewall components 220a-1 and 220a-2 may be substantially identical or identical to one another and may each form one half of the sidewall 212. This may further simplify manufacturing of the housing 200b by reducing the number of unique components fabricated since the sidewall components 220a-1 and 220a-2 represent one unique component.

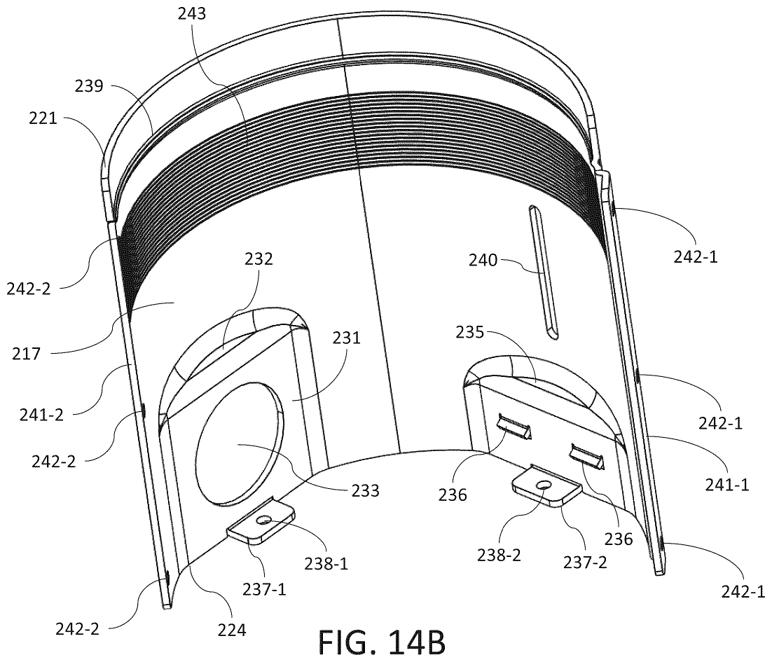

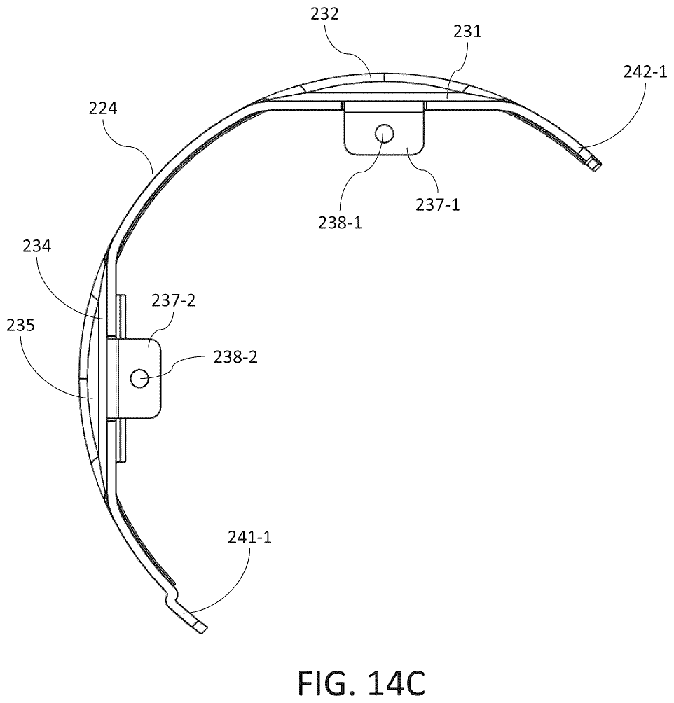

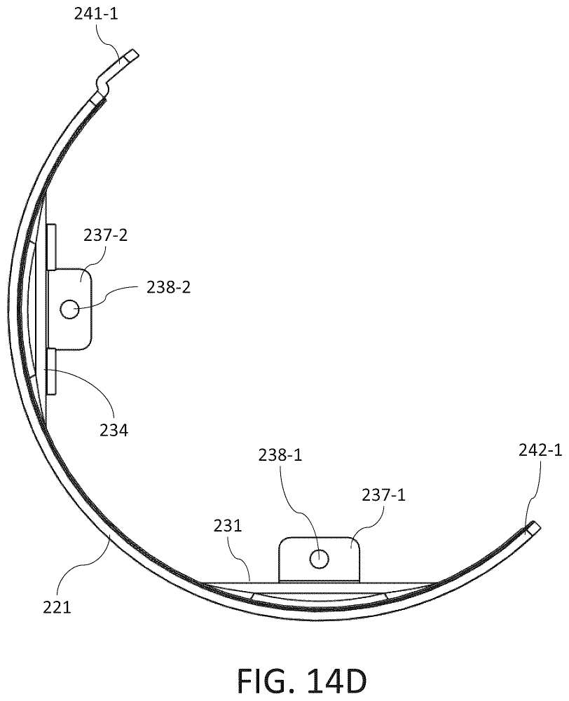

FIGS. 14A-14D show several additional views of the sidewall component 220a of the housing 200b. As shown, the sidewall component 220a may generally have a have a curved portion 217 with a bottom end 221, a top end 224, a side tab 241-1 and a side portion 241-2. Specifically, the bottom portion of the sidewall component 220a including the bottom end 221 may generally have a circular cross-sectional shape. In this manner, the portion of the housing 200b disposed near or within an opening formed in the ceiling during installation may have a round shape, thus simplifying the shape of the opening cut into the ceiling. In some implementations, the round shape of the housing 200b may also reduce the size of the opening cut into the ceiling especially if the lighting module has a round-shaped module housing, which would allow the housing 200b to conform in shape and dimensions with the lighting module.

In some implementations, the sidewall component 220a may also include one or more flat sections formed on or near the top end 224 to accommodate the knockouts on the top component 260a. The flat sections may be formed together with the curved portion 217 such that the sidewall component 220a remains a single unitary component. This may be accomplished, in part, by fabricating the sidewall component 220a using a deep drawing process where the sheet metal is radially drawn into a forming die with the desired curved and flat geometry.

Specifically, the sidewall component 220a may include a flat section 231 with an opening 233 that aligns with the circular knockout 270b disposed on the knockout tabs 263a of the top component 260a. The flat section 231 may generally be larger than the opening 233 to provide sufficient clearance around the opening 233. The flat section 231 may extend from the top end 224 down towards the bottom end 221 by a distance approximately equal to the height of the knockout tab 263a of the top component 260a. The sidewall component 220a may further include a sloped section 232 disposed directly below the flat section 231 to transition between the flat section 231 and the curved portion 217.

The sidewall component 220a may also include a flat section 234 offset approximately 90 degrees with respect to the flat section 231 about a centerline axis 209 of the housing 200b (i.e., an axis intersecting the center of the base section 261 of the top component 260a). The flat section 234 may include multiple openings 236 that align with the Romex knockouts 270d disposed on the Romex tabs 267 of the top component 260a. The flat section 234 may also extend from the top end 224 down towards the bottom end 221 by a distance approximately equal to the height of the Romex tab 267 of the top component 260a. The sidewall component 220a may also include a sloped section 235 disposed directly below the flat section 234 to transition between the flat section 234 and the curved portion 217. The sloped sections 232 and 235 may each taper downwards towards the bottom end 221.

As shown in FIGS. 14A and 14C, the flat section sections 231 and 234 may be separated by the curved portion 217 of the sidewall component 220a. Thus, the top portion of the sidewall component 220a including the top end 224 may have a cross-sectional shape that includes a first straight section corresponding to the flat section 231, a second straight section corresponding to the flat section 234, and circular sections corresponding to the circular portion 217 between and to the sides of the first and second straight sections. It should be appreciated the height of the flat sections 231 and 234 may not be equal, hence, the cross-sectional shape may only include one of the first or second straight sections depending on whether the cross-sectional plane intersects the flat sections 231 and/or 234.

The sidewall component 220a may thus have a cross-sectional shape that varies along its height. Depending on the location of the cross-sectional plane along the height of the sidewall component 220a, the cross-sectional shape of the sidewall component 220a may generally include, but is not limited to, a circular section, an elliptical section, a straight section, or any combinations of the foregoing. In some implementations, the sidewall components 220a may define a sidewall 212 that is shaped as a right cylinder. Said in another way, the interior and/or exterior sides of the curved portion 217 and/or the flat sections 231 and 234 of the sidewall component 220a may be oriented substantially vertical or vertical.

The side tab 241-1 of the sidewall component 220a may protrude radially outwards with respect to the side portion 241-2. In this manner, the side tab 241-1 of one sidewall component 220a may overlap and abut the side portion 241-2 of the other sidewall component 220a as shown in FIGS. 13C and 13D. The side tab 241-1 may further include multiple fastener openings 242-1 that align with corresponding fastener openings 242-2 disposed on the side portion 241-2. During assembly, respective fasteners (e.g., rivets, screw fasteners, bolt fasteners) may be inserted through respective pairs of openings 242-1 and 242-2 to join the sidewall components 220a-1 and 220a-2 together. It should be appreciated that, in some implementations, the respective side tabs 241-1 and side portions 241-2 of the sidewall components 220a-1 and 220a-2 may be welded together and, hence, may not include any fastener openings or fasteners.

When the sidewall components 220a-1 and 220a-2 are coupled together, the sidewall components 220a-1 and 220a-2 may surround and define the cavity 210 of the housing 200b. The respective bottom ends 221 of the sidewall components 220a-1 and 220a-2 may further define the bottom opening 222, which provides access to the cavity 210. The top ends 224 of the sidewall components 220a-1 and 220a-2 may further provide a surface onto which the top component 260a may be disposed and connected to the sidewall components 220a-1 and 220a-2.

In some implementations, the top end 224 of the sidewall component 220a may further include mounting tabs 237-1 and 237-2 that are oriented along a horizontal plane with respect to the sidewall 212. The tabs 237-1 and 237-2 may further include fastener openings 238-1 and 238-2, respectively, which align with corresponding fastener openings 281 on the base section 261 of the top component 260a. During assembly, rivet fasteners 204 may be inserted through the openings 281 and the openings 238-1 or 238-2 to couple the top component 260a to the sidewall components 220a-1 and 220a-2 as shown in FIGS. 13I and 13J. In some implementations, the tabs 237-1 and 237-2 may be positioned along the portions of the top end 224 that join the flat sections 231 and 234, respectively. This may improve manufacturability of the sidewall component 220a since the tabs 237-1 and 237-2 may initially be formed on the same plane as the flat sections 231 and 234 and, hence, may be easier to bend to the desired orientation shown in FIGS. 14A and 14C especially if sidewall component 220a is formed with the curved portion 217 and the flat sections 231 and 234.

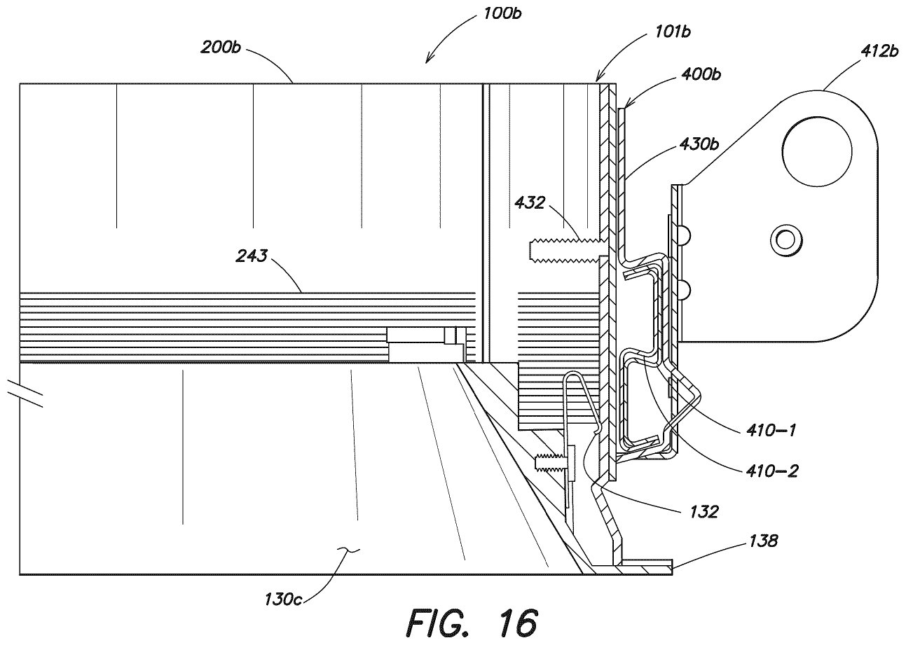

In some implementations, the sidewall component 220a may further include an opening 240 disposed on the curved portion 217 to couple a bar hanger assembly to the housing 200b for a new construction installation. For example, FIG. 16 shows an exemplary lighting system 100b with the lighting module removed to show a trim 130c and a bar hanger assembly 400b mounted to the housing 100b. As shown, the bar hanger assembly 400b may include a bar hanger holder 430b with a rod 432 inserted through the opening 240 to couple the bar hanger holder 430b to the housing 200b. The bar hanger holder 430b may further support a pair of bar hangers 410-1 and 410-2 that are slidably coupled to the bar hanger holder 430b and telescopically coupled to each other. Each bar hanger 410-2 and 410-2 may further include a bar hanger head (e.g., the bar hanger heads 412a, 412b) to mount the housing assembly 101b to support structures in the environment.

As shown in FIG. 13F, the opening 240 may be shaped as a vertical slot, to enable vertical adjustment of the housing 200b with respect to the bar hanger holder 430b by allowing the rod 432 to slidably move along the opening 240. The bar hanger holder 430b, in turn, may enable horizontal adjustment of the housing 200b with respect to the bar hangers and, hence, the support structures in the environment. It should be appreciated that respective openings 240 of the sidewall components 220a-1 and 220a-2 are disposed diametrically opposite to one another when the sidewall components 220a-1 and 220a-2 are joined together due to the sidewall components 220a-1 and 220a-2 being identical to one another. The housing assembly 101b may thus include a bar hanger assembly 400b disposed on opposing sides of the housing 200b.

In some implementations, the sidewall component 220a may also include a series of grooves 243 disposed on an interior side of the curved portion 217 near the bottom end 221. The grooves 243 may provide a textured surface for the friction clips 132 of the trim 130c to contact, thus increasing the frictional force holding the trim 130c onto the housing 200b. FIG. 16 shows the friction clip 132 in physically contact with the grooves 243 when the trim 130c is sufficiently inserted into the cavity 210 such that a flange 138 abuts the bottom end 221 of the housing 200b. As shown in FIGS. 13H and 13I, the grooves 243 may be oriented in parallel alignment with the bottom end 221 and may also extend from the side tab 241-1 to the side portion 241-2. The sidewall component 220a may include multiple grooves 243 spanning a portion of the height of the sidewall component 220a to accommodate different sized trims and/or trims with different sized spring clips.

As described above, the lighting module may generally be electrically grounded to the housing 200b. In some implementations, this may be accomplished by connecting a ground wire or cable on the lighting module to a ground cable connected to the housing 200b. In some implementations, the trim 130c may provide an electrical pathway to ground the lighting module to the housing 200b. For example, the body of the trim 130c and the friction clips 132 may be formed of metal. To ground the trim 130c to the housing 200b, a portion of the interior surfaces of the sidewall components 220a may be uncoated and/or unpainted to expose the underlying metal. For example, the sidewall components 220a may have exposed metal along the grooves 243. When the trim 130c is inserted into the housing 200b, the physical contact between the friction clips 132 and the exposed portions of the sidewall component 220a may electrically ground the trim 130c to the housing 200c. The trim 130c, in turn, may be electrically grounded to the module housing of the lighting module.

In some implementations, the installation of conventional housing assemblies often leads to gaps formed between the housing and the opening in the ceiling resulting in unwanted air leaks. For example, the user may accidentally cut an opening in the ceiling that is larger than required to accommodate the housing 200b. If not compensated properly, air leaks may lead to higher energy consumption and/or costs for cooling and/or heating of the environment. Air leaks may also leave the ceiling space susceptible to moisture accumulation and mold growth.

To mitigate potential air leaks formed between the housing 200b and the opening formed in the ceiling, the sidewall components 220a may include a groove 239 formed on the exterior side of the curved portion 217 near the bottom end 221 to support a gasket (not shown). As shown in FIGS. 13E and 13F, the groove 239 may be in parallel alignment with the bottom end 221 and recessed into the cavity 210. The groove 239 may further extend from the side tab 241-1 to the side portion 241-2. The groove 239 may be offset vertically from the bottom end 221 such that the gasket may fill the gaps formed between the housing 200b and the edges of the ceiling defining the opening when the bottom end 221 of the housing 200b is inserted into the opening during installation. In some implementations, the groove 239 may be disposed below the grooves 243. It should be appreciated that other sealing mechanisms may be utilized to mitigate air leak including, but not limited to, a curable sealant and flexible tape.

In some implementations, the groove 239 may also provide a safety feature to prevent the trim 130c from falling out from the housing 200b in the event the friction clips 132 disengage from the grooves 243 or, more generally, the curved portion 217 of the sidewall component 220a. Specifically, the groove 239, as described above, may be recessed into the cavity 210, which results in a lip formed along the interior sides of the sidewall 212. When the trim 130c is installed, the friction clips 132 may be disposed above the lip. Thus, in the event the friction clips 132 loses contact with the grooves 243 and/or otherwise becomes loose, the lip formed by the groove 239 may catch the spring clip 132 thus preventing the trim 130c from falling out of the housing 200b.

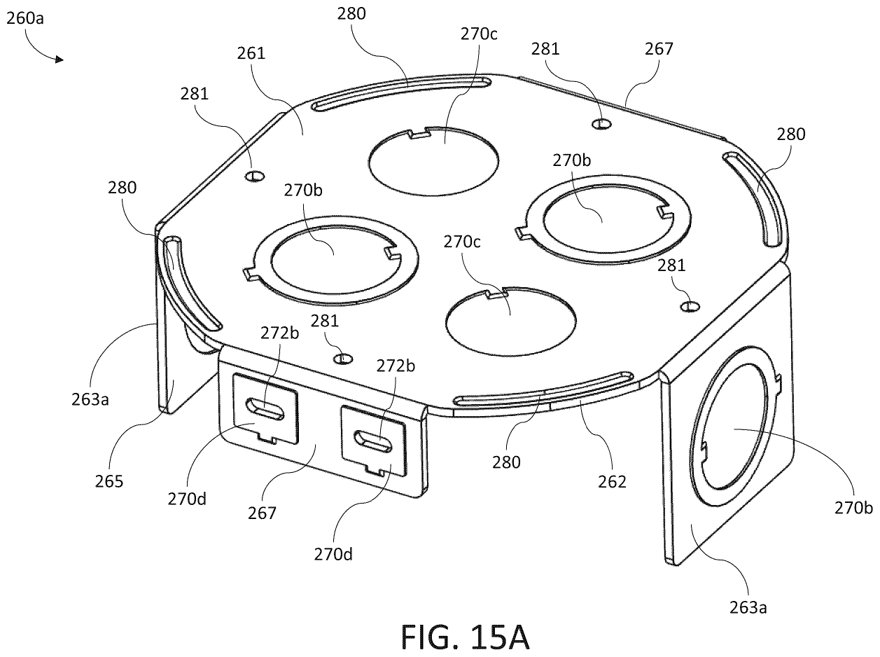

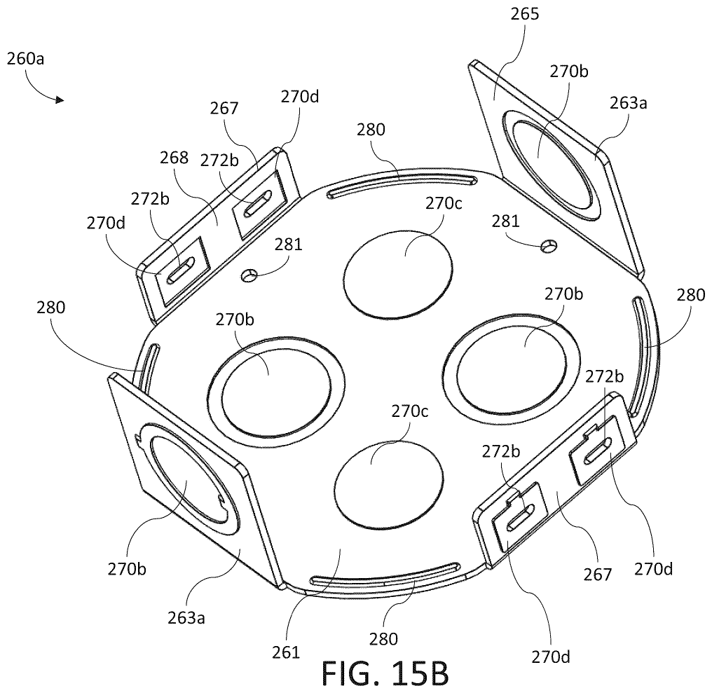

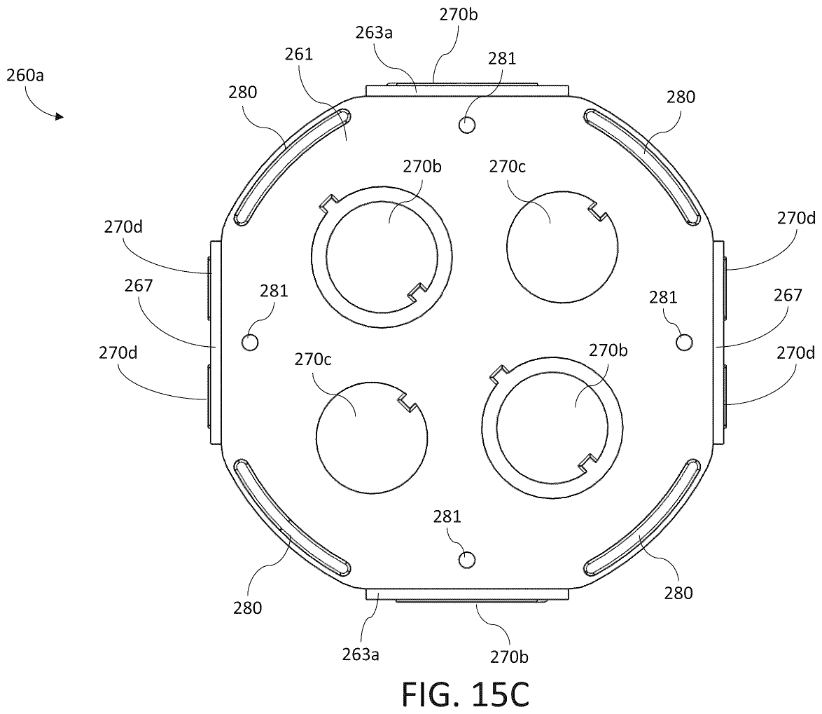

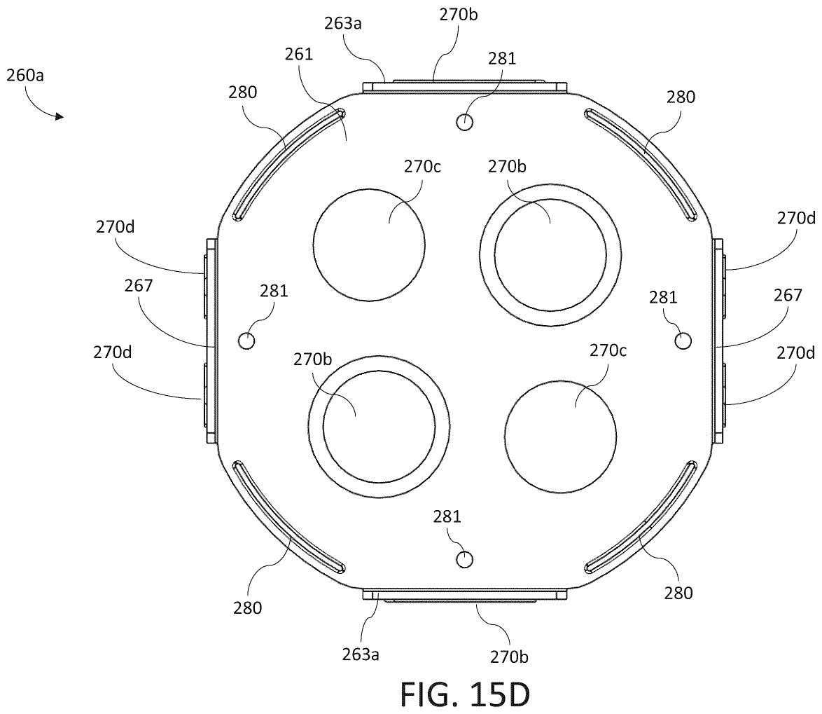

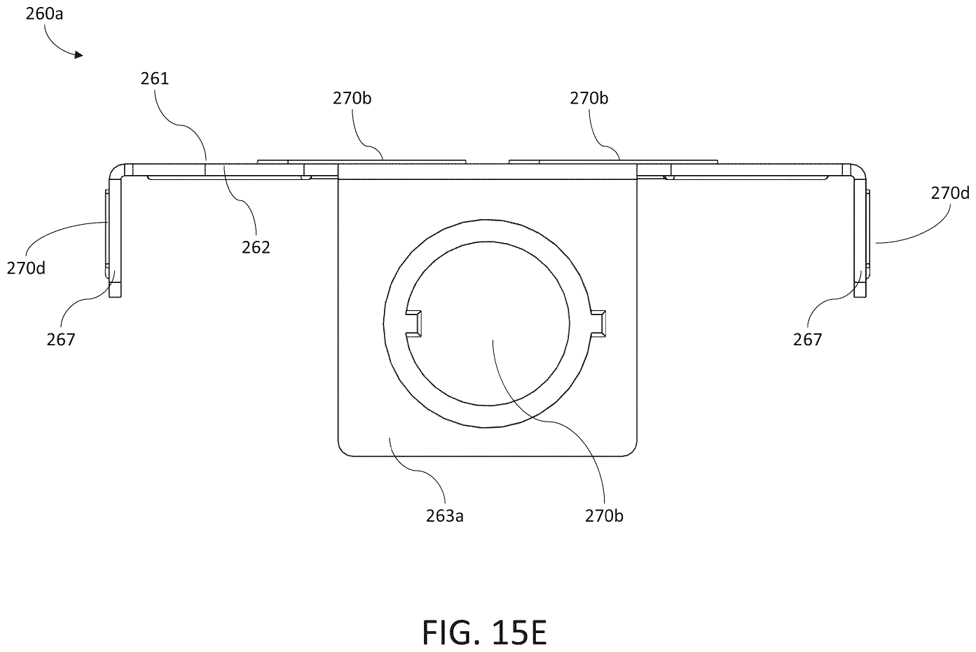

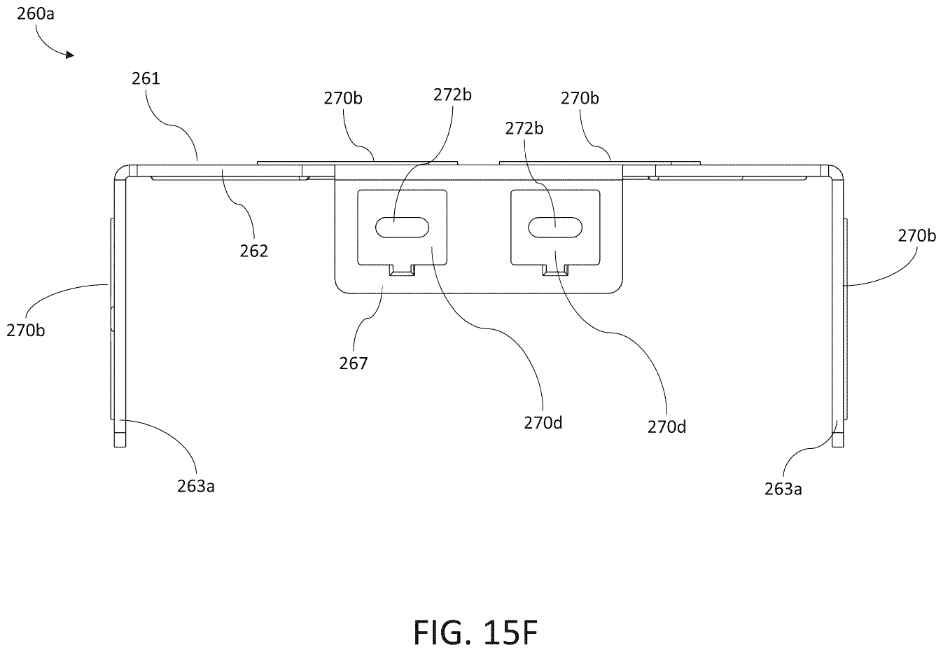

FIGS. 15A-15F show several additional views of the top component 260a of the housing 200b. As shown, the top component 260a may include a base section 261 that covers the top ends 224 of the sidewall components 220a-1 and 220a-2. The base section 261 may generally be shaped and dimensioned to conform with the top ends 224 of the sidewall components 220a-1 and 220a-2 such that an outer edge 262 of the base section 261 is substantially flush or flush with the sidewall components 220a-1 and 220a-2 (i.e., the outer edge 262 is aligned with an exterior edge of the top end 224) as shown in FIGS. 13A and 13C. For example, the outer edge 262 of the base section 261 may have multiple straight sections corresponding to the flat sections 231 and 234 of the sidewall components 220a-1 and 220a-2 separated by circular sections.

As described above, the top component 260a may also include a pair of knockout tabs 263a and a pair of Romex tabs 267 that extend from the base section 261 and oriented to cover the respective flat sections 231 and 234 of the sidewall components 220a-1 and 220a-2. Specifically, each knockout tab 263a may include an interior side 265 that abuts the exterior side of one flat section 231. Similarly, each Romex tab 267 may include an interior side 268 that abuts the exterior side of one flat section 234.

In some implementations, the knockout tabs 263a and the Romex tabs 267 may be offset 90 degrees with respect to one another about the centerline axis 209 of the housing 200b. The pair of knockout tabs 263a may further be disposed diametrically opposite with respect to one another. The pair of Romex tabs 267 may also be disposed diametrically opposite with respect to one another. It should be appreciated that, in some implementations, the pair of knockout tabs 263a and/or the pair of Romex tabs 267 may be offset at any angle about the centerline axis 209 so long as the knockout tabs 263a and the Romex tabs 267 do not interfere in a manner that would prohibit the placement of a knockout (e.g., the circular knockout 270b, the Romex knockout 270d). It should be appreciated the flat sections 231 and 234 of the sidewall component 220a may be repositioned to align with the knockout tabs 263a and the Romex tabs 267. In some implementations, this may result in the sidewall components 220a-1 and 220a-2 having a different geometry. In one example, the knockout tabs 263a and the Romex tabs 267 may be disposed on one side of the housing 200b (e.g., the knockout tabs 263a and the Romex tabs 267 are offset by 60 degrees with respect to one another with one pair of knockout tabs 263a and the Romex tabs 267 offset by 180 degrees).

As shown in FIGS. 15E and 15F, the knockout tabs 263a and the Romex tabs 267 may also be oriented substantially vertical or vertical while the base section 261 may be oriented substantially horizontal or horizontal. In other words, the knockout tabs 263a and the Romex tabs 267 may be oriented at a right angle with respect to the base section 261. However, it should be appreciated that, in some implementations, one or more of the knockout tabs 263a and/or the Romex tabs 267 may be oriented at any angle relative to the base section 261. For example, the knockout tab 263a or the Romex tab 267 may taper outwards away from the centerline axis 209 or inwards towards the centerline axis 209 of the housing 200b.

In some implementations, the base section 261, the knockout tabs 263a, and the Romex tabs 267 may be substantially flat or flat in shape. The flat geometry of the top component 260a may improve the ease of manufacture since the knockout tabs 263a and the Romex tabs 267 may initially be formed along the same plane as the base section 261 and subsequently bent to the desired orientation. Additionally, complex structural features may be more readily formed on the flat surfaces of the top component 260a.

For example, the base section 261 may include multiple circular knockouts 270b and 270c. Each knockout tab 263a may include one circular knockout 270b. Each Romex tab 267 may include a pair of Romex knockouts 270d. The knockout 270b may be a concentric knockout that allows the installer to remove an inner portion to form a smaller opening and, optionally, an outer portion to form a larger opening. For example, the removal of the inner portion of the knockout 270b may result in an opening that is ½ inch in diameter. If the outer portion of the knockout 270b is removed, the opening may be ¾ inch in diameter. The knockout 270c may be a single knockout that provides an opening with one size. For example, the knockout 270c, when removed, may form an opening that is ½ inch in diameter. More generally, the knockouts 270b and 270c, when removed, may provide an opening with a diameter that ranges between about 0.5 inches to about 1.25 inches.

The Romex knockouts 270d may be similarly removed to provide an opening into the cavity 210. Compared to the circular knockouts 270b and 270c, the Romex knockouts 270d may provide a relatively smaller opening when removed. For example, the opening formed by the removal of the Romex knockout 270d may have a width or height that ranges between about 0.25 inches to about 0.75 inches. In some implementations, each Romex knockout 270d may further include a slot 272b shaped to receive an end of a tool (e.g., a flathead screwdriver) to facilitate removal of the Romex knockout 270d.

The term “about,” when used to describe the openings formed by the removal of the circular and Romex knockouts, is intended to cover manufacturing tolerances and variances in dimensions due to the removal of the knockouts. For example, “about 0.5 inches” may correspond to the following dimensional ranges: 0.495 to 0.505 inches (+/−1% tolerance), 0.496 to 0.504 inches (+/−0.8% tolerance), 0.497 to 0.503 inches (+/−0.6% tolerance), 0.498 to 0.502 inches (+/−0.4% tolerance), 0.499 to 0.501 inches (+/−0.2% tolerance).

In some implementations, the placement of the knockout tabs 263a and the Romex tabs 267 may also allow for straight conduit runs where a conduit cable may extend through the housing 200b by passing through openings formed on opposite sides of the housing 200b. For example, the removal of the circular knockouts 270b on the knockout tabs 263a may provide openings that allow a straight conduit cable to pass through the housing 200b. Similarly, the removal of Romex knockouts 270d disposed directly opposite to one another on the Romex tabs 267 may similarly allow a smaller conduit cable to pass straight through the housing 200b.

As noted above, the base section 261 may include multiple fastener openings 281 to facilitate attachment with the sidewall components 220a-1 and 220a-2 via rivet fasteners 204. FIGS. 15A-15D also show the base section 261 may include ribs 280 formed along the periphery near the curved portions of the outer edge 262 that extend into the cavity 210. In some implementations, the ribs 280 may help align the top component 260a to the sidewall components 220a-1 and 220a-2 during assembly. Specifically, the ribs 280 may abut the interior edge of the top end 224 of the sidewall components 220a-1 and 220a-2 to align the openings 281 to the openings 238-1 and 238-2 on each sidewall component 220a. In some implementations, the base section 261 may further include an opening (not shown) to connect a ground cable directly to the housing 200b.

A Round-Shaped Housing with a Single Sidewall Component

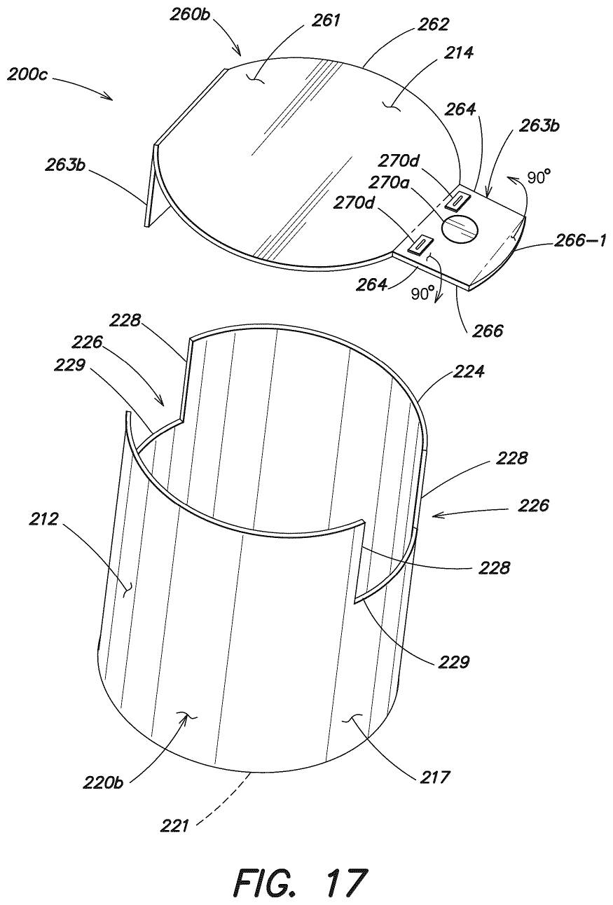

FIG. 17 shows another exemplary housing 200c assembled using a sidewall component 220b and a top component 260b. As shown, the sidewall component 220b may define the round shape of the sidewall 212 in the same manner as the sidewall components 220a in the housing 200b. In this implementation, however, the housing 200c may include a single sidewall component 220b with a curved portion 217 that surrounds and defines the cavity of the housing 200c. The sidewall component 220b may further include a bottom end 221 that defines a bottom opening (not shown) into the cavity 210. Said in another way, the sidewall component 220b is a single unitary component that defines at least a portion of the sidewall 212 in a similar manner as the assembly of the sidewall components 220a-1 and 220a-2 in the housing 200b. The top component 260b may once again cover a top end 224 of the sidewall component 220b and provide various knockout features. Thus, the housing 200c may be assembled from only two components.

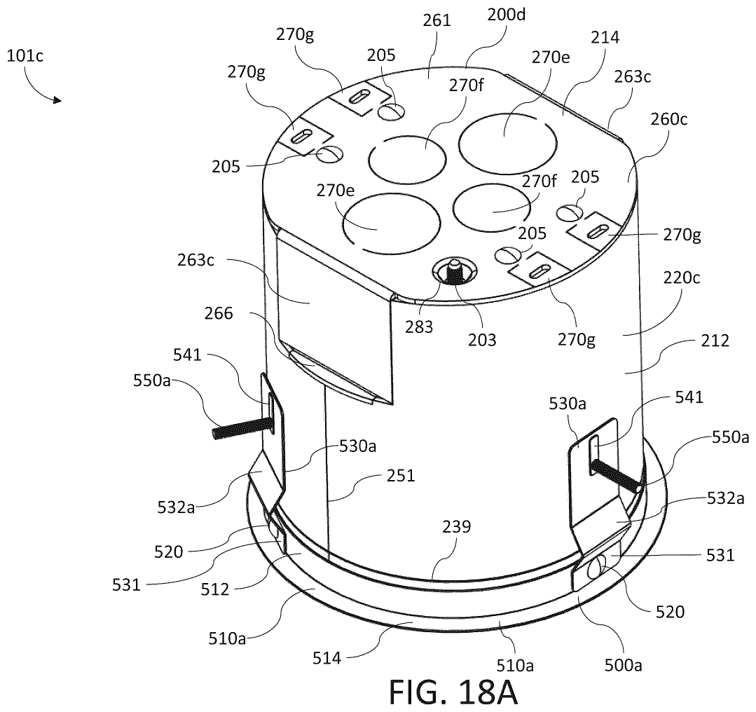

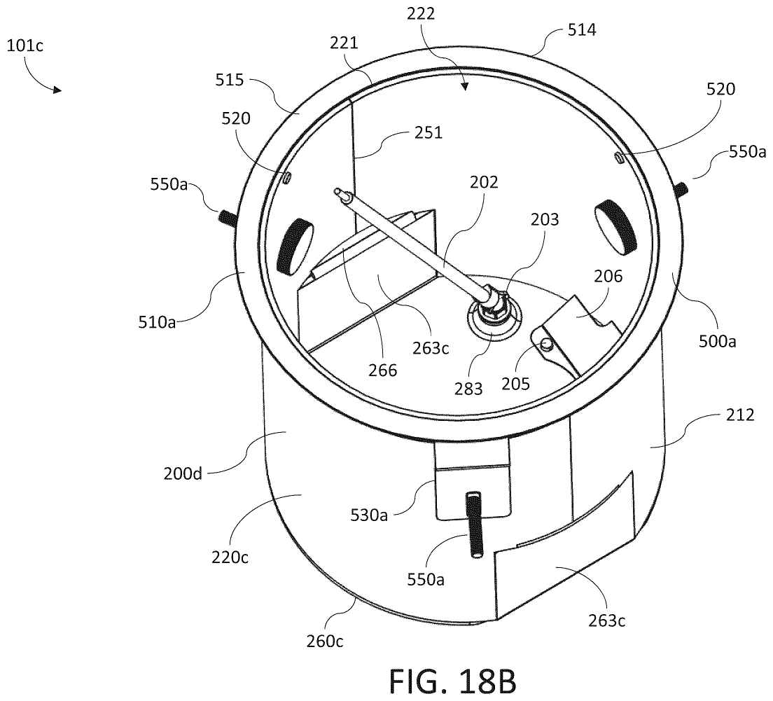

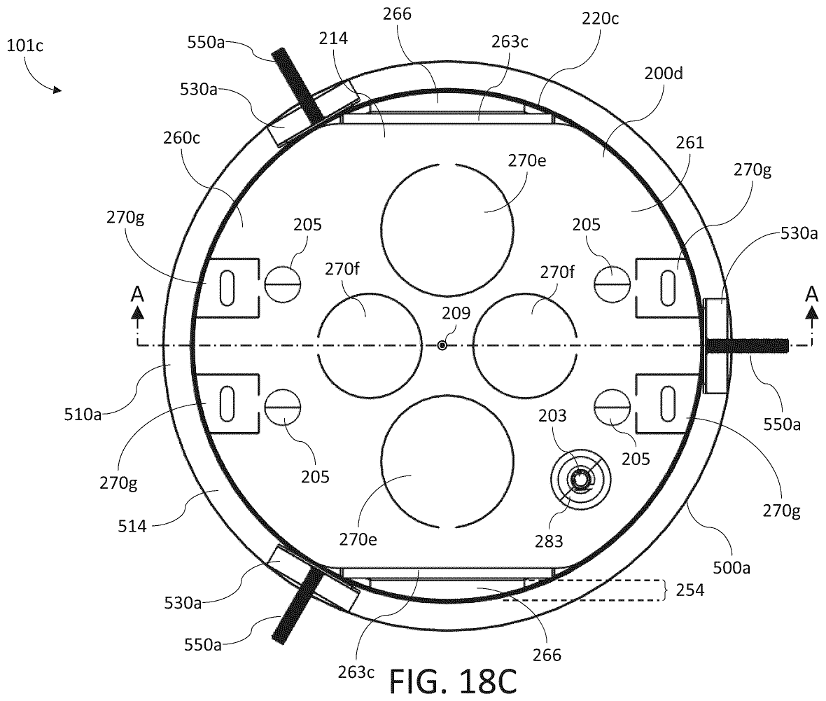

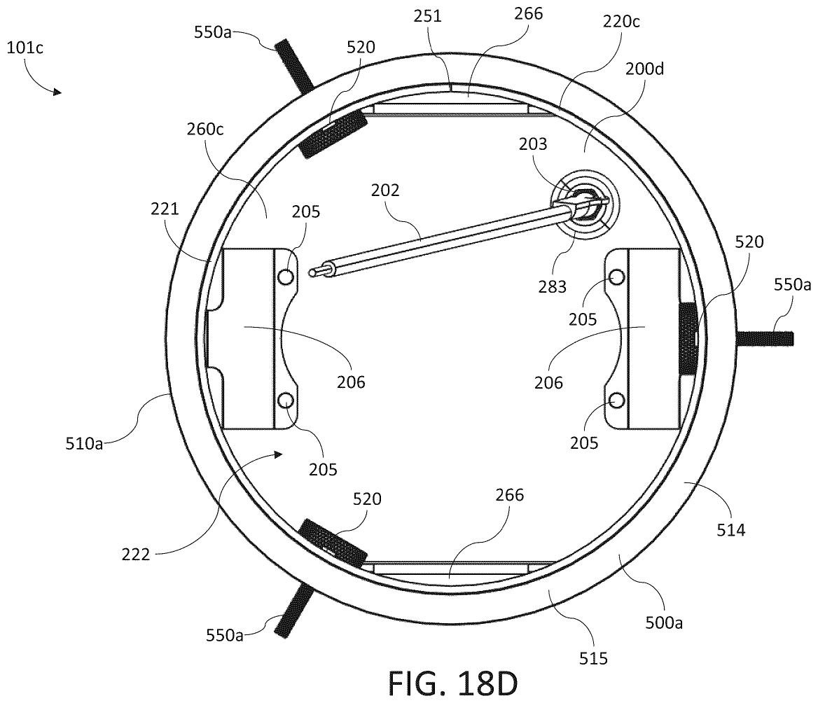

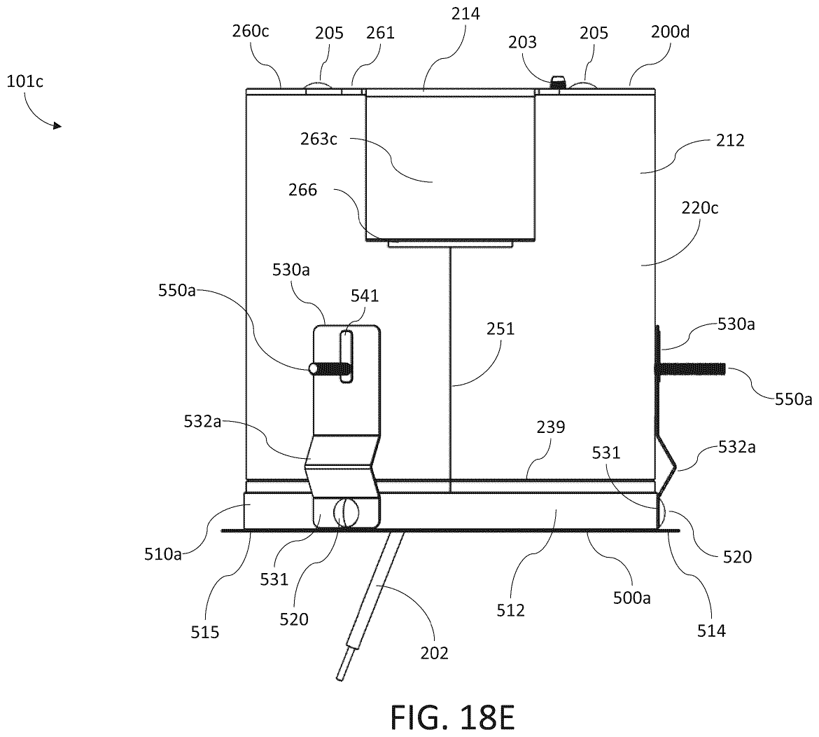

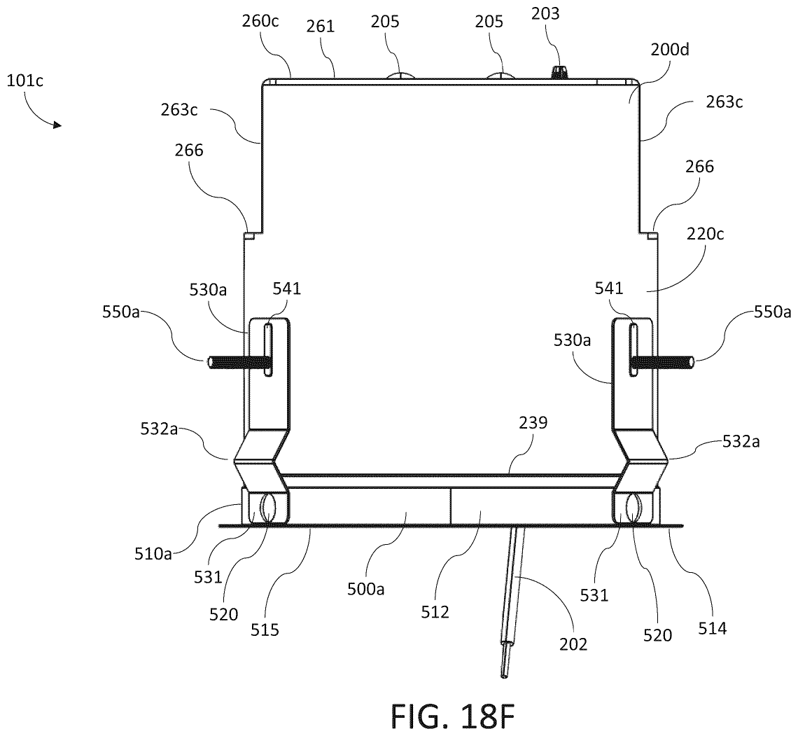

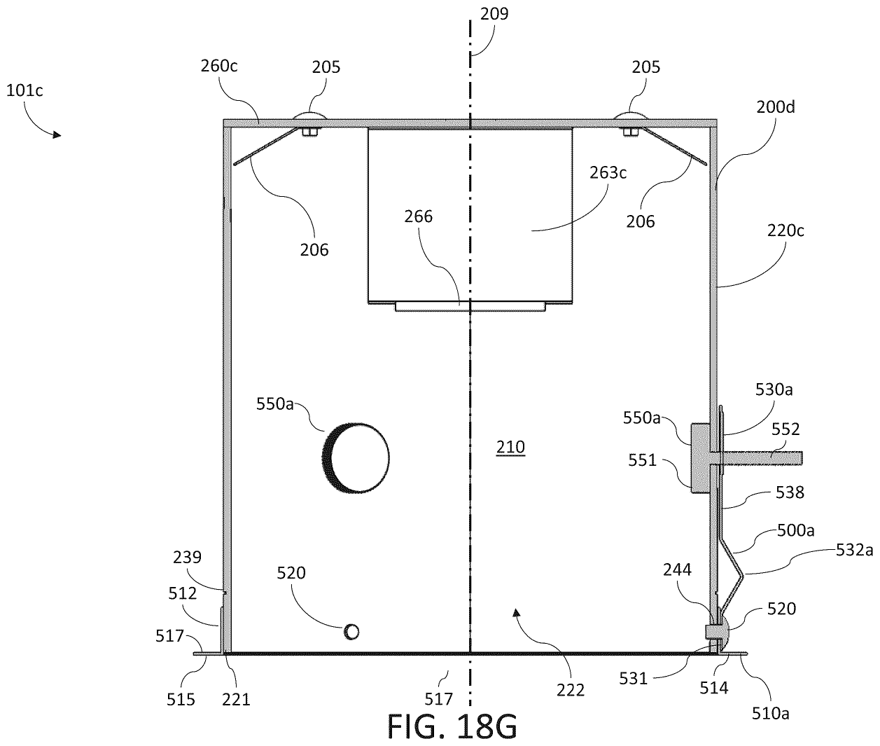

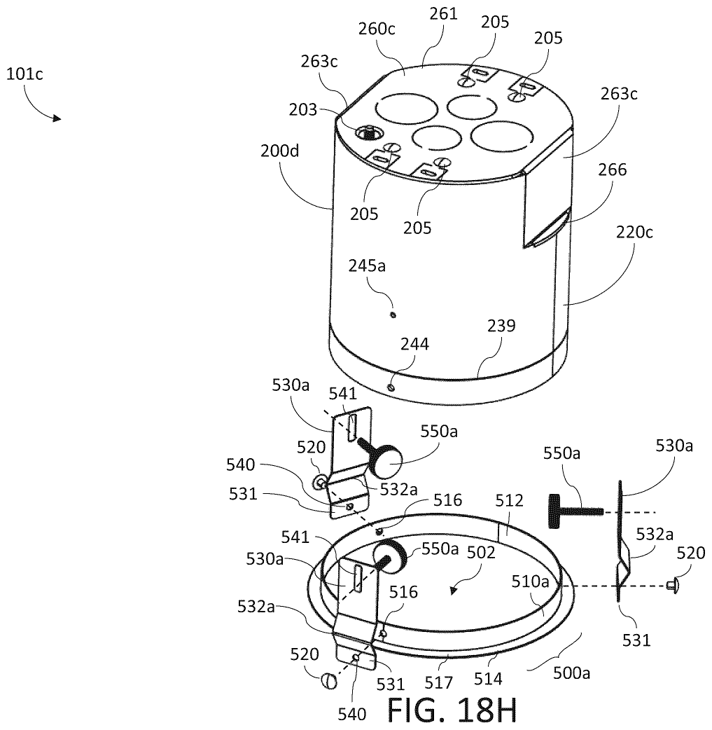

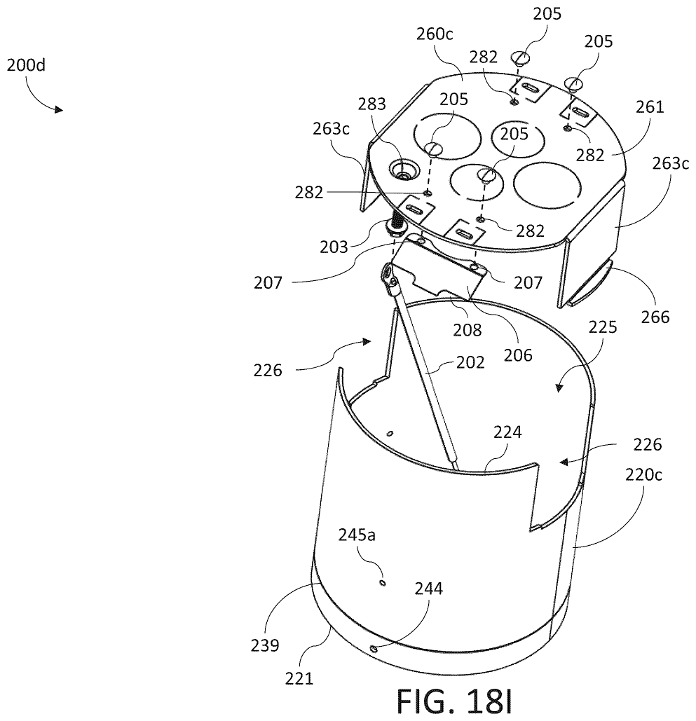

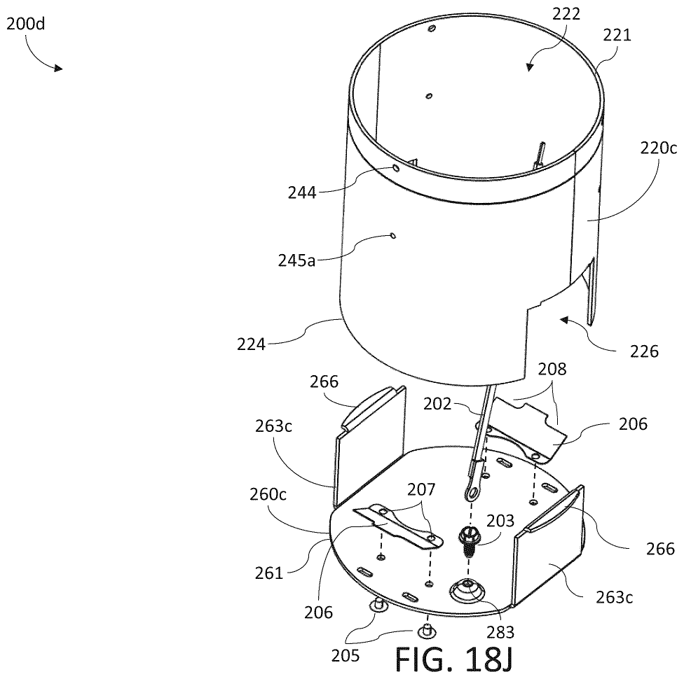

This may be accomplished, in part, by simplifying the geometry of the sidewall component 220b such that there are no flat sections or, more generally, no portions that deviate in shape from the curved geometry of the sidewall 212. In other words, the sidewall component 220b may only include a curved portion 217. This may simplify manufacture of the sidewall component 220b by eliminating additional process steps to form the sidewall component 220b into the desired shape. For example, the sidewall component 220b may be formed by rolling a single piece of sheet metal into a round shape. In some implementations, the sidewall component 220b may be formed as a tube with a uniform thickness. Once rolled, the opposing sides of the sidewall component 220b may form a seam, which may be welded together (see for example, the housings 200d, 200g, and 200i of FIGS. 18A-18J, 28A-28N, and 30A-30I, respectively). It should be appreciated that other sheet metal forming processes may be used to fabricate the sidewall component 220b including, but not limited to, drawing and deep drawing.

Although the sidewall component 220b may not include any flat sections, the housing 200b, when assembled, may nevertheless provide flat sections along the top and sides of the housing 200b to support one or more circular knockouts and/or Romex knockouts to support both new construction and remodel installations. For example, FIG. 17 shows one or more notches 226 may be formed along the top end 224 of the sidewall component 220b to provide space to accommodate corresponding knockout tabs 263b of the top component 260b. Specifically, the sidewall component 220b may include opposing side edges 228 joined to the top end 224 and a curved bottom edge 229 joining the side edges 228 where the side edges 228 and the bottom edge 229 define the notch 226. The top component 260b may include a base section 261 to abut and cover the top end 224 and the knockout tab 263b may extend from the base section 261 at an angle (e.g., a right angle, an angle that results in knockout tab 263b tapering outwards away from the centerline axis 209 or inwards towards the centerline axis 209 of the housing 200b) to cover the notch 226. As shown, the knockout tab 263b may include opposing side edges 264 that align and abut the side edges 228.

Although the knockout tabs 263b are disposed along the sides of the housing 200c, for the purposes of defining the sidewall 212 and the base end 214, the sidewall components 220b may be viewed as defining the sidewall 212 of the housing 200c and the top component 260b may be viewed as defining the base end 214 of the housing 200c.

In some implementations, the notches 226 may be formed when the sidewall component 220b is initially a flat piece of sheet metal before being rolled into the desired round shape. In some implementations, the notches 226 may be cut into the sidewall component 220b after the sidewall component 220b is formed with a round shape. For example, the sidewall component 220b may be formed as a tube, which is then cut along the top end 224 to form the notches 226. The side edges 228 and the bottom edge 229 may generally form a notch 227 with various shapes including, but not limited to, a square, a rectangle, a trapezoid, a semi-circle, a semi-ellipse, or any combinations of the foregoing. For example, the side edges 228 and the bottom edge 229 may define a notch 226 that is shaped as a rectangle or a square when viewing the front side of the housing 200c (see, for example, FIGS. 18E and 18G for the housing 200d).

The knockout tab 263b may be substantially flat or flat in shape, which results in a gap forming between the bottom of the knockout tab 263b and the bottom edge 229 of the sidewall component 220b. The knockout tab 263b may include an end portion 266 that extends from the bottom of the knockout tab 263b at an angle (e.g., a right angle, an angle that results in the end portion 266 tapering outwards away from the centerline axis 209 or inwards towards the centerline axis 209 of the housing 200b) to cover the gap. As shown in FIG. 17, the end portion 266 may have a curved edge 266-1 that aligns with the curved bottom edge 229 of the sidewall component 220b. In this manner, the base section 261, the knockout tabs 263b, and the end portions 266 of the top component 260b may enclose the top end 224 and the notches 226 of the sidewall component 220b. In some implementations, the outer edge 262 of the base section 261, the side edges 264 of the knockout tabs 263b, and the edge 266-1 of the end portion 266 may be welded to the top end 224, the side edges 228, and the bottom edge 229, respectively, to form the housing 200c. In some implementations, the top component 260b may be joined to the sidewall component 220b to form an airtight cavity.

The base section 261 and the end portions 266 of the top component 260b may also be substantially flat or flat in shape. In some implementations, the base section 261 may be oriented substantially horizontal or horizontal to abut the top end 224 of the sidewall component 220b. The knockout tabs 263b may be oriented substantially vertical or vertical. The end portions 266 may be oriented substantially horizontal or horizontal. In some implementations, the top component 260b may initially be formed from a flat piece of sheet metal with the knockout tabs 263b and the end portions 266 aligned coplanar with the base section 261. The knockout tabs 263b and the end portions 266 may subsequently be bent into the desired orientation.

The base section 261 and the knockout tabs 263b of the top component 260b may support various knockouts to provide entry into the cavity of the housing 200b for various wiring connections. For example, FIG. 17 shows the knockout tab 263b may include a circular knockout 270a and a pair of Romex knockouts 270d. Although FIG. 17 shows the base section 261 without any knockouts, it should be appreciated that one or more circular or Romex knockouts may be disposed on the base section 261 similar to the housing 200b.

It should be appreciated that, in some implementations, certain design aspects of the housing 200c may be incorporated into the housing 200b. For example, the housing may include two (or more) sidewall components similar to the housing 200b where each sidewall component does not include any flat sections similar to the housing 200c, thus simplifying the manufacture of the respective sidewall components. Each sidewall component may be fabricated using, for example, a rolling process. The sidewall components may be joined together via welding and/or one or more rivet connections.

### A Round-Shaped Housing for a Remodel Installation

In some implementations, the housings and housing assemblies disclosed herein may be tailored to support a remodel installation of a lighting system. In a typical remodel installation, a built environment is modified to facilitate installation of the lighting assembly. For example, the environment may include a previously installed drywall panel on the ceiling. To install the lighting system, the housing assembly is inserted through an opening on the drywall panel, which may have been formed for a previous installation or may be newly formed for the new installation. The housing assembly may then be secured directly to the drywall panel. In this manner, the housing assembly may be installed without removing the drywall panel and/or accessing the ceiling space above the drywall panel. Once the housing assembly is installed, a lighting module and a trim may then be inserted into the housing.

FIGS. 18A-18J show several views of an exemplary implementation of a housing assembly 101c tailored for remodel installations. As shown, the housing assembly 101c may include a housing 200d defining a cavity 210 to contain and support a lighting module, at least a portion of a trim, and various electrical wire and wiring connections with an external power supply system. The housing assembly 101c may further include a spring clip assembly 500a mounted to the housing 200d to provide an attachment mechanism to couple the housing 200d to a drywall panel. The spring clip assembly 500a may include a mounting ring 510a and multiple spring clips 530a that together defining a clamping mechanism to mount the housing 200d onto the bottom and top surfaces of the drywall panel as discussed in more detail below.

The housing 200d may be assembled using a single sidewall component 220c that defines the sidewall 212 and a top component 260c that defines the base end 214 similar to the housing 200c. In this implementation, the sidewall component 260c may provide additional mounting features (e.g., openings) to support the spring clip assembly 500a without appreciably increasing the complexity of the component or cost of manufacture. For example, the sidewall component 260c may still be readily formed via a rolling process. The top component 260c may once again provide multiple knockouts and a ground connection to support various wiring connections in the lighting system. Although the housing 200d is assembled using a single sidewall component 220c, it should be appreciated that, in some implementations, multiple sidewall components may be assembled to form the sidewall 212 similar to the housing 200b.

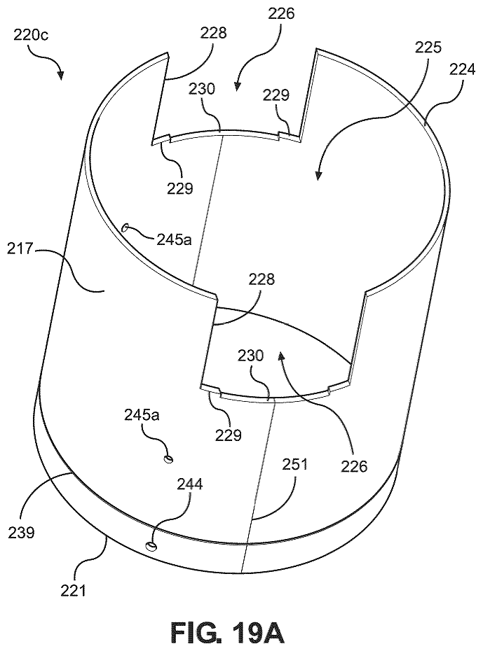

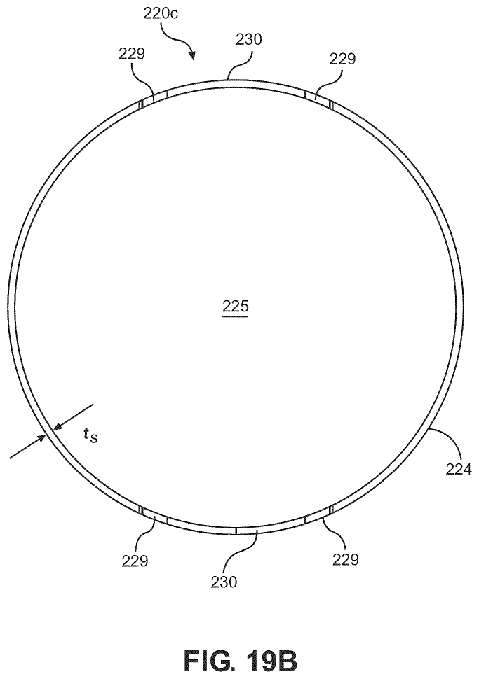

FIGS. 19A and 19B show several additional views of the sidewall component 220c. As shown, the sidewall component 220c may have a curved portion 217 that surrounds the cavity 210. The sidewall component 220c may also have a bottom end 221 that defines an opening 222 into the cavity 210 and a top end 224 that defines, in part, a top opening 225 into the cavity 210. In some implementations, the round shape of the sidewall component 220c may be formed by rolling a flat piece of sheet metal. The opposing sides of the sheet metal may be joined together to form a seam 251 that is welded. In some implementations, the sidewall component 220c may have a circular cross-sectional shape that extends from the bottom end 221 to the top end 224. Said in another way, the sidewall component 220c may be shaped as a tube as shown in FIG. 19B. In some implementations, the sidewall component 220c may have a uniform thickness (tₛ). The thickness tₛ may range between about 0.6 mm to about 2.0 mm when the sidewall and top components are formed from galvanized steel. The term “about,” when used to describe the thickness of the sidewall component 220c, is intended to cover manufacturing tolerances. For example, “about 0.6 mm” may correspond to the following dimensional ranges: 0.594 to 0.606 mm (+/−1% tolerance), 0.5952 to 0.6048 mm (+/−0.8% tolerance), 0.5964 to 0.6036 mm (+/−0.6% tolerance), 0.5976 to 0.6024 mm (+/−0.4% tolerance), 0.5988 to 0.6012 mm (+/−0.2% tolerance).

The sidewall component 220c may further include a pair of notches 226 formed along the top end 224 and on the curved portion 217 to provide space to accommodate the tabs 263c on the top component 260c. Specifically, each notch 226 may once again be defined by opposing side edges 228 joined to the top end 224 and a bottom edge 229 joining the opposing side edges 228. In this implementation, however, the bottom edge 229 may further include a recessed edge 230 that forms a secondary notch. The secondary notch may provide space for the end portion 266 on the tabs 263c on the top component 260c to reside. As shown in FIG. 19A, the pair of notches 226 may be disposed diametrically opposite with respect to one another corresponding to the arrangement of the tabs 263c on the top component 260c. More generally, the notches 226 and the tabs 263c may be offset at any angle relative to one another about the centerline axis 209.

The sidewall component 220c may further include multiple fastener openings 244 disposed around its periphery and near the bottom end 221 that align with corresponding fastener openings 516 on a collar 512 of the mounting ring 510a. In some implementations, the fastener openings 244 and 516 may also align with a fastener opening 540 on each spring clip 530a. Thus, the number and location of the fastener openings 244 and 516 may depend on the number and placement of the spring clips 530a in the housing assembly 101c. For example, the housing assembly 101c may include three spring clips 530a disposed uniformly around the sidewall 212 of the housing 200d (i.e., the spring clips 530a are rotationally offset by 120 degrees about the centerline axis 209 of the housing 200d). The housing assembly 101c may include fasteners 520 inserted through the respective openings 244, 516, and 540 to couple the spring clip 530a and the mounting ring 510a to the housing 200d. In some implementations, the fasteners 520 may be rivet fasteners.

The sidewall component 220c may also include fastener openings 245a disposed above the openings 244 to support an actuation mechanism for each spring clip 530a. Thus, the number and placement of the fastener openings 245a may correspond with the fastener openings 244. The opening 245a may be shaped to receive a threaded shank 552 of a thumbscrew fastener 550a used to actuate the spring clip 530a. For example, the opening 245a may be threaded and/or dimensioned to retain the thumbscrew fastener 550a as it is rotated. Specifically, FIGS. 18G and 18H show the shank 552 of the thumbscrew fastener 550a may be inserted through an opening 541 on the spring clip 530a while the head 551 of the thumbscrew fastener 550a may remain disposed within the cavity 210 of the housing 200d. This arrangement may provide access to the thumbscrew fastener 550a from within the cavity 210 through the bottom opening 222 once the housing assembly 200d is inserted into an opening of a ceiling. In some implementations, the thumbscrew fastener 550a may be shaped and/or dimensioned such that the head 551 may be disposed proximate to the interior surface of the sidewall component 220c or, in some instances, in contact with the interior surface when the housing assembly 101c is securely coupled to the drywall panel to provide more room within the cavity 210 of the housing 200d to insert, for example, a lighting module and/or a trim.

The sidewall component 220c may also include the groove 239 disposed between the fastener openings 244 and 245a and extending around the periphery of the sidewall component 220c. In this implementation, the groove 239 may provide an alignment mark to position and align a gasket (not shown) disposed around the collar 512 of the mounting ring 510a and the spring clips 530a.

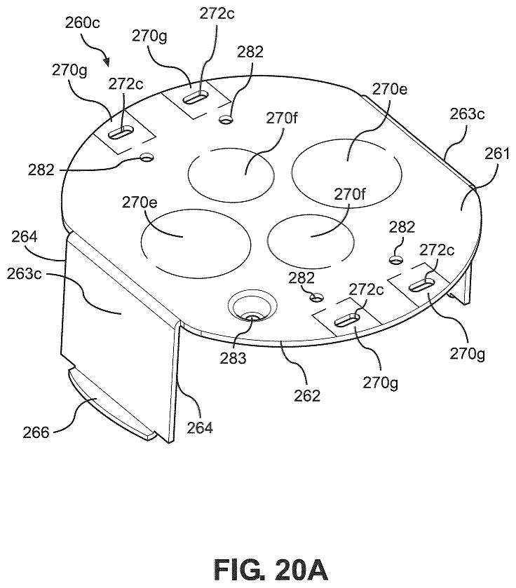

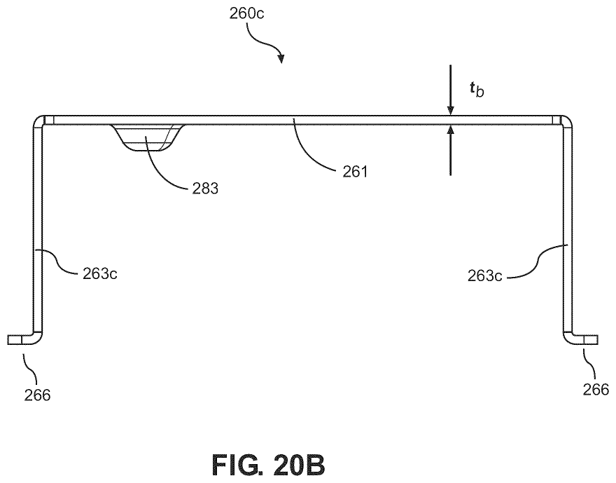

FIGS. 20A and 20B show several additional views of the top component 260c. As shown, the top component 260c may include a base section 261 that is once again substantially flat or flat in shape. The base section 261 may have an outer edge 262 shaped and/or dimensioned to be substantially flush or flush with the top end 224 of the sidewall component 220c. Thus, the base section 261 may cover and enclose the top end 224 and the top opening 225 of the sidewall component 220c. The top component 220c may further include tabs 263c that extend from the base section 261 and oriented at an angle (e.g., a right angle, an angle that results in knockout tab 263c tapering outwards away from the centerline axis 209 or inwards towards the centerline axis 209 of the housing 200d) with respect to the base section 261 to cover the notches 226 of the sidewall component 220c. Specifically, each tab 263c includes side edges 264 that aligns and abuts with the side edges 228 forming each notch 226. Each tab 263c may further include an end portion 266 to a cover a gap 254 formed between each tab 263c and the bottom edge 229 of each notch 226. As shown in FIGS. 18A, 18E, and 18F, the end portion 266 is disposed within the secondary notch formed by the recessed edge 230. Similar to the housing 200c, the outer edge 262 of the base section 261, the side edges 264 of the tabs 263c, and the edge of the end portion 266 of the top component 260c may be welded to the top end 224, the side edges 228, the bottom edge 229, and the recessed edge 230 of the sidewall component 220c.

Once again, the tabs 263c may provide flat sections along the side of the housing 200d. However, in this implementation, the tabs 263 may not include any knockouts to prevent misuse and/or an improper remodel installation of the housing (e.g., mounting the housing to a conduit cable disposed within the ceiling).

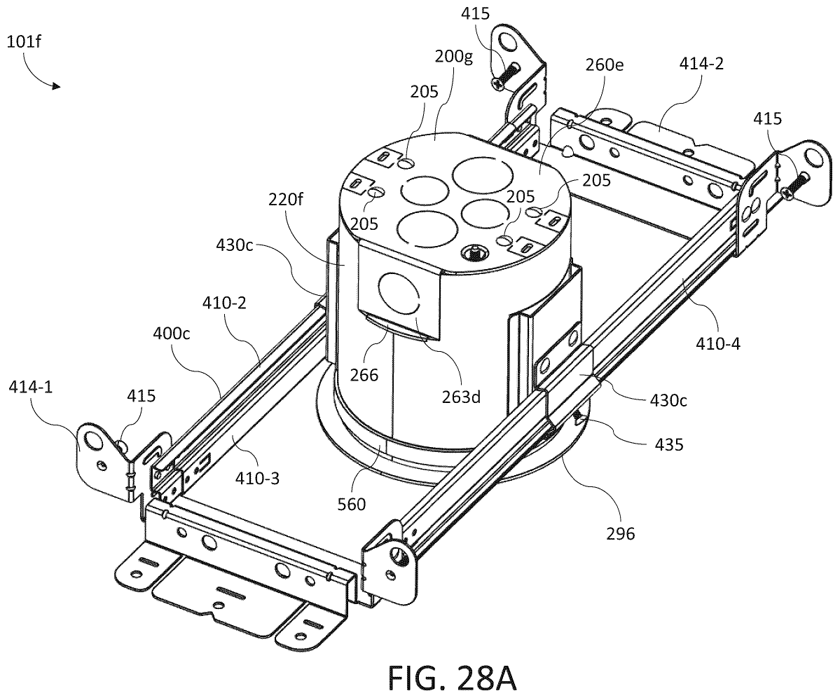

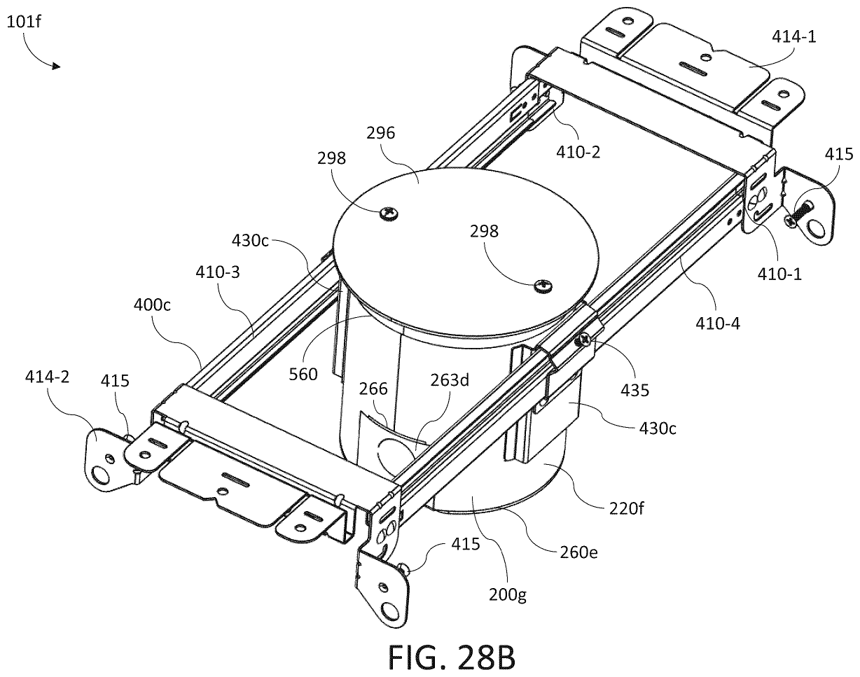

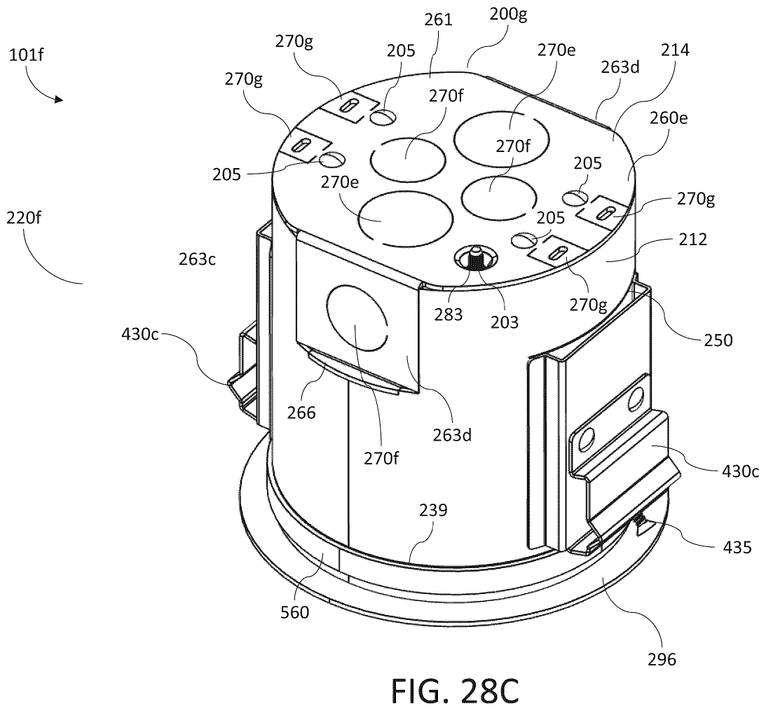

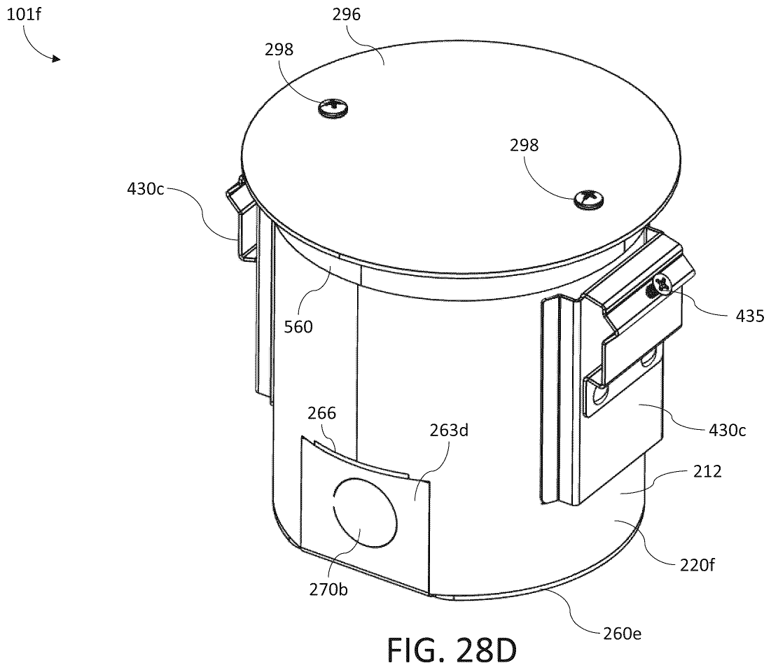

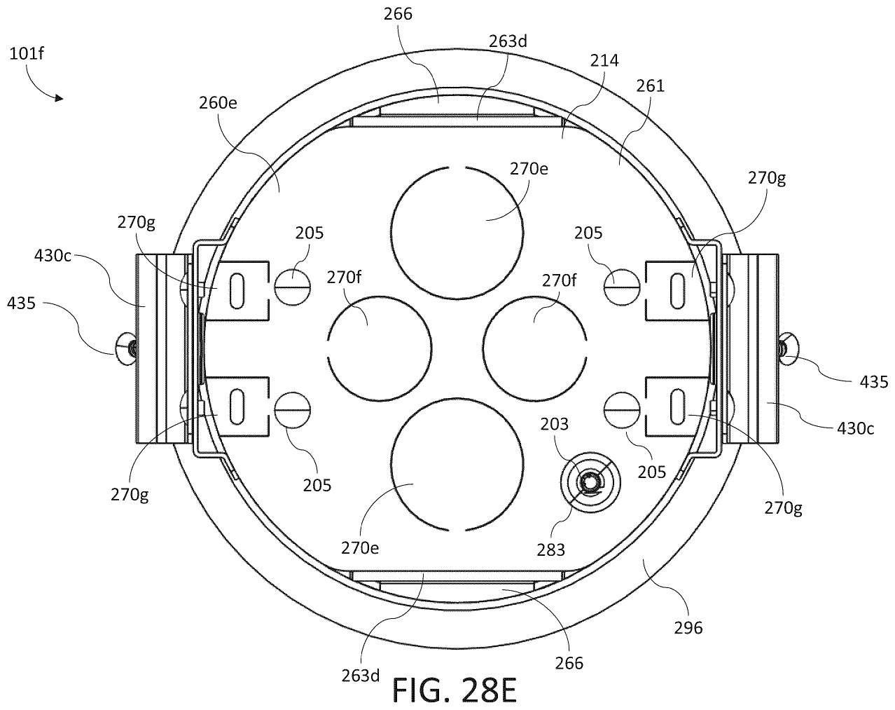

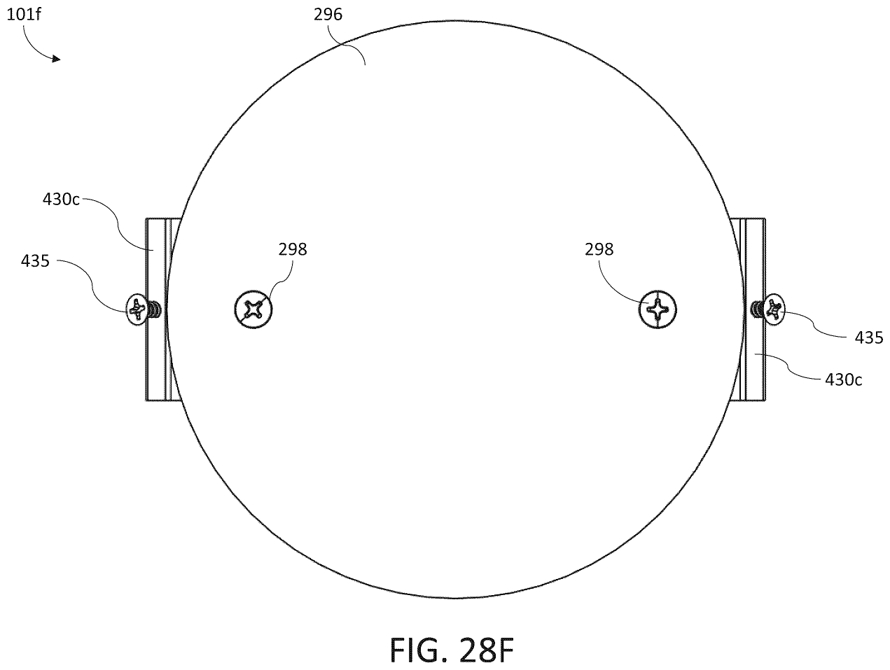

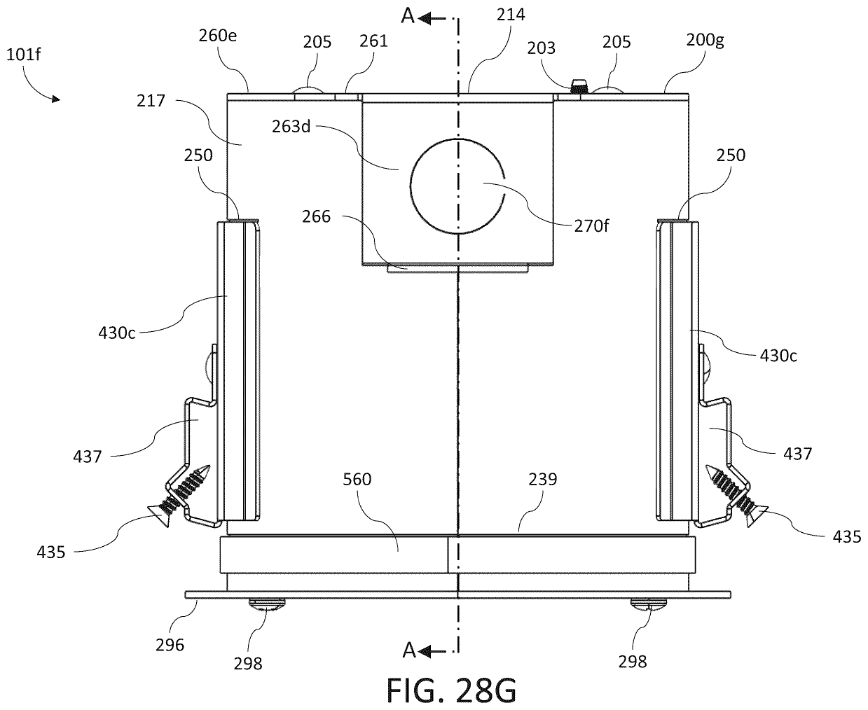

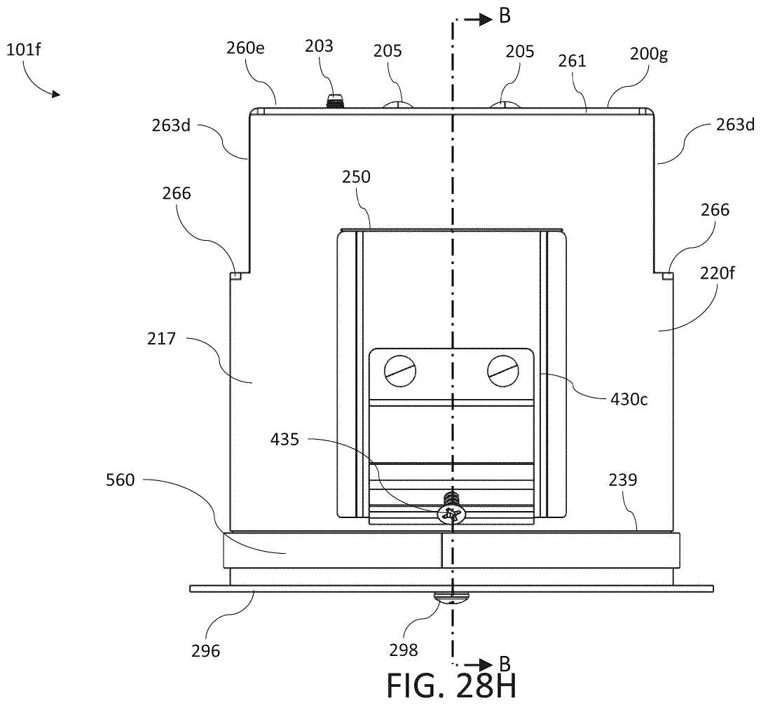

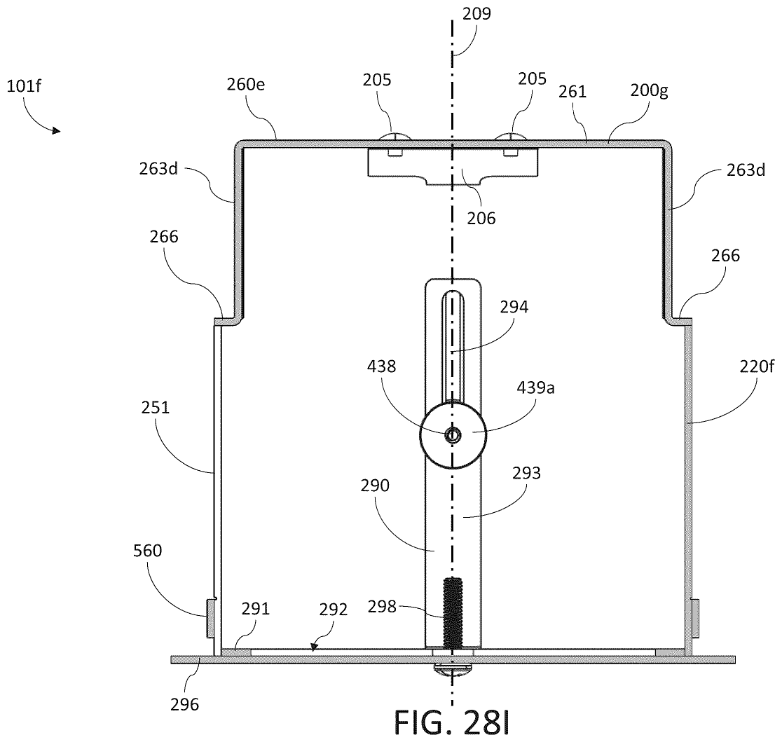

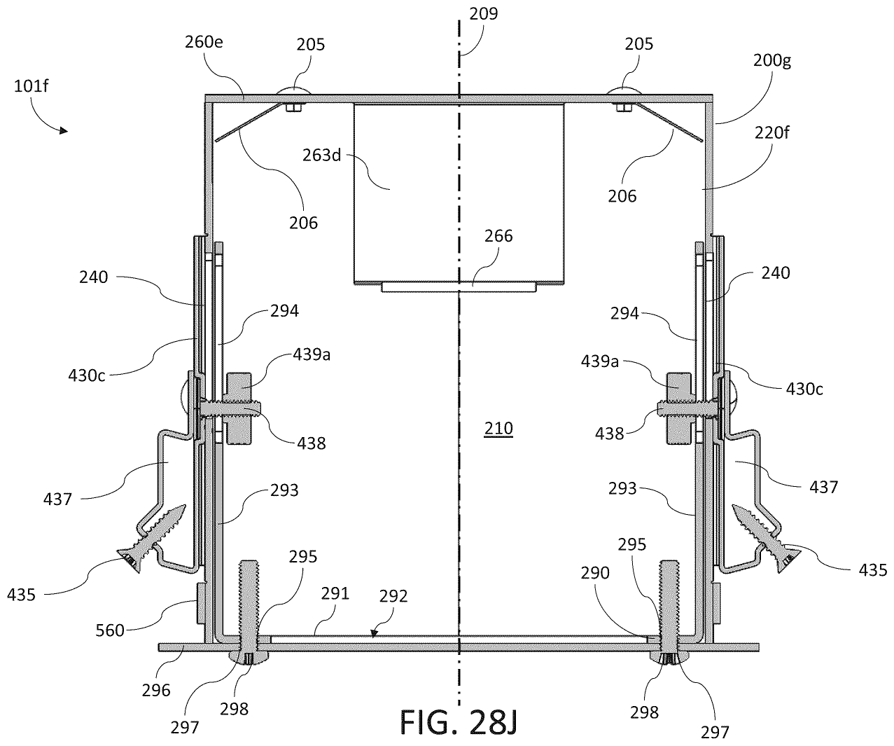

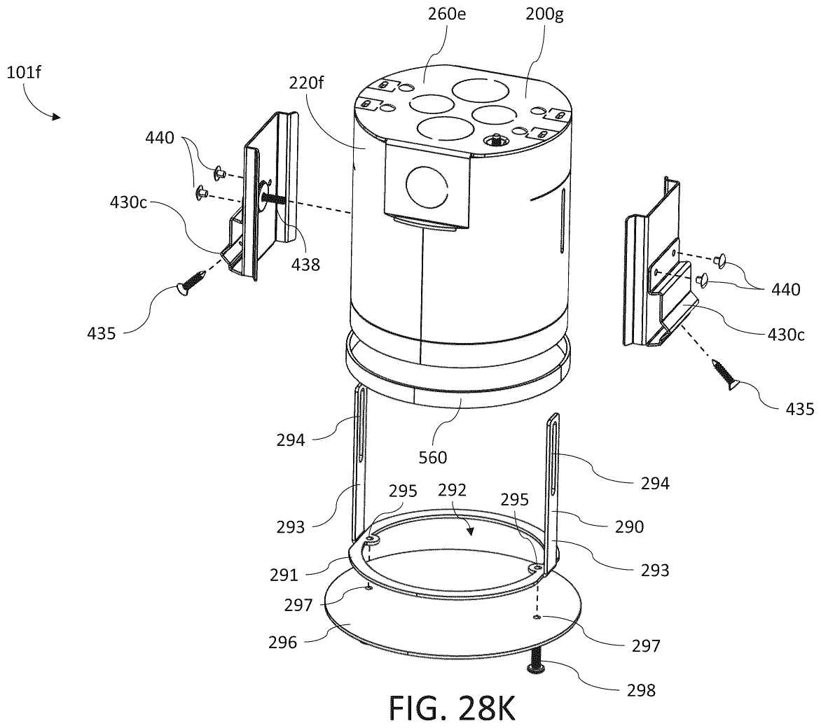

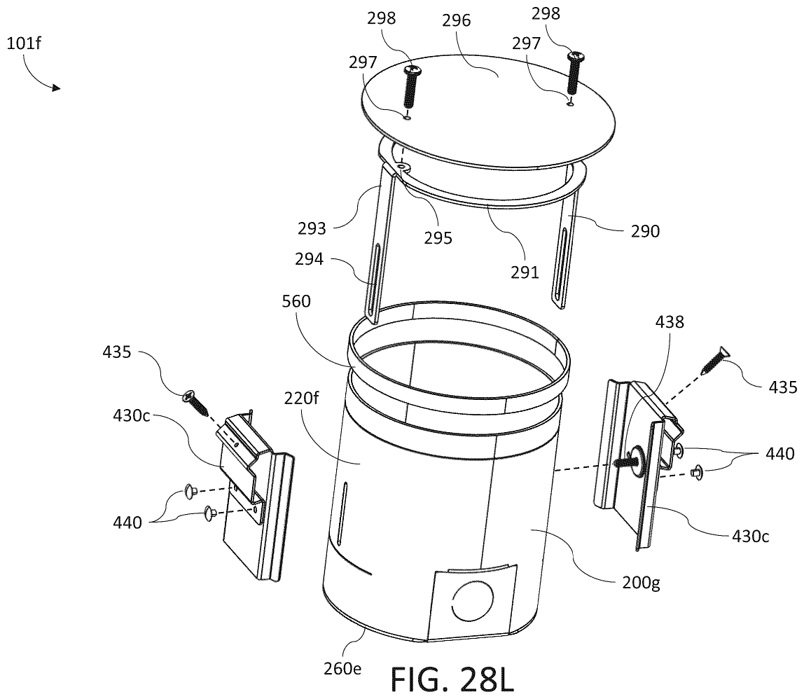

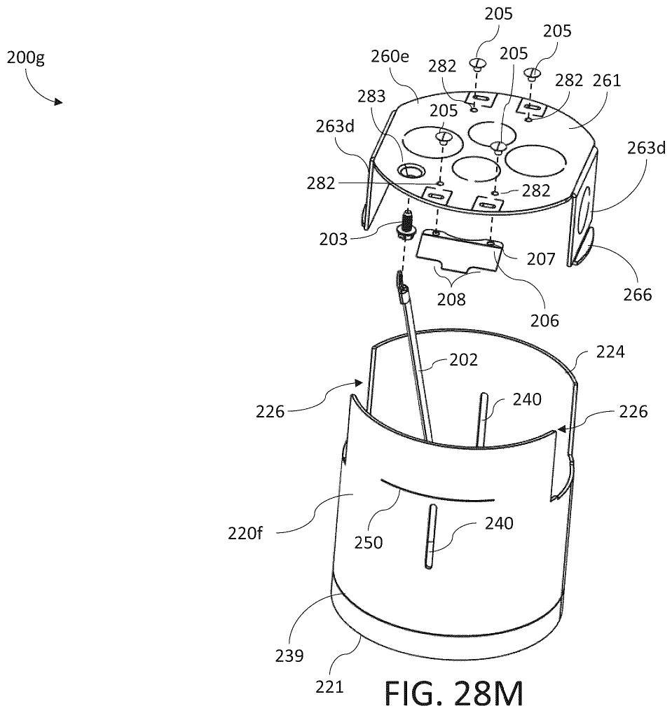

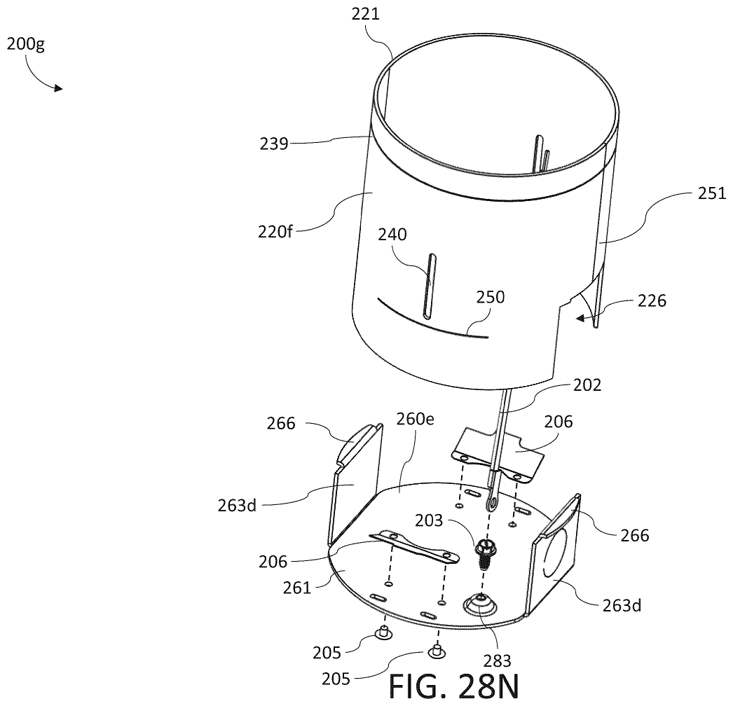

The tabs 263 and the notches 226 may be included in the housing 200d, in part, to leverage the same manufacturing processes used to manufacture housings and housing assemblies tailored for new construction installations (see, for example, the housing 200g in FIGS. 28A-28N). For example, the omission of knockouts on the tabs 263c may make the top component 220c suitable for remodel installations. For a new construction installation, the top component 220c may be modified by adding a knockout on each tab 263c. In this manner, the manufacture of a top component suitable for new construction installations may leverage the same processing steps as the top component 260c with the addition of one processing step to form the knockouts on the tabs 263c. The manufacture of the sidewall component 220c, which is suitable for a remodel installation, and a sidewall component suitable for a new construction installation may also utilize the same or similar processing steps with some minor modifications related to the formation of different mounting features for the respective installations.

The base section 261 may include one or more knockouts 270e and 270f. The knockouts 270e and 270f may be half-shear knockouts and/or flush knockouts of varying size. For example, the knockouts 270e, when removed, may form an opening with a diameter of about 1.1 inches. The knockouts 270f, when removed, may form an opening with a diameter of about 0.85 inches. More generally, the knockouts 270e and 270f, when removed, may provide an opening with a diameter that ranges between about 0.5 inches to about 1.25 inches. The base section 261 may also include multiple Romex knockouts 270g with slots 272c formed along the periphery and adjoining portions of the outer edge 262. The Romex knockouts 270g may be arranged in pairs disposed on opposing sides of the bases section 261. Similar to the Romex knockouts 270d, a tool, such as a flathead screwdriver, may be inserted into the slot 272c to facilitate removal of the Romex knockout 270g. The opening formed by the removal of the Romex knockout 270g may have a width or depth that ranges between about 0.25 inches to about 0.75 inches.

The base section 261 may also include a ground connection feature 283 with an opening to receive a fastener 203 to couple a ground cable 202 to the base section 261. As shown in FIG. 20B, the ground connection feature 283 may be formed as a recessed structure that extends into the cavity 210 to accommodate at least a portion of the fastener 203 so that the fastener 203 does not protrude appreciably above the base end 214 of the housing 200d. Generally, at least a portion of the ground connection feature 283 around the opening (e.g., the threads) may have exposed metal to electrically ground the ground cable 202 to the housing 200d.

In some implementations, the housing 200d may further include a retainer 206 coupled to the base section 261 and disposed within the cavity 210 for each pair of Romex knockouts 270g. The retainer 206 may be used to clamp electrical wires and/or cables against the sidewall 212 of the housing 200d when inserted through openings formed by the removal of the Romex knockouts 270g. For example, the retainer 206 may be deflected when wires and/or cables are inserted into the housing 200d, which results in the retainer 206 generating an internal restoring force that pushes the wires and/or cables against the sidewall component 220c. In some implementations, the retainer 206 may also function as a strain relief features by limiting or, in some instances, preventing the electrical wire or cable from moving in or out of the cavity 210 once inserted. The retainer 206 may generally be formed of the same material as the housing 200d, such as sheet metal.

As shown in FIGS. 18I and 18J, each retainer 206 may include fastener openings 207 that align with fastener openings 282 on the base section 261 of the top component 260c. Fasteners 205 may be inserted through the openings 282 and 207 to couple the retainer 207 to the top component 260c. The retainer 206 may further include notches 208 to provide a narrow opening for electrical wires or cables to pass between the retainer 206 and the sidewall component 220c. In some implementations, the retainer 206 may be oriented at an angle relative to the interior surface of the sidewall component 220c so that the wires and/or cables may be readily fed into the cavity 210 of the housing 200d while reducing or, in some instances, preventing the wires from slipping out of the housing 200d. For example, FIG. 18G shows the retainer 206 may be angled downwards towards the bottom end 221 of the housing 200d. When the wires and/or cables are inserted into the cavity 210, any subsequent attempt to pull the wires and/or cables out from the housing 200d may cause the wires and/or cables to get caught on the retainer 206.

As noted above, the spring clip assembly 500a may provide a mounting mechanism to facilitate installation of the housing assembly 101c onto a drywall panel. FIGS. 18E-18H show the mounting ring 510a may be directly coupled to the housing 220c. Specifically, the collar 512 of the mounting ring 510a may define an opening 502 that is shaped and/or dimensioned to allow the sidewall component 220c to pass through the opening 502 so that the collar 512 may surround and abut an exterior portion of the sidewall component 220c located near the bottom end 221. As described above, the collar 512 may include multiple openings 516 to receive a fastener 520 to couple the mounting ring 510a to the housing 200d and the spring clips 530a to the mounting ring 510a. The mounting ring 510a may further include a flange 514 joined to the collar 512. The flange 514 may extend radially from the housing 200d along a horizontal plane and may include a top surface 517 that abuts a bottom surface of the ceiling and a bottom surface 515 that is substantially flush or flush with the bottom end 221 of the housing 200d (i.e., the bottom surface 515 and the bottom end 221 lie on the same horizontal plane). It should be appreciated that, in some implementations, the bottom surface 515 may extend below the bottom end 221 of the housing 200d. The mounting ring 510a may generally be formed from metal or plastic.

FIGS. 18G and 18H show the spring clip 530a may include a base section 531 that includes the fastener opening 540 and abuts the collar 512 of the mounting ring 510a. The spring clip 530a may further include a bent section 532a (also referred to herein as a “clamping surface 532a” or a “contact section 532a”) that is shaped to physically engage a top surface of the drywall panel when the spring clip 530a is actuated by the thumbscrew fastener 550a. The spring clip 530a may further include an end section 538 joined to the bent section 532a and defining the opening 541. In some implementations, the opening 541 may be shaped as a slot for the threaded shank 552 of the thumbscrew fastener 550a to move along as the spring clip 530a is deflected outwards when actuated. The spring clip 530a may be generally formed of the same materials as the housing 200d. For example, the spring clip 530a may be formed of galvanized steel in the form of sheet metal.

The following describes an exemplary remodel installation of the housing assembly 101c for a ceiling. It should be appreciated that the same or similar steps may be used to install the housing assembly 101c in a wall or a floor.

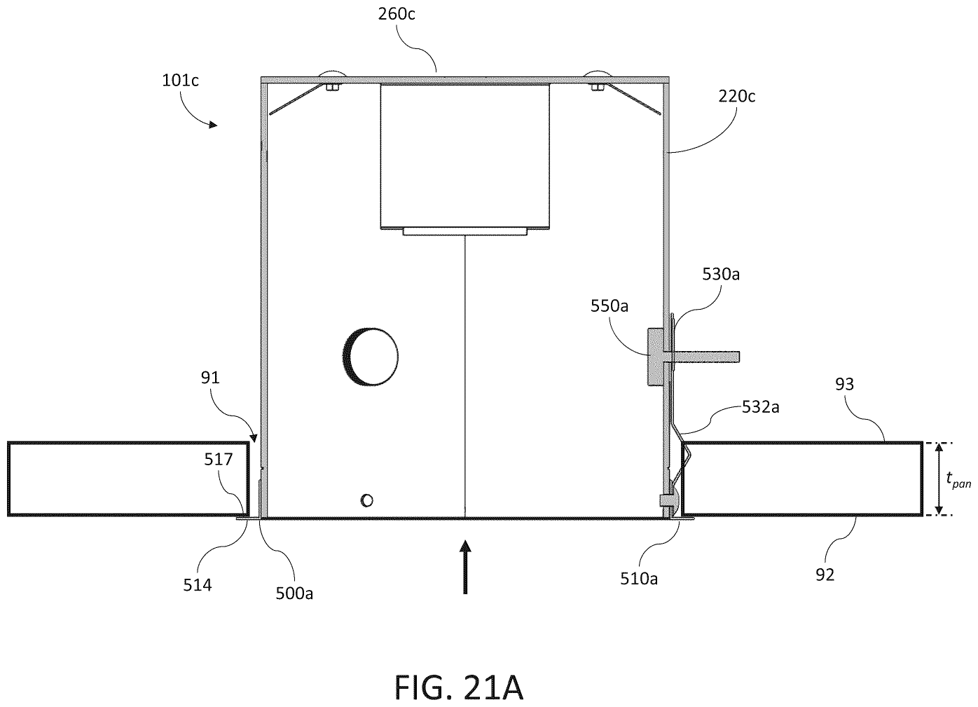

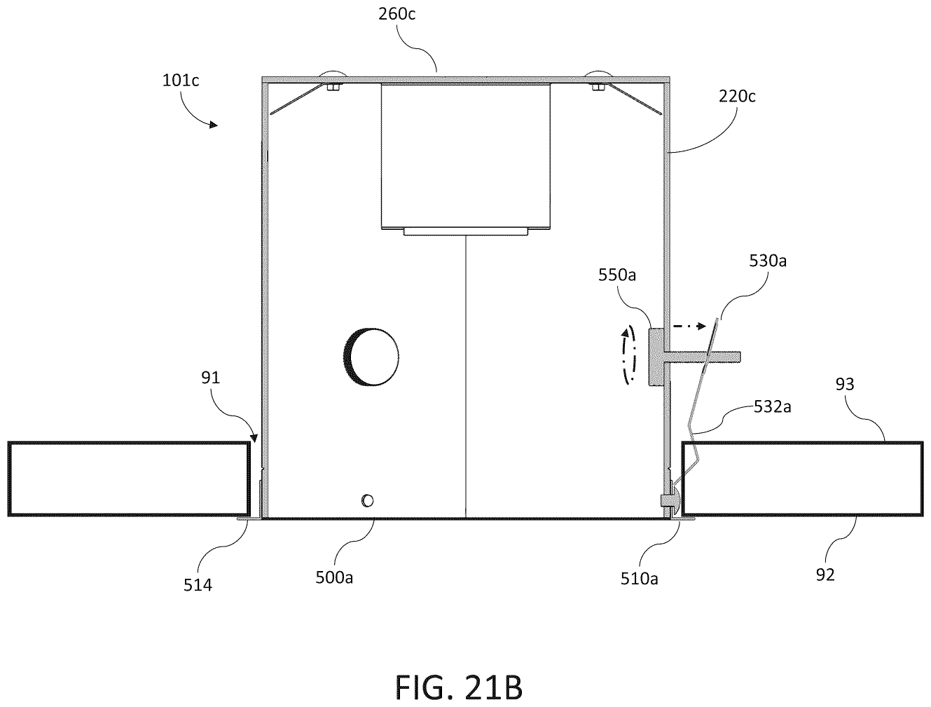

In a typical remodel installation, one or more of the knockouts 270e-270g may be removed to route electrical wires and/or cables (e.g., the cable 96 from an external power supply system) into the cavity 210 of the housing 200d. Once the external electrical wire connections are inserted into the housing 200d, FIG. 21A shows the housing 200d may then be inserted through an opening 91 formed on a ceiling drywall panel 90 until the top surface 517 of the flange 514 abuts an bottom surface 92 of the drywall panel 90. Once the housing 200d is disposed within the ceiling space, the installer may then actuate each spring clip 530a may reaching into the cavity 210 and rotating the head 551 of each thumbscrew fastener 550a. As the thumbscrew fastener 550a is rotated, the threaded shank 552 may cause the end section 538 and the bent section 532a to deflect outwards and physically contact and engage a top surface 93 of the drywall panel 90 as shown in FIG. 21B. The opening 541 may be shaped to retain the threaded shank 552 of the thumbscrew fastener 550a so that the spring clip 530a remains engaged to the drywall panel 90. In this manner, the spring clips 530a and the flange 514 of the mounting ring 510a may clamp onto opposing sides of the drywall panel 90, thus securing the housing assembly 101c to the drywall 90.

As noted above, the housing assembly 101c may include three spring clips 530a disposed uniformly around the housing 200d. Each spring clip 530a may be actuated and engaged to the drywall panel 90 to provide multiple points of attachment between the housing assembly 101c and the drywall panel 90 to improve mechanical stability. To uninstall and remove the housing assembly 101c, each of the thumbscrew fasteners 550a may be rotated to return the spring clips 530a to their original, undeflected orientations.

The bent section 532a of the spring clip 530a may be shaped and/or positioned to provide a large contact area to engage the drywall panel 90 and, hence, provide a more secure mechanical connection with the drywall panel 90. The bent section 532a may have various shapes including, but not limited to, a V-shaped bend, a round-shaped bend, an arc where the spring clip 530a bends outwards to clasp the drywall panel 90. The bent section 532a may also be shaped to reduce the degree with which the spring clip 530a is displaced to securely couple the housing assembly 101c to the drywall panel 90. In some implementations, the bent section 532a may extend outwards from the sidewall 212 of the housing 200d by a distance less than the width of the flange 514 of the mounting ring 510a when the spring clip 530a is not actuated. This may ensure the opening 91 in the drywall panel 90 remains sufficiently small so that the top surface 517 of the flange 514 may abut the bottom surface 92 of the drywall panel 90.

In some implementations, the bent section 532a may also be shaped to accommodate drywall panels with different thicknesses (tₚₐₙ). For example, the spring clip 530a may be deflected outwards less to engage a thicker drywall panel or deflected outwards more to engage a thinner drywall panel. Generally, the spring clips 530a may be tailored to accommodate drywall panels with a thickness tₚₐₙ ranging between about ⅜ inches and about 1¼ inches. In some implementations, the spring clip 530a or, more generally, the spring clip assembly 500a may also be compatible with wood panels or stacks of drywall panels provided the overall thickness remains within the desired operating range.

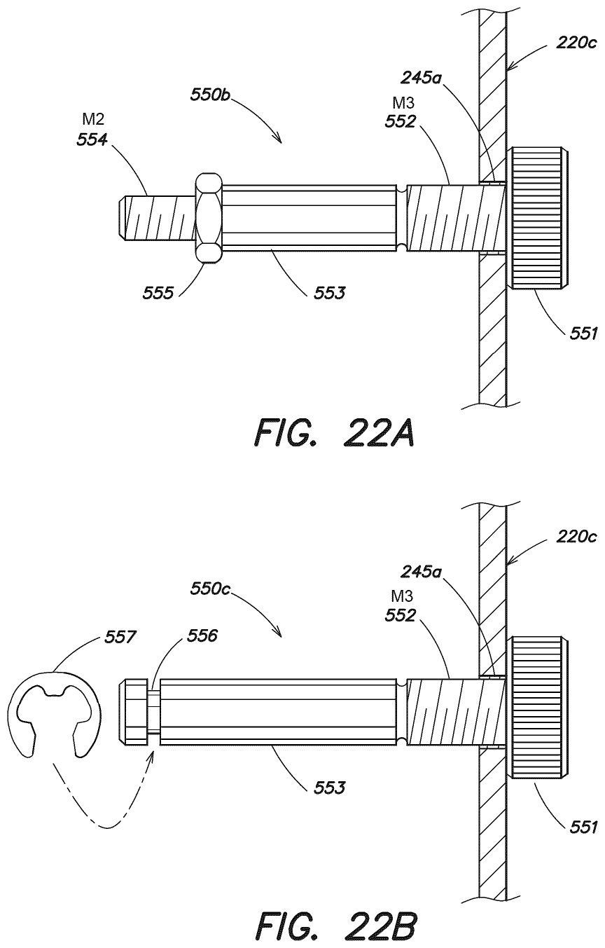

In some implementations, the thumbscrew fastener 550a used to actuate the spring clip 530a may be a captive fastener. In other words, the fastener may not be removed from the housing 200d to prevent accidental loss or removal of the fastener from the housing 200d during installation. For example, FIG. 22A shows an exemplary captive fastener 550b. As shown, the shank of the fastener 550b may include an unthreaded portion 553 and a threaded portion 552 to engage the opening 245a of the sidewall component 220c and/or the opening 541 on the spring clip 530a, which is removed in FIG. 22A for clarity.

The unthreaded portion 533 may allow the installer to initially push the fastener 550b through the opening 245a to initially displace the spring clip 530a more quickly during installation. Once the bent section 532a of the spring clip 530a is nearly engaged to the drywall panel 90, the threaded portion 552 may then engage the opening 245a to maintain the fastener 550b in the tightened position on the housing 200d and, hence, maintain the displacement of the spring clip 530a. The threaded portion 552 may remain engaged with the opening 541 on the spring clip 530a as the spring clip 530a is deflected outwards.

Additionally, the fastener 550b may include a threaded end section 554 and a nut 555 may be fastened to the end section 554 to prevent removal of the fastener 550b from the housing 200d. In some implementations, the threaded portion 552 of the shank and the threaded end section 554 may have different threads (e.g., M2 and M3 threads). FIG. 22B shows another exemplary captive fastener 550c. The fastener 550c may be similar to the fastener 550b of FIG. 22A with the difference being the fastener 550c may have a notched end section 556 to support an e-clip 557. The e-clip 557 may function in a similar manner as the nut 555 in the fastener 550b by preventing removal of the fastener 550c from the housing 200d.

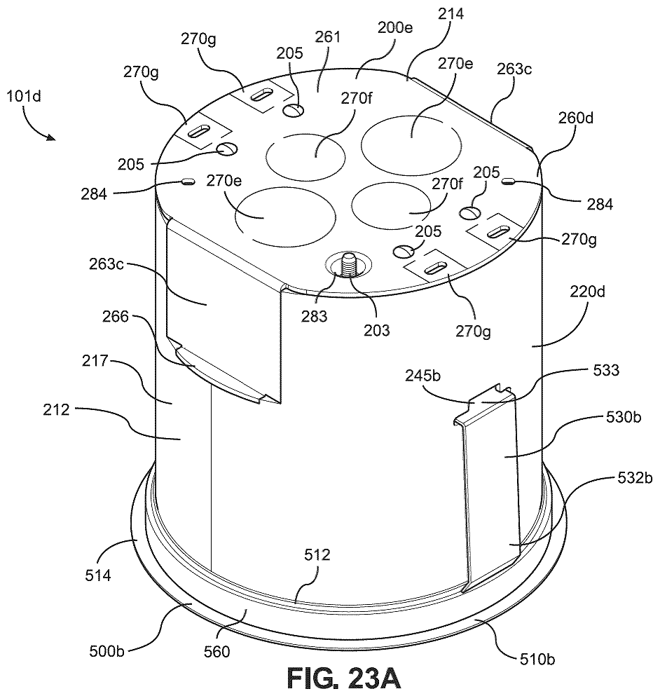

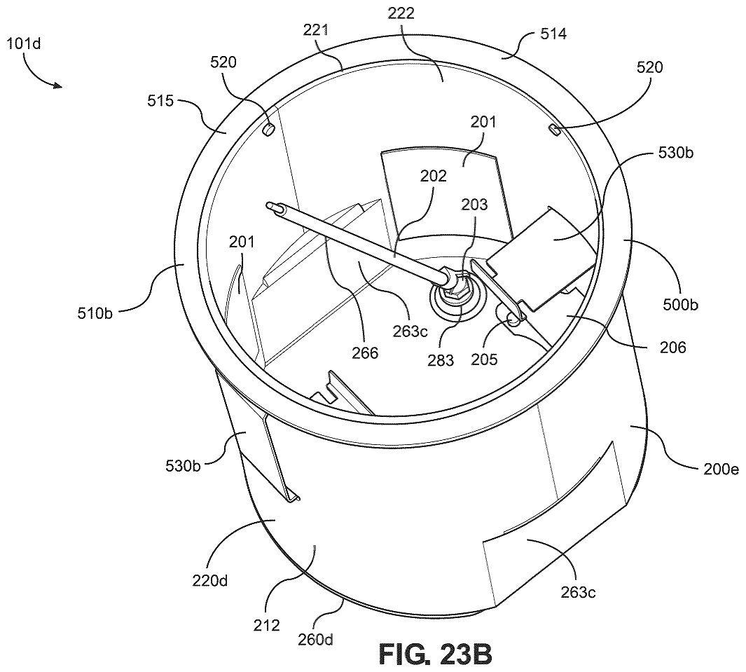

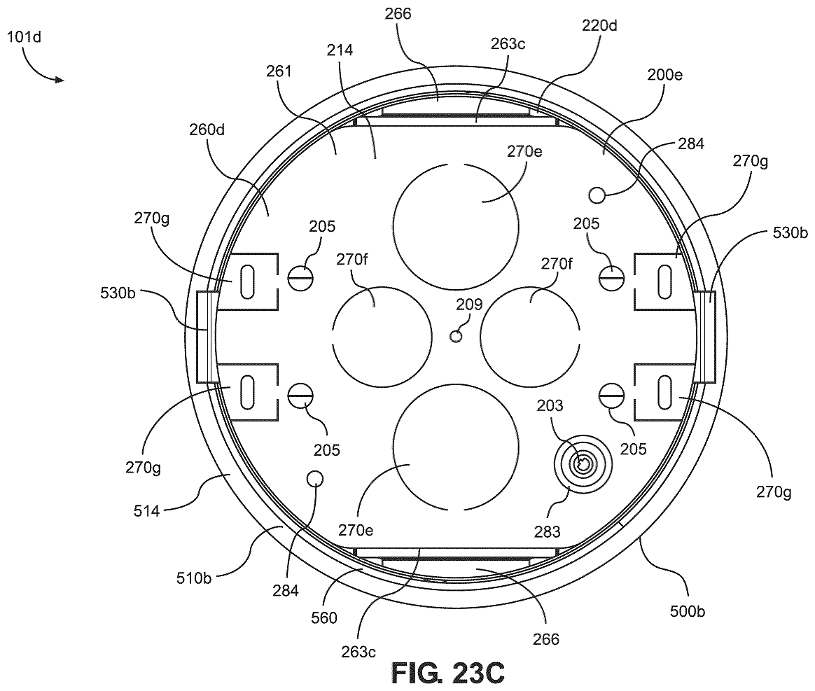

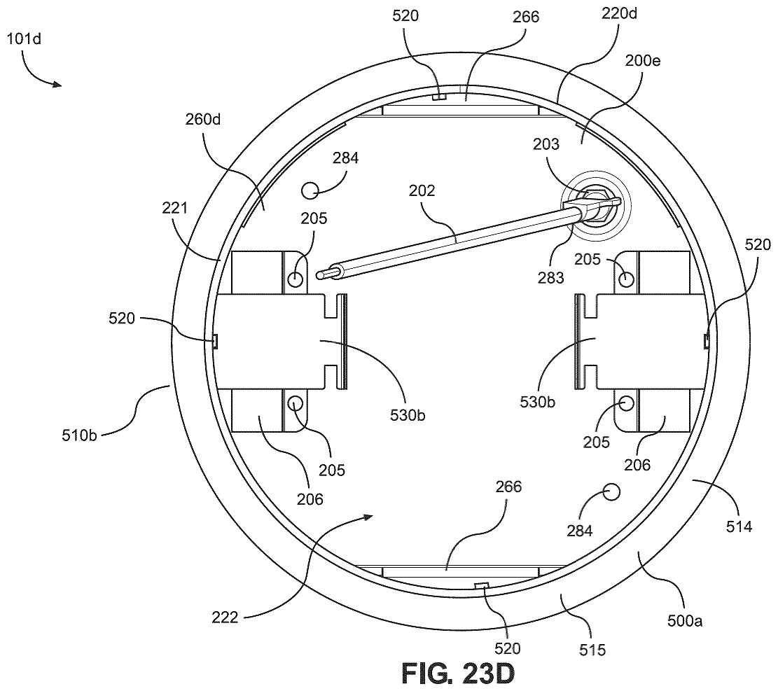

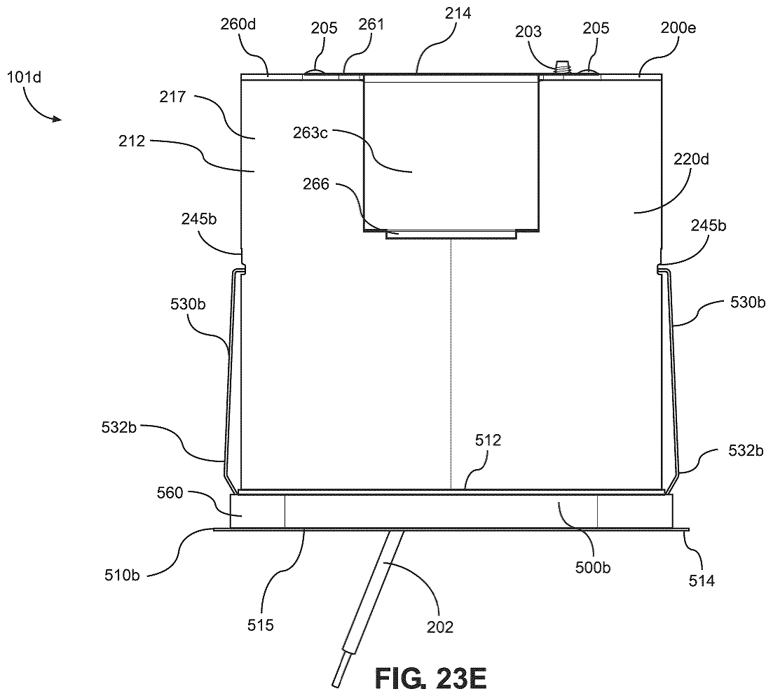

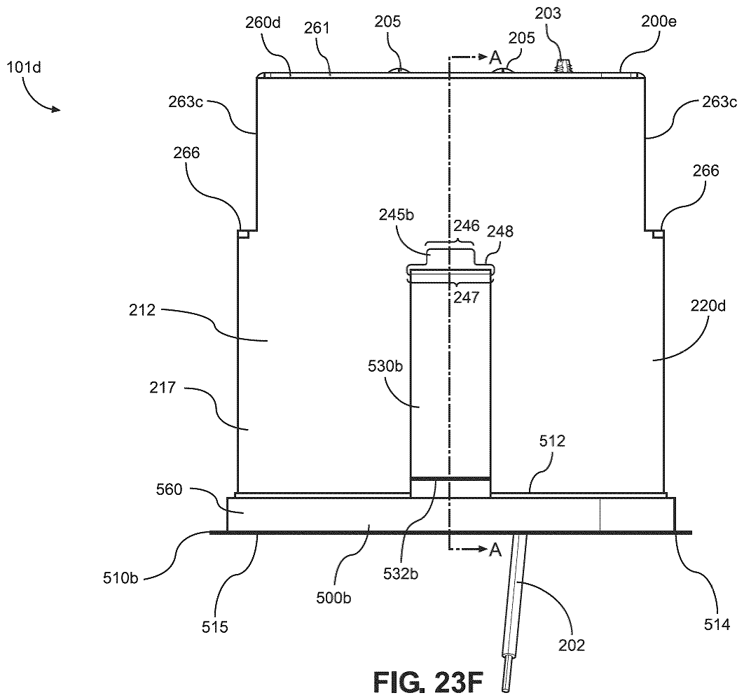

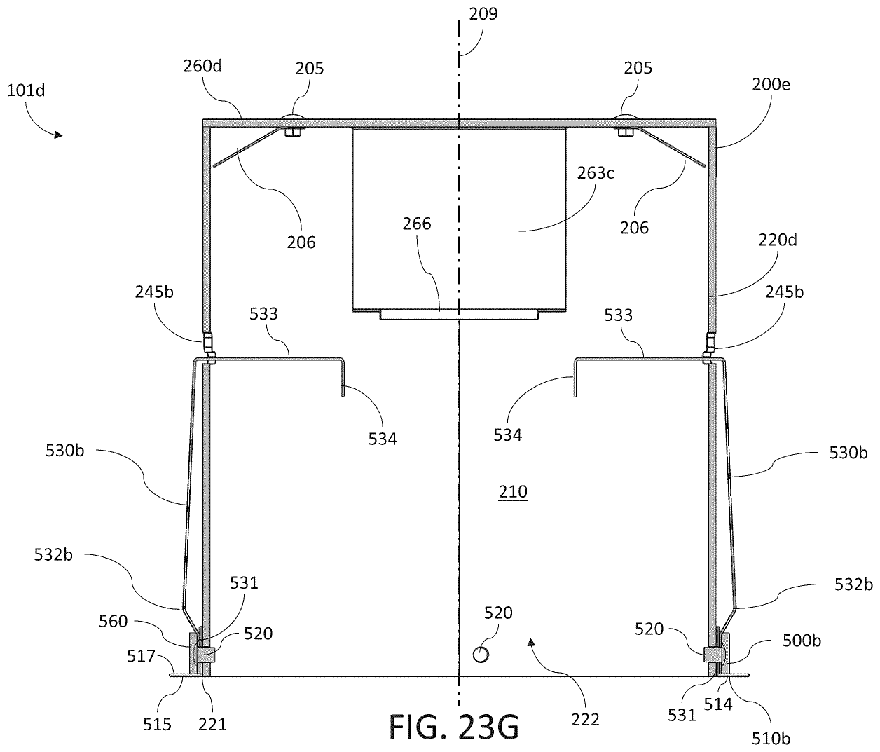

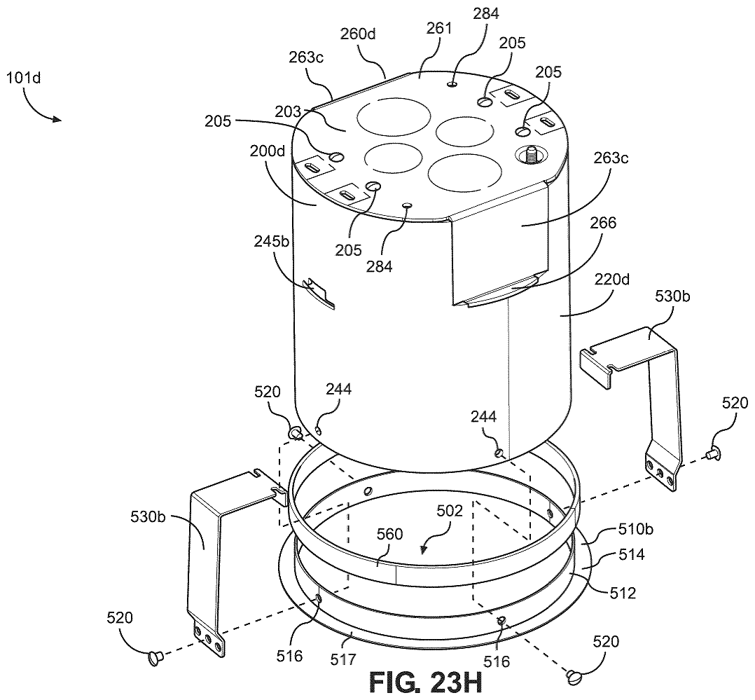

FIGS. 23A-23H show another exemplary housing assembly 101d for a remodel installation that includes a spring clip assembly 500b with a push-based actuation mechanism. As shown, the housing assembly 101d may include a housing 200e assembled using a single sidewall component 220d and a top component 260d. The spring clip assembly 500b may include a mounting ring 510b and a pair of spring clips 530b that collectively form a clamping mechanism to securely couple the housing assembly 200e to a drywall panel in the same manner as the housing assembly 101c. In some implementations, the housing assembly 101d may further include a gasket 560 supported by the mounting ring 510b to seal any gaps formed between the housing 200d and the edges of the ceiling defining the opening through which the housing assembly 101d is inserted during installation.

The sidewall component 220d may include several of the same or similar structural features as the sidewall component 220c. For example, the sidewall component 220d may have a curved portion 217 formed by rolling a flat piece of sheet metal into the desired round shape and welding a seam 251 formed by the opposing sides of the sheet metal. The curved portion 217 may thus surround and define a cavity 210. The sidewall component 220d may further include a bottom end 221 that defines a bottom opening 222 into the cavity 210 and a top end 224 that defines a top opening 225. The sidewall component 220d may further include a pair of notches 226 disposed diametrically opposite to one another, which are each defined by respective pairs of side edges 228, a bottom edge 229, and a recessed edge 230. More generally, the notches 226 and the tabs 263c may be offset at any angle relative to one another about the centerline axis 209. In some implementations, one or more labels 201 may be disposed along the interior surfaces of the sidewall component 220d as shown in FIG. 23B. As described above, the labels 201 may explicitly state the various components that may be mounted to the housing 200d to comply with the various UL and NEC standards and regulations.

The sidewall component 220d may further include multiple fastener openings 244 disposed near the bottom end 221 to align with corresponding fastener openings 516 on the mounting ring 510b to facilitate attachment of the mounting ring 510b to the housing 200e via fasteners 520. As shown in FIG. 23H, the sidewall component 220d and the mounting ring 510b may include four fastener openings 224 and 516, respectively, which are rotationally offset by 90 degrees with respect to one another about the centerline axis 209 of the housing 200e. In this implementation, the housing assembly 101d may only include a pair of spring clips 530b. In some implementations, the pair of spring clips 530b may be disposed diametrically opposite to one another. Thus, one pair of fastener openings 244 and 516 disposed on opposing sides may also align with respective fastener openings 240 on each spring clip 530b and the corresponding fasteners 520 may couple the spring clips 530b to the mounting ring 510b.

As shown in FIG. 23F, the sidewall component 220d may include a pair of T-shaped openings 245b to receive portions of the spring clips 530b. Specifically, each T-shaped opening 245b may include wide portion 247 and a narrow portion 246 disposed directly above and adjoining the wide portion 247. The narrow and wide portions 246 and 247 may be centered about a vertical plane intersecting the centerline axis 209 of the housing 200e. The wide portion 247 may be shaped and/or dimensioned to receive a wide section 535 of a push flange 533 on the spring clip 530b while the narrow portion 246 may be shaped and/or dimensioned to receive a narrow section 536 of the push flange 533. During installation, the spring clip 530b may be deflected outwards by pushing the wide section 535 through the wide portion 247 of the opening 245b. The narrow section 533 may engage the narrow portion 246 of the opening 245b to lock the spring clip 530b in place once engaged with the drywall panel as will be discussed in more detail below.

The top component 260d may also include several of the same or similar structural features as the top component 260c. For example, the top component 260d may include a base section 261 to cover the top end 224 and the top opening 225 of the sidewall component 220d. The top component 260d may further include tabs 263c that extend from the base section 261 and cover the respective notches 226 of the sidewall component 220c. Each tab 263c may further include an end portion 266 to cover a gap 254 formed between the tab 263c and the curved sidewall component 220c. The base section 261 may further include the circular knockouts 270e and 270f as well as the Romex knockouts 270g. The top component 260d may further support a pair of retainers 206 coupled to the base section 261 via fasteners 205. The base section 261 may also include a ground connection feature 283 to connect a ground cable 202 to the top component 260d via a fastener 203. In this implementation, the top component 260d may further include additional openings 284 disposed on the base section 261.

FIG. 23H shows the mounting ring 510b may also include several of the same or similar features as the mounting ring 510a. For example, the mounting ring 510b may include a collar 512 defining an opening 502 for the bottom portion of the housing 200d to pass through. The collar 512 may abut the exterior side of the sidewall component 220d. As described above, the collar 512 may include four fastener openings 516 that align with the fastener openings 244 on the sidewall component 220d. The mounting ring 510b may further include a flange 517 with a top surface 517 that abuts an bottom surface of a ceiling and a bottom surface 515 that is substantially flush or flush with the bottom end 221 of the housing 200d.

In some implementations, the housing assembly 101d may also include the gasket 560 to seal any gaps formed between the housing 200d and the edges of the ceiling defining the opening. FIG. 23G shows the gasket 560 may be disposed around the exterior side of the collar 512, the exterior portion of the mounting section 531 of each spring clip 530b, and the fasteners 520. The gasket 560 may generally wrap tightly around the various components of the spring clip assembly 500b to reduce or, in some instances, eliminate gaps between the gasket 560 and the spring clip assembly 500b. In some implementations, the gasket 560 may be an elastic component that is stretched (i.e., put in tension) when mounted to the spring clip assembly 500b. The gasket 560 may thus provide a compliant component to contact and seal the edges of the ceiling defining the opening. The gasket 560 may be formed from various types of polymers including, but not limited to, polyethylene foam, silicone rubber, and neoprene rubber.

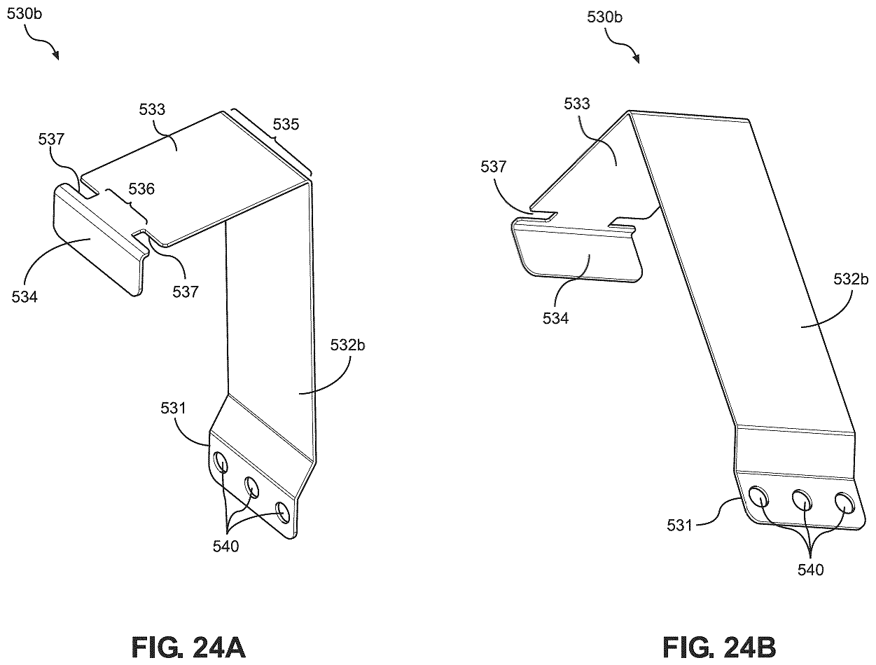

FIGS. 24A and 24B show several additional views of the spring clip 530b. As shown, the spring clip 530b may include a base section 531 that abuts the collar 512 of the mounting ring 510b. In some implementations, the base section 531 may include multiple fastener openings 540. During assembly, one of the fastener openings 540 may be used to couple the spring clip 530b to the mounting ring 510b. The spring clip 530b may further include a bent section 532b joined to the base section 531. The bent section 532b may protrude outwards to engage a top surface of a drywall panel for installation. As shown, the bent section 532b may extend up to the push flange 533, which is disposed within the opening 245b of the sidewall component 220d as described above. The bent section 532b may be tapered in shape such that the bent section 532b includes flat sections that are not oriented vertically. This geometry may provide more leverage to deflect the bent section 532b about the portion of the spring clip 530b where the base section 531 joins the bent section 532b. More generally, the bent section 532b may have various shapes including, but not limited to, a V-shaped bend, a round-shaped bend, an arc where the spring clip 530a bends outwards to clasp the drywall panel. The push flange 533 may pass through the opening 245b as described above. In some implementations, the push flange 533 may be oriented horizontally. In some implementations, the push flange 533 may not be oriented at an angle relative to a horizontal plane. The spring clip 530b further include a handle 534 joined to the push flange 533 to provide a surface the installer may press on to push the push flange 533 through the opening 245b and deflect the bent section 532b outwards. The push flange 533 may include a wide section 535 and a narrow section 536 disposed near the handle 524. The narrow section 536 may be formed by a pair of notches 537 disposed on opposing sides of the push flange 533 as shown in FIG. 24A. The spring clip 530b may be generally formed of the same materials as the housing 200e. For example, the spring clip 530b may be formed of galvanized steel in the form of sheet metal.

The following describes an exemplary remodel installation of the housing assembly 101d for the ceiling 90. It should be appreciated that the same or similar steps may be used to install the housing assembly 101d in a wall or a floor.

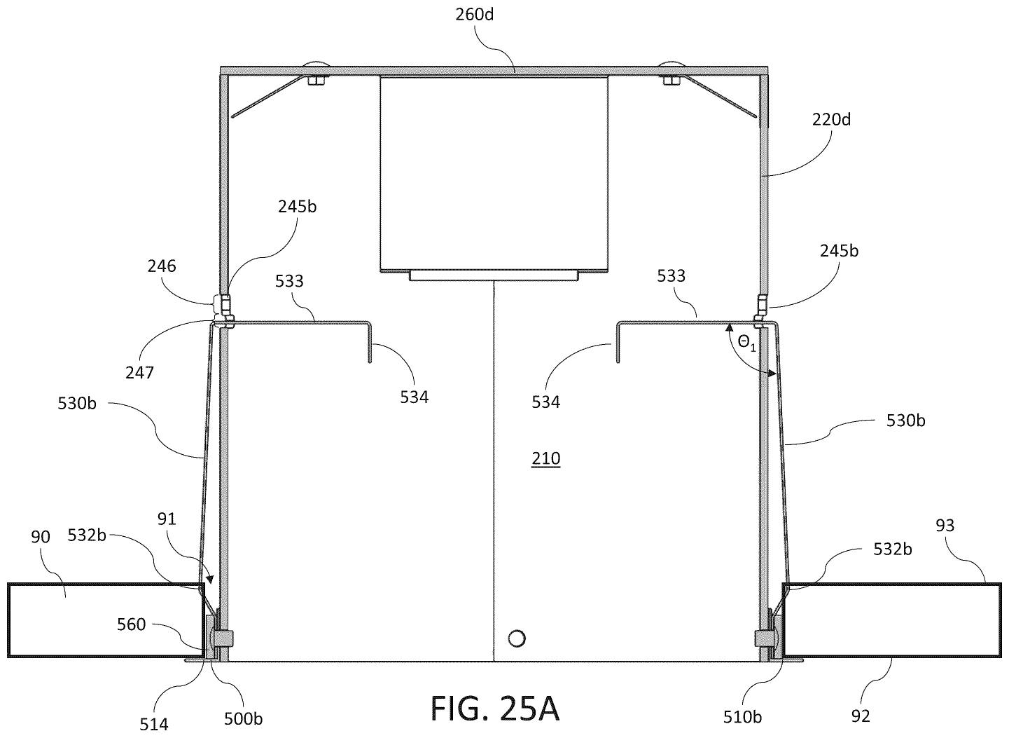

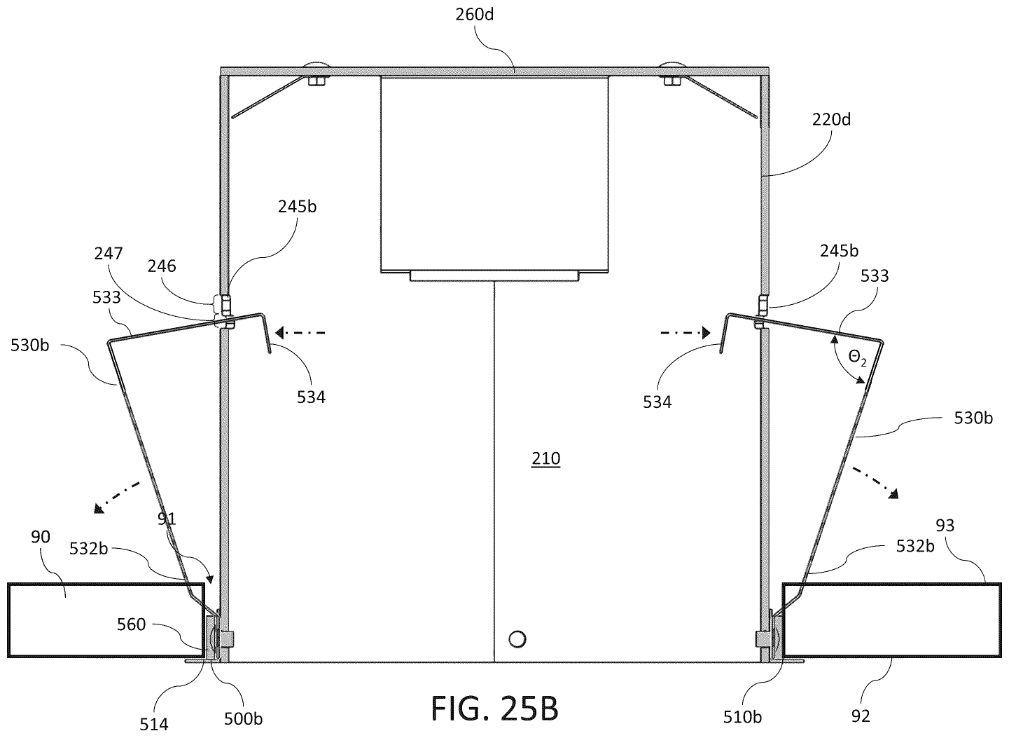

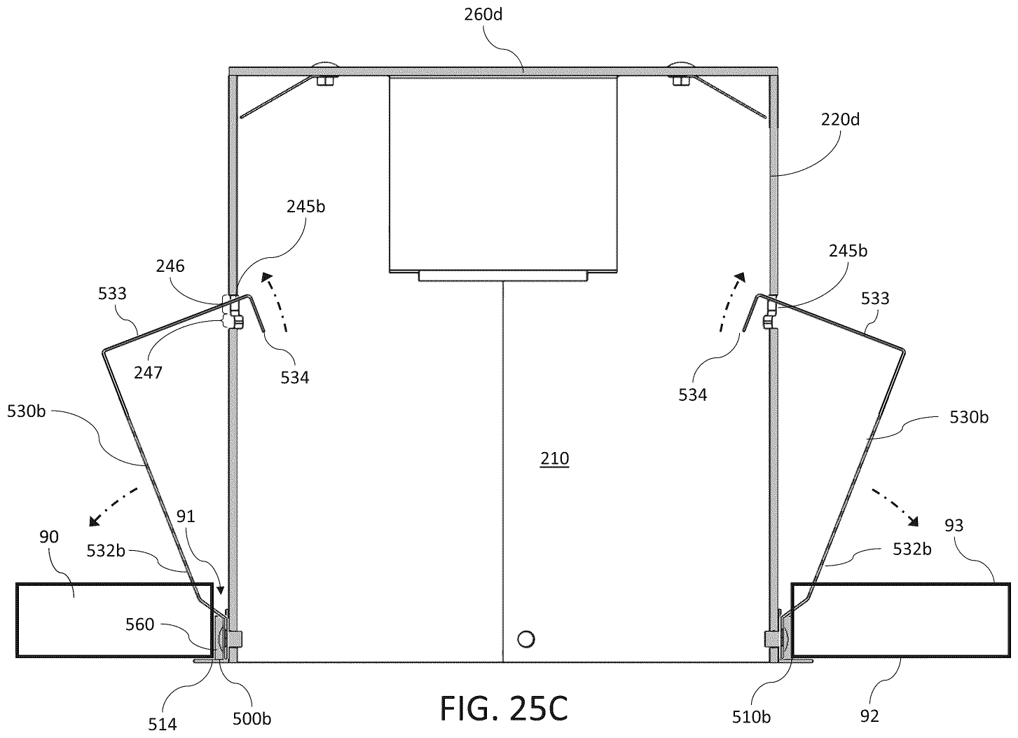

Similar to the housing assembly 101c, the installation of the housing assembly 101d may first begin with the removal of one or more of the knockouts 270e-270g to provide an opening for one or more electrical wires and/or cables to be inserted into the cavity 210 of the housing 200e. As before, once the external electrical wire connections are inserted into the housing 200e, FIG. 25A shows the housing 200e may then be inserted through the opening 91 formed on the ceiling drywall panel 90 until the top surface 517 of the flange 514 abuts the bottom surface 92 of the drywall panel 90. Once the housing assembly 200e is disposed within the ceiling space, the installer may then press the handle 534 of each spring clip 530b to deflect the bent section 532b of the spring clip 530b outwards.

FIG. 25B shows that as the user presses the handle 534, the wide section 535 of the push flange 533 passes through the wide portion 247 of the opening 245b and the bent section 532b rotates about the portion of the spring clip 530b where the base section 531 joins the bent section 532b towards the top surface 93 of the drywall panel 90. As the bent section 532b is deflected closer towards the top surface 93, the rotational motion of the bent section 532b causes the push flange 533 to displace upwards towards the base end 214 of the housing 200c. However, the upward displacement of the push flange 533 is limited due to physical contact between the top surface of the wide section 535 and the edge 248 of the opening 245b. The constraints imposed by the wide portion 247 of the opening 245b may cause the push flange 533 to bend towards the bent section 532b as the bent section 532b is deflected further outwards. Said in another way, the angle between the push flange 533 and the bent section 532b may decrease from Θ₁ to Θ₂ as shown in FIGS. 25A and 25B.

When the push flange 533 is sufficiently displaced through the opening 245b such that the narrow section 536 is disposed within the wide portion 247 of the opening 245b, the edge 248 of the opening 245b may no longer constrain the push flange 533. Once this occurs, the internal restoring force generated within the spring clip 530b by the deflection of the push flange 533 relative to the bent section 532b may cause the push flange 533 to move upwards such that the narrow section 536 is disposed within the narrow portion 246 of the opening 245b as shown in FIG. 25C. Once this occurs, the edges of the push flange 533 defining the notches 537 may prevent the push flange 533 from moving in or out through the opening 245b, thus locking the bent section 532b in place. In this manner, the spring clip 530b and the flange 514 of the mounting ring 510b may clamp onto the drywall panel 90.

During installation, the installer may actuate both spring clips 530b by pressing on the corresponding handle 524, thus providing multiple points of attachment between the housing assembly 101d and the drywall panel 90. As described above, the pair of spring clips 530b may be disposed diametrically opposite to one another, thus providing two attachment points on opposite sides of the housing assembly 101d. To uninstall and remove the housing assembly 101d, the handle 534 of each spring clip 530b may be pulled downwards, causing the push flange 533 to move downwards into the wide portion 247 of the opening 245b. Once this occurs, the handle 534 may then be pulled inwards into the cavity 210 to disengage the bent section 532b from the drywall panel 90.

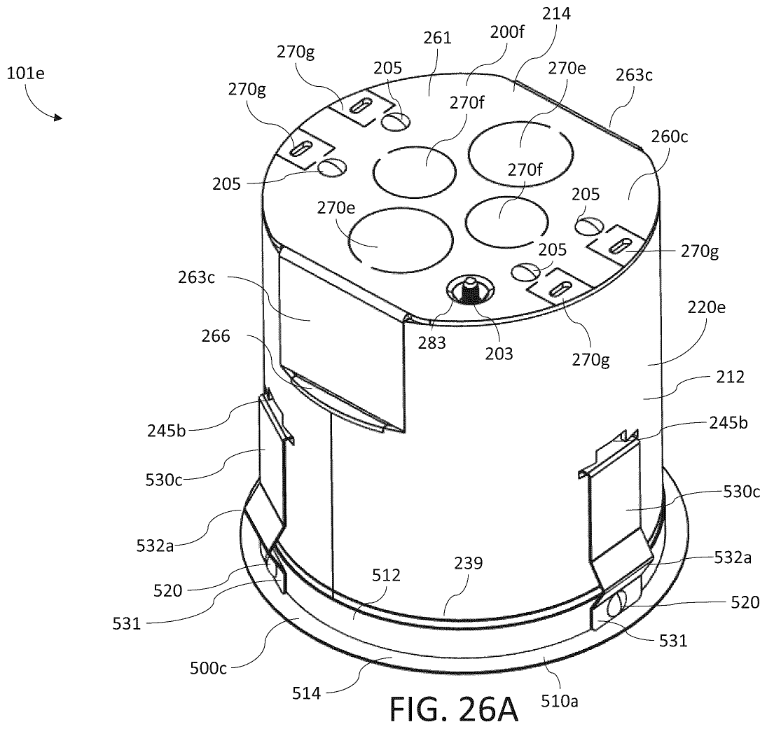

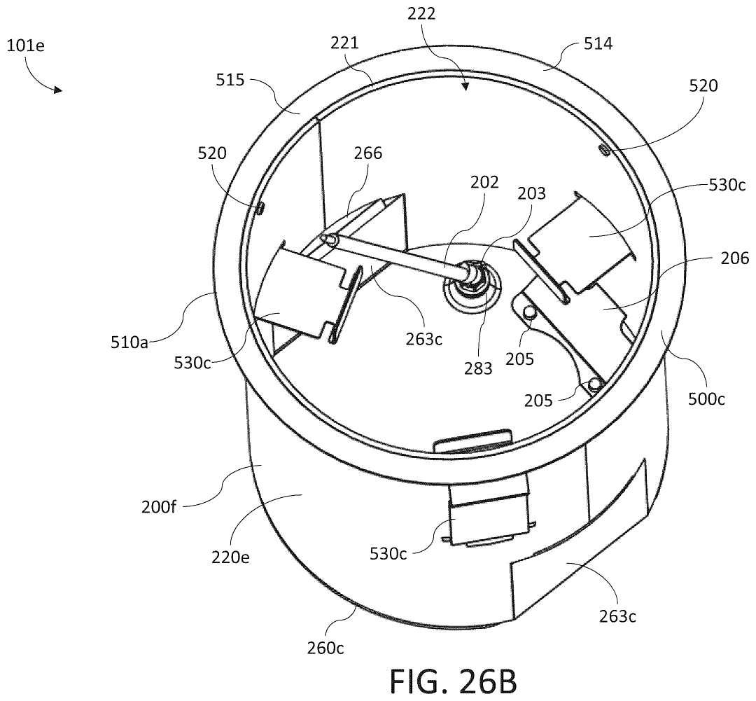

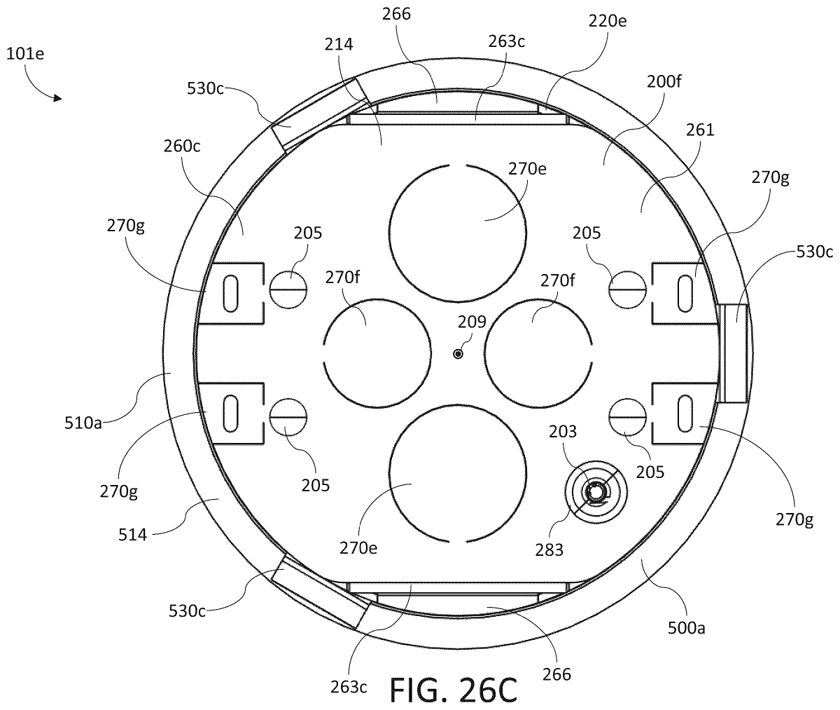

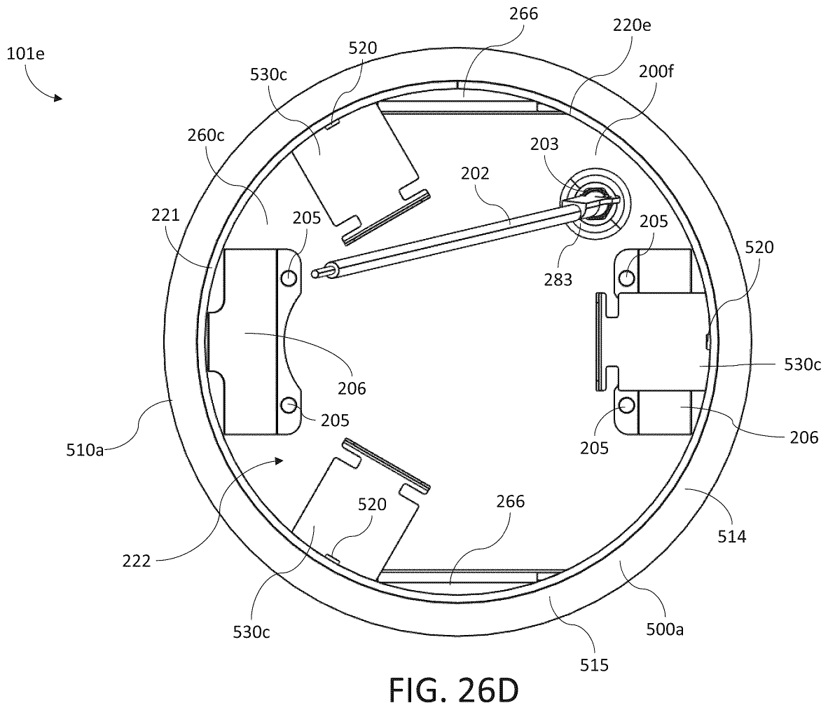

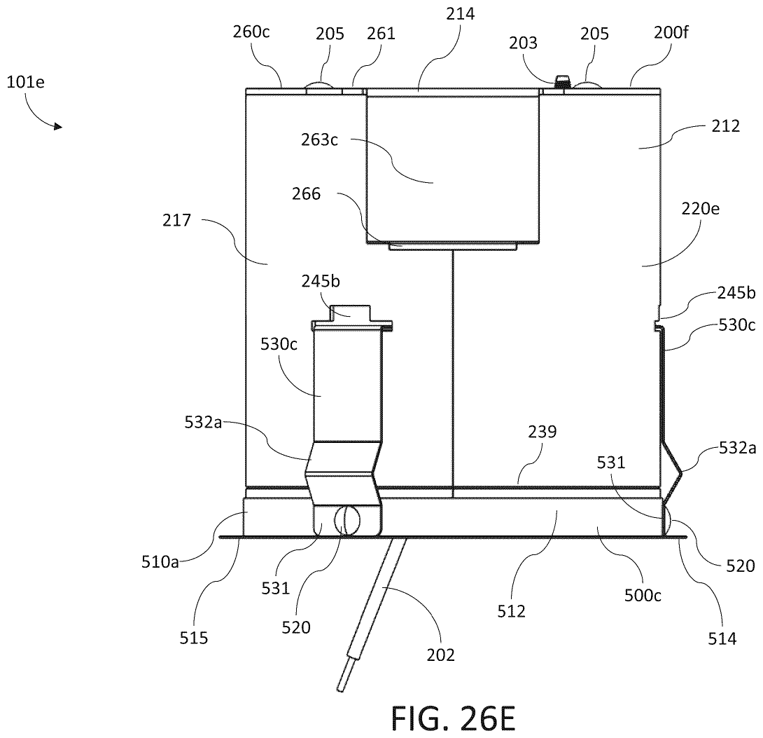

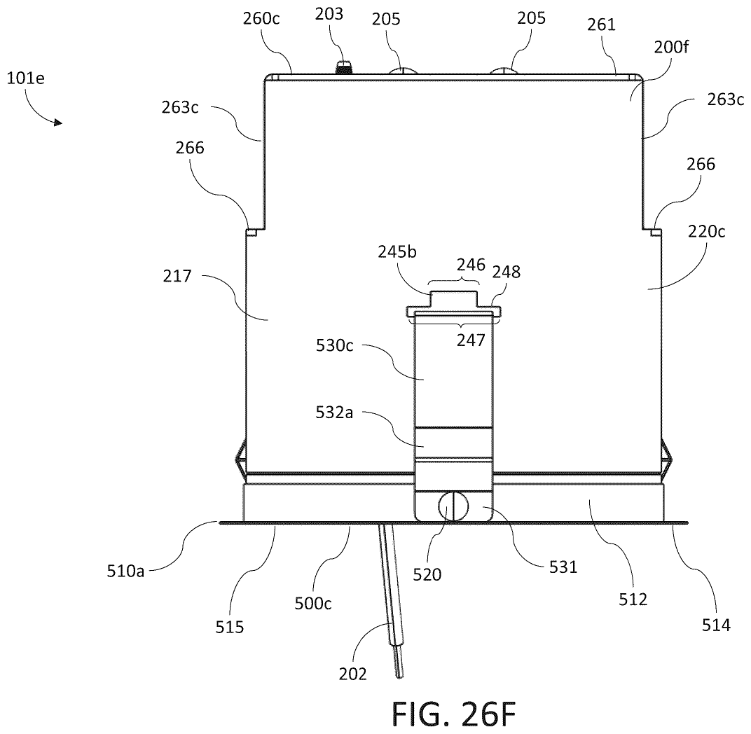

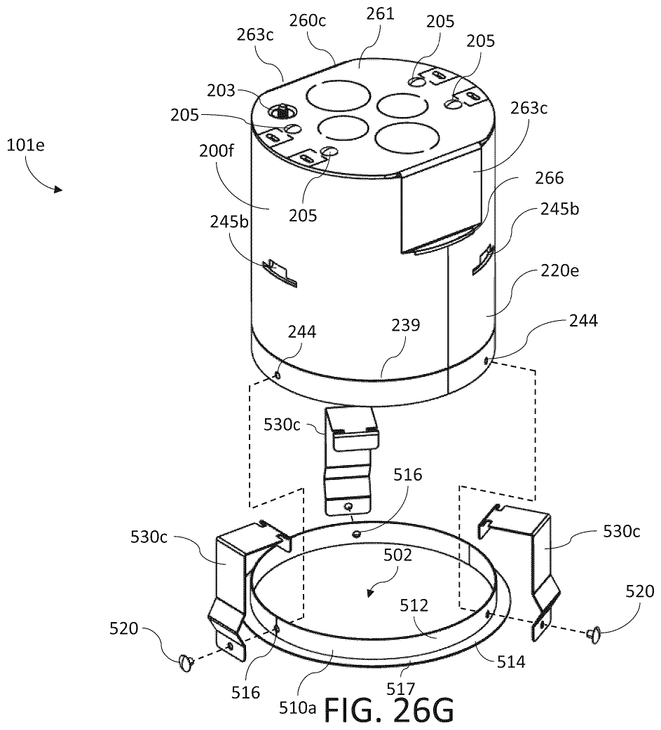

FIGS. 26A-26I show yet another exemplary housing assembly 101e for a remodel installation that includes a spring clip assembly 500c with another push-based actuation mechanism. As shown, the housing assembly 101e includes a housing 200f assembled from a sidewall component 220e and the top component 260c of the housing 200d. The spring clip assembly 500c may further include the mounting ring 510a of the spring clip assembly 500a and multiple spring clips 530c. The housing assembly 101e may thus utilize several of the same components in the housing assemblies 101c and 101d, which illustrates the components in the housing and housing assemblies described herein may be interchangeable to provide housings with different structural features and/or housing assemblies with different mounting features.

The sidewall component 220e may also incorporate several features from both the sidewall components 220c and 220d. Specifically, the sidewall component 220e may be a variant of the sidewall component 220c with the difference being the openings 245a are each replaced with the opening 245b of the sidewall component 220d. As shown in FIG. 26G, the sidewall component 220e may include three openings 245b disposed directly above corresponding fastener openings 244 to align with the three spring clips 530c. As before, each of the openings 245b include a wide portion 247 to receive a wide section 535 of a push flange 533 on the spring clip 530c and a narrow portion 246 disposed directly above the wide portion 247 to receive a narrow section 536 of the push flange 533.

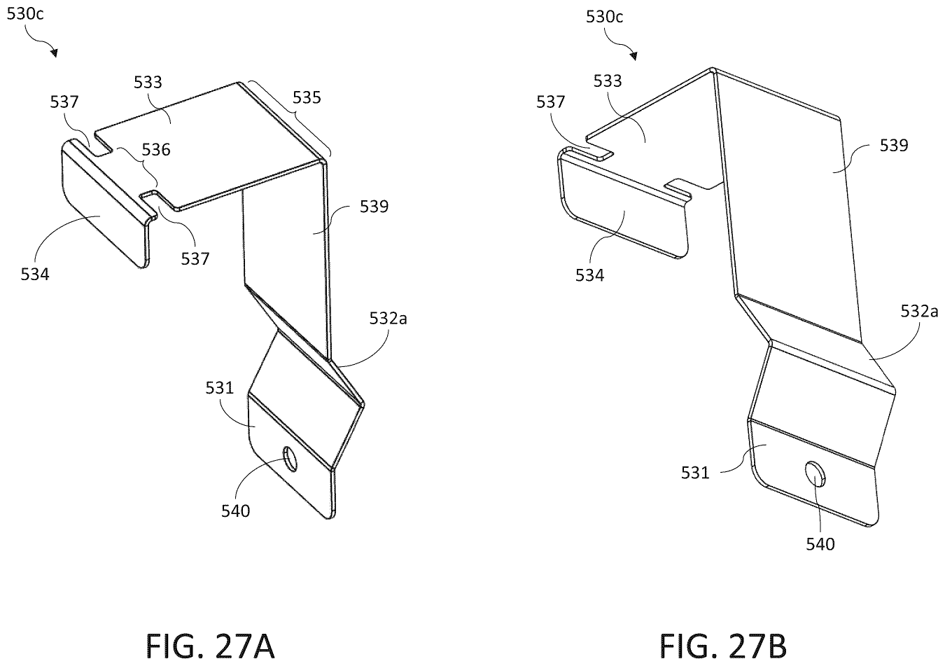

FIGS. 27A and 27B show several additional views of the spring clip 530c. As shown, the spring clip 530c may also incorporate several features from both the spring clips 530a and 530b. For example, the spring clip 530c may include the base section 531 with the fastener opening 540 and the bent section 532a from the spring clip 530a. The spring clip 530c may further include an intermediate section 539 similar in shape with the end section 538 of the spring clip 530a with the difference being the intermediate section 539 does not include any openings. The spring clip 530c may further include a push flange 533 and a handle 534 similar in shape and dimensions with the spring clip 530b. The narrow section 536 of the push flange 533 may once again be disposed near the handle 534 and may further be defined by a pair of notches 537 disposed on opposing sides of the push flange 533.

Each of the spring clips 530c may be actuated in a similar manner as the spring clips 530b. Specifically, the installer may press the handle 534 of each spring clip 530c to displace the respective push flange 533 through the opening 245b so that the bent section 532a and, by extension, the intermediate section 539 is deflected outwards towards the top surface of a drywall panel. The wide section 535 of the push flange 533 may be constrained by the wide portion 247 of the opening 245b, thus causing the push flange 533 to bend relative to the bent section 532a as the bent section 532a deflects closer to the drywall panel. Once the push flange 533 is sufficiently displaced such that the narrow section 536 is disposed within the wide portion 247 of the opening 245b, the internal restoring force generated by the relative deflection between the push flange 533 and the intermediate section 539 and/or the bent section 532a causes the push flange 533 to deflect upwards such that the narrow section 536 is disposed within the narrow portion 246 of the opening 245b. In this manner, the spring clip 530c may be locked in position once engaged with the drywall panel.

### A Round-Shaped Housing for a New Construction Installation

In some implementations, the housings and housing assemblies disclosed herein may be tailored to support a new construction installation. In a typical new construction installation, the housing assembly of the lighting system is installed before the construction of the environment is complete. For example, the environment may not include a ceiling enclosed by a drywall panel, thus exposing various support structures (e.g., a wood/metal joist, a T-bar, a hat channel) in the ceiling space. To install the lighting system, the housing assembly may be mounted to one or more of the support structures using, for example, a bar hanger assembly. In some implementations, the housing assembly may be directly mounted to one single support structure. Once the housing assembly is mounted, a drywall panel may then be installed to enclose the ceiling and an opening may then be cut to expose the housing through the drywall panel. In some implementations, the housing may then be lowered such that a bottom end of the housing is disposed within the opening. Once the housing is exposed, a lighting module and a trim may then be inserted into the housing.

FIGS. 28A-28N show several views of an exemplary housing assembly 101f tailored for a new construction installation. As shown, the housing assembly 101f may include a housing 200g that may be similar in construction with the housings 200b-200f. For instance, the housing 200g may include a single sidewall component 220f and a top component 200g that together define a cavity 210 to contain and support a lighting module, at least a portion of a trim, and various electrical wire and wiring connections with an external power supply system. The housing assembly 101f may further include a bar hanger assembly 400c to mount the housing assembly 101f to two or more support structures in the environment. The housing assembly 101f is also shown with a cover plate 296 and a yoke 290 to illustrate the use of the housing assembly 101f as an electrical outlet box as discussed in more detail below. It should be appreciated, however, that in a lighting installation, the cover plate 296 and the yoke 290 are not present. Instead, a lighting module and a trim may be installed into the housing 200g.

FIGS. 28M and 28N show additional views of the sidewall component 220f and the top component 260e of the housing 200g. As shown, the sidewall component 220f may once again include a curved portion 217 that defines the round shape of the sidewall 212 of the housing 200g. Similar to the sidewall components 220b-200e, the sidewall component 220f may be formed from a single piece of sheet metal rolled into the desired round shape with opposing sides forming a seam 251 that is welded during fabrication. The sidewall component 220f may thus surround and define the cavity 210 and may further include a bottom end 221 defining a bottom opening 222 into the cavity 210 and a top end 224 defining a top opening that is enclosed by the top component 260e. The sidewall component 220e may further include a pair of notches 226 disposed diametrically opposite with respect to one another to provide space for corresponding knockout tabs 263d of the top component 260e. More generally, the notches 226 and the tabs 263d may be offset at any angle relative to one another about the centerline axis 209.

The sidewall component 220f may further include a pair of openings 240 disposed diametrically opposite to one another. The openings 240 may provide a mounting feature to couple the bar hanger assembly 400c and, specifically, a corresponding pair of bar hanger holders 430c to the housing 200g. In some implementations, each opening 240 may be shaped as a slot or, more generally, an elongated opening to define a path along which the position of the housing 200g may be changed relative to the bar hanger assembly 400c. For example, the opening 240 may be a substantially vertical or vertical slot to provide vertical adjustment of the housing 200g with respect to the bar hanger assembly 400c. The bar hanger holders 430c, in turn, may provide horizontal adjustment of the housing 200g with respect to respective pairs of bar hangers 410 as discussed in more detail below.

In some implementations, the sidewall component 220f may also include a groove 250 disposed above each opening 240 to provide a reference line to align and/or position the bar hanger holder 430c to the housing 200g. For example, the bar hanger holder 430c may include alignment markings (not shown), which the installer can use to align with the groove 250 to position the bottom end 221 of the housing 200g at a known distance below the bar hanger assembly 400c. As shown in FIG. 28M, the groove 250 may be formed as a horizontal indentation on the sidewall component 220f.

In some implementations, the sidewall component 220f may also include a groove 239 that forms a reference line to align and/or position a gasket 560 mounted to the housing 200g. The groove 239 may be formed as a horizontal indentation that extends around the periphery of the sidewall component 220f. For example, FIGS. 28G-28J show the gasket 560 may be disposed around an exterior portion of the sidewall component 220f located just below the groove 239. Similar to the housing assembly 101d, the gasket 560 may wrap tightly around the sidewall component 220f to reduce or, in some instances, eliminate gaps between the gasket 560 and the housing 220f. The gasket 560 may thus protrude outwards to contact and seal the edges of the ceiling defining the opening within which the housing assembly 101d is installed. As before, the gasket 560 may form an airtight seal separating the environment and the ceiling space.

The top component 260e may include several of the same features as the top components 260b-260d. For example, the top component 260e may include a base section 261 to cover the top end 224 and top opening of the sidewall component 220f. The top component 260e may further include a pair of knockout tabs 263d that extend from the base section 261 at an angle to cover the notches 226 of the sidewall component 220f. Each knockout tab 263d may include a circular knockout 270f. For a new construction installation, the knockouts 270f disposed on the knockout tabs 263d may facilitate insertion of a conduit cable or, in some instances, a straight conduit run that passes through one or both of the knockouts 270f on the knockout tabs 263d. Each knockout tab 263d may also include an end portion 266 to cover gaps formed between the knockout tab 263d and the curved sidewall component 220f. The base section 261 may include multiple circular knockouts 270e and 270f as well as multiple Romex knockouts 270g. The top component 260e may further support multiple retainers 206 coupled to the base section 261 via fasteners 205. The top component 260e may also include a ground connection feature 283 to couple a ground cable 202 to the top component 260e via a fastener 203.

As described above, in some implementations, the components of the housing 200g may be fabricated using the same or similar manufacturing processes as a housing tailored for a remodel installation. This may reduce manufacturing costs while providing housings tailored for different installations. For example, the sidewall component 220f and the top component 260e may be fabricated using the same or similar manufacturing processes as the sidewall component 220c and the top component 260c, respectively, with modifications to accommodate different mounting features and/or arrangement of knockouts for the remodel and new construction installations.

FIGS. 28A and 28B show the bar hanger assembly 400c may include a first pair of bar hangers 410-1 and 410-4 and a second pair of bar hangers 410-2 and 410-3 where the first and second pairs of bar hangers are disposed on opposite sides of the housing 200g. Each pair of bar hangers 410 may be telescopically coupled to one another and may be further slidably coupled to corresponding bar hanger holders 430c. Each bar hanger holder 430c, in turn, may be coupled directly to the sidewall component 220f of the housing 200g. This allows the installer to adjust the length of the bar hangers 410, for example, to traverse a gap between support structures. Additionally, the position of the housing 200g along the bar hangers 410 may also be adjusted, thus allowing the installer to place the housing 200g at a desired location along the ceiling.

The bar hanger assembly 400c may further include crossmembers 414-1 and 414-2 (collectively referred to herein as a “crossmember 414”) that couple to one bar hanger 410 from each pair of bar hangers 410. Specifically, the crossmember 414-1 may be coupled to the bar hangers 410-1 and 410-2 and the crossmember 414-2 may be coupled to the bar hangers 410-3 and 410-4. The crossmembers 414 may thus constrain the bar hangers 410 such that the length of the first and second pairs of bar hangers are substantially equal or equal to one another. In this manner, the crossmembers 414 may reduce the number of independent moving parts in the bar hanger assembly 400c during installation. Said in another way, the installer may only adjust the position of the two crossmembers 414-1 and 414-2 rather than adjusting the position of each individual bar hanger 410.

In some implementations, the bar hangers 410 may be substantially identical in shape and/or dimensions. Thus, one bar hanger 410 may engage another bar hanger 410 by being flipped upside down with respect to the other bar hanger 410. For example, the bar hangers 410 in the bar hanger assembly 410c may be the same as the bar hangers 410-1 and 410-2 in the bar hanger assembly 400b. FIG. 16 shows the bar hanger 410-1 may be rotated 180 degrees with respect to the bar hanger 410-2 when telescopically coupled to one another. In this manner, one type of bar hanger 410 is used, thus reducing the number of different parts in the housing assembly 101f for manufacture. However, it should be appreciated that in some implementations, the bar hangers 410 may each have different shapes and/or dimensions. In particular, the bar hangers 410-1 and 410-4 or the bar hangers 410-2 and 410-3 may have different shapes and/or dimensions.

In some implementations, the bar hanger 410 may be shaped and/or dimensioned to reduce lateral play when telescopically coupled to another bar hanger 410. For example, the respective pairs of bar hangers 410 (e.g., the bar hangers 410-1 and 410-4 or the bar hangers 410-2 and 410-3) may physically contact one another such that the relative lateral movement between the bar hangers 410 is reduced or, in some instances, mitigated. In some implementations, the pair of bar hangers 410 may impart a compressive force onto each other that further reduces lateral play. The compressive force may also produce a corresponding frictional force that holds one bar hanger 410 at a desired position with respect to the other bar hanger 410 unless a user applies a sufficiently large force to slidably adjust the respective positions of the bar hangers 410.

Examples of bar hangers that are substantially identical in shape and/or dimension, reduce lateral play, and/or provide a compressive holding force may be found in U.S. application Ser. No. 16/886,365, filed on May 28, 2020, entitled, “ADJUSTABLE HANGER BAR ASSEMBLY” (hereinafter the '365 application) and International Application No. PCT/US2019/054220, filed on Oct. 2, 2019, entitled, “A BAR HANGER ASSEMBLY WITH MATING TELESCOPING BARS” (hereinafter the '220 application). The contents of each of the aforementioned applications is incorporated by reference herein in its entirety.

The crossmember 414 may generally provide several mounting features to facilitate installation onto various support structures including, but not limited to, a wood/metal joist or stud, a T-bar, a hat channel, and a metal frame. The crossmember 414 may be attached to the different support structures using one or more fasteners inserted through appropriate openings in the crossmember. For example, FIGS. 28A and 28B show each crossmember 414 may include captive fasteners 415 to couple the crossmember 414 to, for example, a wood joist. It should be appreciated other fasteners (not shown) may be inserted through one of the openings on the crossmember 414. The crossmember 414 may also include features (e.g., a safety cable opening) to facilitate attachment of a safety cable (also referred to as an aircraft cable or an earthquake cable), which provides a secondary attachment mechanism to ensure the housing assembly 101f remains suspended from a support structure in the event the fasteners coupling the crossmember 414 to one or more support structures detach or fail (e.g., during an earthquake).

In some implementations, the crossmember 414 may be a separate component from the bar hangers 410, which may improve ease of manufacture of the crossmember 414. For example, the crossmember 414 may be readily formed from a single piece of sheet metal. The crossmember 414 may be coupled to the bar hangers 410 via one or more rivet fasteners.

The bar hanger holder 430c may generally define a passageway 437 to guide and support the pair of bar hangers 410 as shown in FIG. 28G. The bar hanger holder 430c may further include a fastener opening to receive a locking fastener 435 to lock the relative position of the housing 200g along the bar hangers 410. Specifically, the locking fastener 435, when tightened, may press the bar hangers 410 against the bar hanger holder 430c, thus imparting a friction force that restricts movement of the bar hanger holder 430c and, by extension, the housing 200g along the bar hangers 410.

The bar hanger holder 430c may further include a rod 438 that protrudes through the opening 240 on the sidewall component 220f of the housing 200g as shown in FIG. 28J. This may allow the installer to adjust the position of the housing 200g relative to the bar hanger assembly 400c by sliding the rod 438 along the path defined by the opening 240. For example, the opening 240 may be a vertical slot as described above, which may allow vertical adjustment of the housing 200g with respect the bar hanger holders 430c. The bar hanger holder 430c may further include a locking nut 439a coupled to the rod 438 from within the cavity 210 of the housing 200g. When the locking nut 439a is sufficiently tightened, the sidewall component 220f may be clamped to the bar hanger holder 430c, thus maintaining the desired position of the housing 200g relative to the bar hanger holders 430c.

The bar hanger holder 430c may also include vertical side flanges that abut the exterior surface of the sidewall component 220f and align the bar hanger holder 430c to the housing 200g. Specifically, the side flanges may be shaped and/or dimensioned such that the side flanges only abut the curved sidewall component 220f when the bar hanger holder 430c is oriented substantially vertical or vertical.

In some implementations, the bar hanger holder 430c may be formed from a single piece of sheet metal that is bent to form the passageway 437 and the side flanges. As shown in FIGS. 28K and 28L, the bar hanger holder 430c may include multiple rivet fasteners 440 to couple together respective ends of the bar hanger holder 430c defining the passageway 437 so that the bar hanger holder 430c may more stably support the bar hangers 410.

Examples of crossmembers that provide multiple mounting features to couple the housing assembly to various support structures and include one or more safety cable openings and/or bar hanger holders formed of a single piece of sheet metal may be found in U.S. Application No. 63/071,440, filed on Aug. 28, 2020, entitled, “BAR HANGER ASSEMBLY WITH CROSS MEMBERS AND HOUSING ASSEMBLIES USING SAME” (hereinafter the '440 application). The contents of the aforementioned application is incorporated by reference herein in its entirety.

Although the housing 200g is tailored to support a lighting system, it should be appreciated that, in some implementations, the housing 200g may also be used as an electrical outlet box mounted to a ceiling. Specifically, the housing 200g may be used to contain various electrical wires and wire connections (e.g., wire splices). The bottom end 221 and the bottom opening 222 may also be covered by a cover plate 296 as shown in FIGS. 28B, 28D, and 28F. The cover plate 296 may further cover and enclose the opening formed in the ceiling, thus providing a barrier separating the various electrical wiring and components disposed inside the housing 200g from the environment.

As described above, the housing 200 may generally be shaped and/or dimensioned to contain a lighting module, at least a portion of a trim, and provide a sufficient volume allowance for a specific number of wires of a particular gauge in accordance with Article 314.16 of the 2020 NEC. Thus, it should be appreciated that in installations where the housing 200g is used as an electrical outlet box, the housing 200g may generally provide a volume that exceeds the requirements specified by Article 314.16 of the 2020 NEC.

Conventional electrical outlet boxes typically include one or more tabs disposed along an opening facing the environment. Each includes a fastener opening to couple a cover plate to the electrical outlet box. For the housing 200g, the sidewall component 220f does not include any tabs with openings to facilitate attachment to the cover plate 296. Instead, FIGS. 28H-28L show the housing assembly 101f may include the yoke 290 to mechanically couple the cover plate 296 to the housing 200g. As shown, the yoke 296 may include a frame 291 and a pair of arms 293 joined to the frame 291. The frame 291 may define an opening 292 and include tabs 295 that extend into the opening 292. Each tab 295 includes a fastener opening that aligns with fastener openings 297 on the cover plate 296. Fasteners 298 may thus be used to couple the cover plate 296 to the frame 291 of the yoke 290. In some implementations, the openings on the tabs 295 may be positioned and/or aligned according to industry standards to ensure compatibility with a large selection of cover plates.

Each arm 293 may further include an opening 294 that aligns with one of the openings 240 on the sidewall component 220f. Thus, the rod 438 of the bar hanger holder 430c may also extend through the opening 294 to couple the yoke 290 to the housing 200g. As shown in FIG. 28J, the locking nut 439a, when tightened, may clamp the arm 293 to the sidewall component 220f of the housing 200g, thus securing the yoke 290 and the cover plate 296 to the housing 200g. FIG. 28J further shows the yoke 290 may be shaped and/or dimensioned fit entirely within the cavity 210 of the housing 200g. In some implementations, the opening 294 may be shaped as a slot or, more generally, an elongated opening so that the yoke 290 may be pulled out from the bottom end 221 of the housing 200g while remaining coupled to the housing 200g, thus preventing accidental loss or removal of the yoke 290 from the housing 200g.

In a typical installation, the yoke 290 may first be placed in the cavity 210 of the housing 200g such that the rod 438 of each bar hanger holder 430c passes through the openings 294 on the pair of arms 293. The bottom surface of the frame 291 may be flush with the bottom end 221 (i.e., the bottom surface of the frame 291 and the bottom end 221 lie on the same horizontal plane) or positioned above the bottom end 221. The respective locking nuts 439a may then be tightened to securely couple the yoke 290 to the housing 200g. The cover plate 296 may then be coupled to the yoke 290 via the fasteners 298 as described above. As shown in FIG. 28J, the cover plate 296 may abut the bottom end 221 of the housing 200g.

The yoke 290 may generally be formed a single unitary component. For example, the yoke 290 may be formed from sheet metal. However, it should be appreciated that, in some implementations, the yoke 290 may also be formed from plastic.

The cover plate 296 may also be formed a single unitary component from metal or plastic. Additionally, the cover plate 296 shown in FIGS. 28B, 28D, and 28F is circular in shape. However, it should be appreciated the cover plate 286 may have other shapes including, but not limited to, an ellipse, a polygon (e.g., a square, a rectangle), or any combinations of the foregoing. In some implementations, the cover plate 296 may be a commercial-off-the-shelf component that the installer can purchase and install according to their desired preferences.

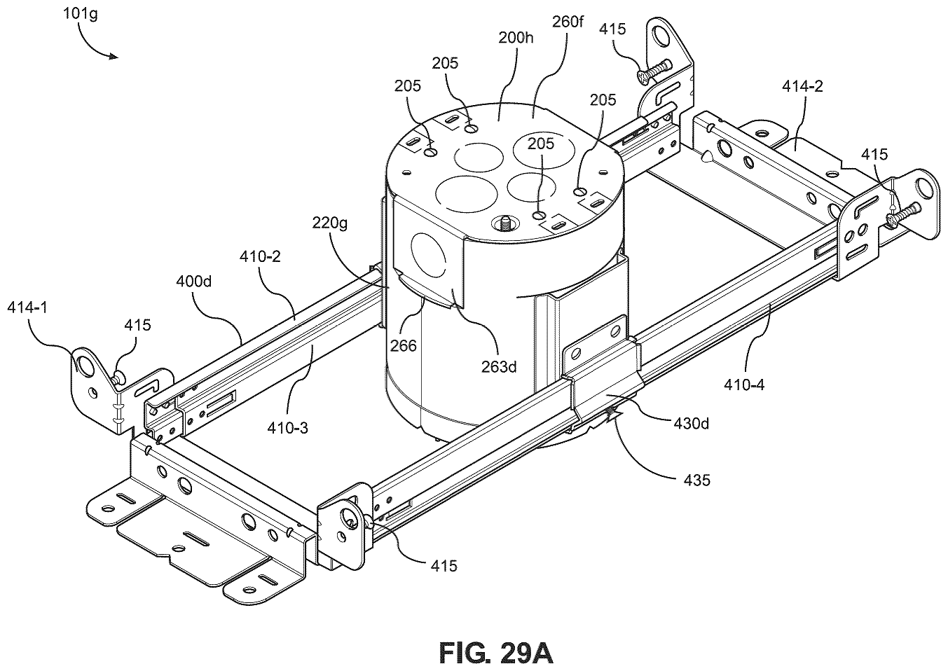

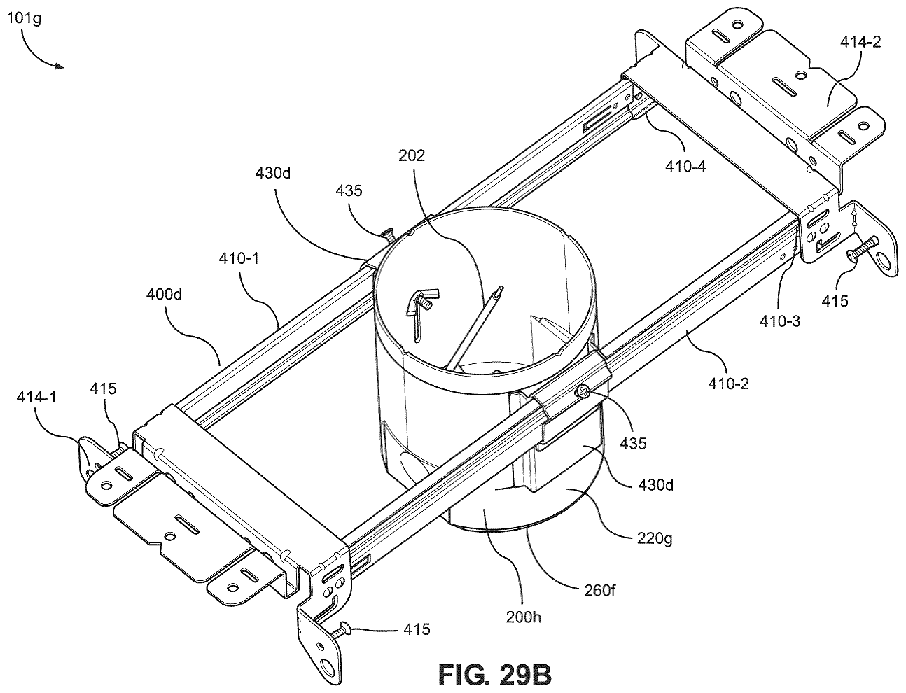

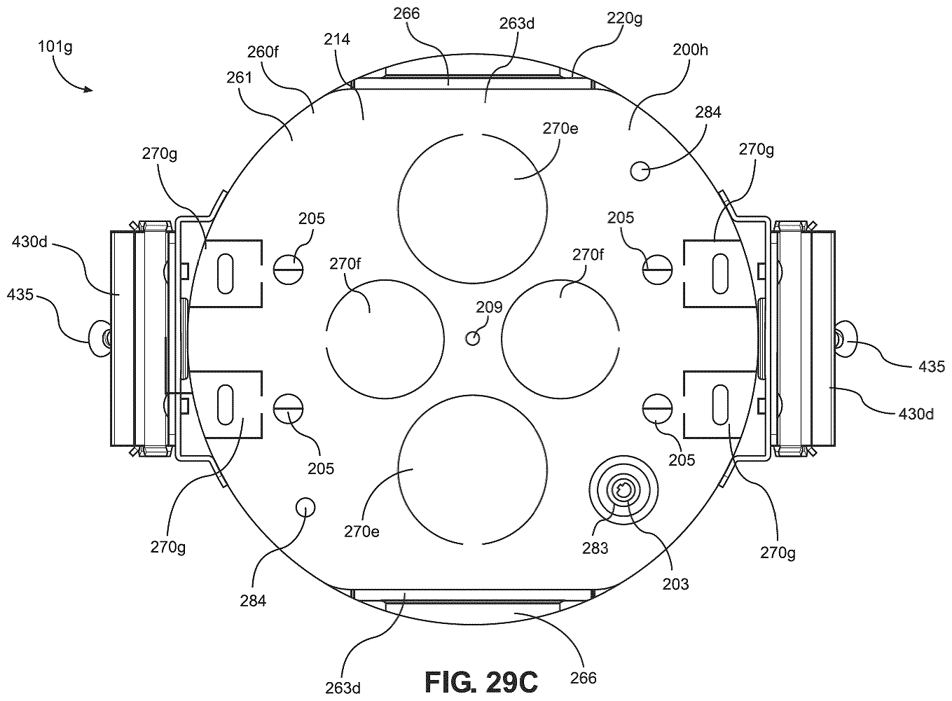

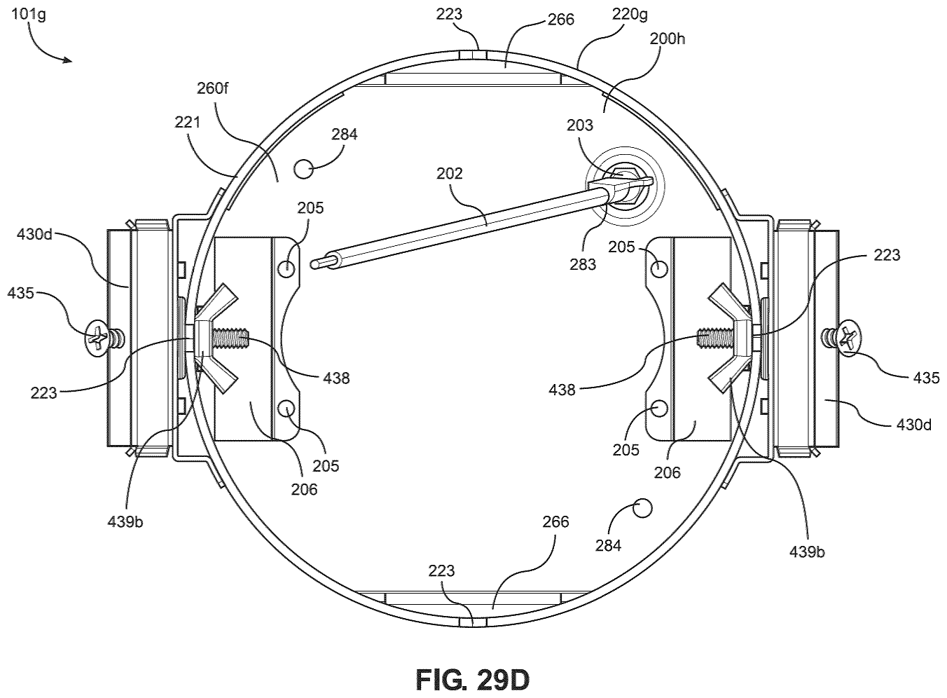

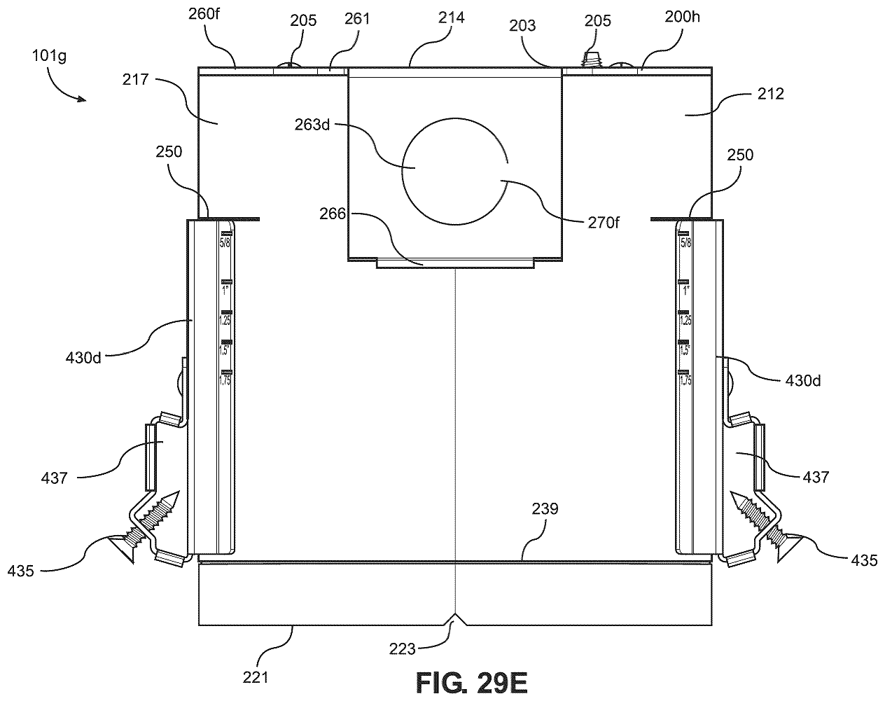

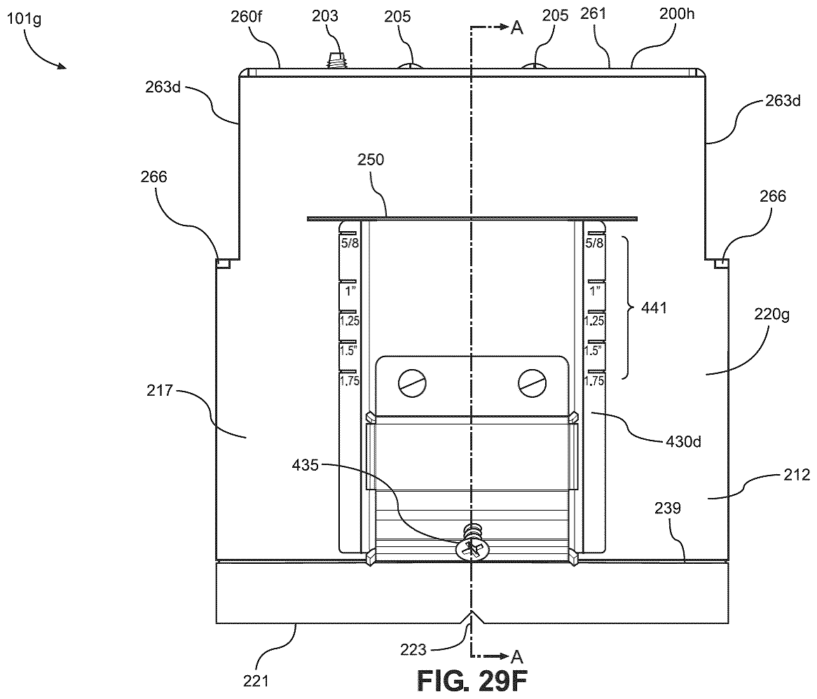

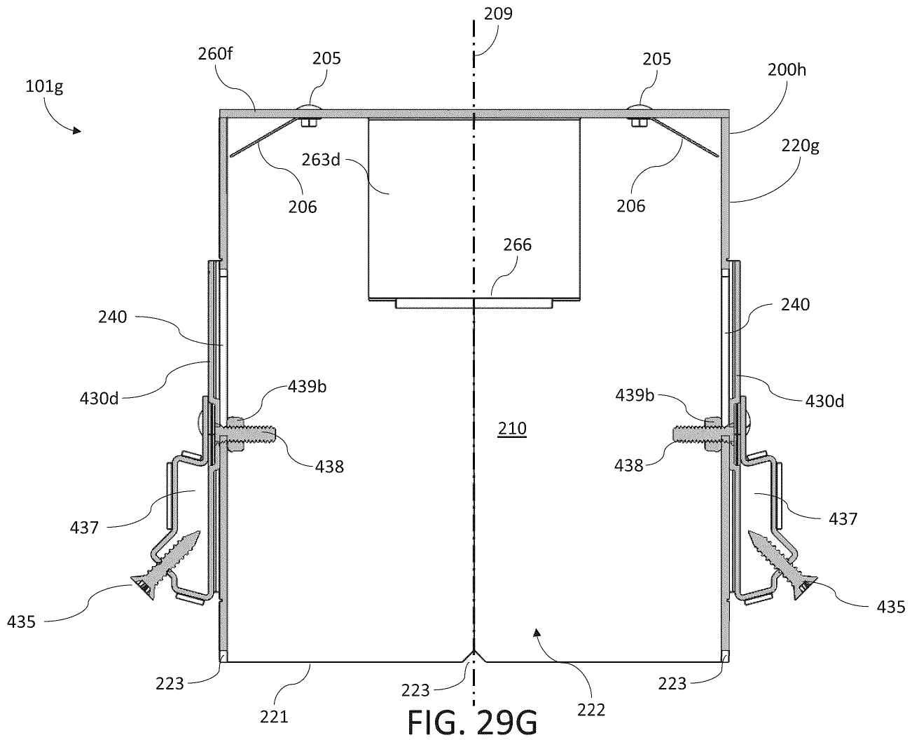

FIGS. 29A-29G show another exemplary housing assembly 101g for a new construction installation. As shown, the housing assembly 101g may include a housing 200h and a bar hanger assembly 400d of the housing assembly 101f.

Specifically, the housing 200h may include a single sidewall component 220g and a top component 260f. The sidewall component 220g may be a variant of the sidewall component 200f that additionally includes multiple notches 223 disposed along the bottom end 221. In some implementations, the notches 1114 may be triangular in shape. The notches 223 may be arranged in pairs that are disposed diametrically opposite from one another along the bottom end 221. For example, FIG. 29D shows two pairs of notches 223 that divide the bottom end 221 into substantially equal or equal quadrants.

The notches 223 may be arranged in this manner to facilitate alignment of the housing assembly 200h to the various support structures and/or other housing assemblies in the environment during installation. For example, multiple housing assemblies 101g may be installed in an environment and arranged in a row. In order to align the housings 200h of the housing assemblies 101g, a laser guide may be used to provide a laser beam that defines an alignment axis. The alignment axis may be based on the desired location of the housings 200h in the environment or may be used to locate an axis of one housing assembly 101g that is already installed in the environment. When installing the housing assemblies 101g, the position of each housing 200h may be adjusted such that the laser beam passes through a respective pair of notches 223. In this manner, the housings 200h may be aligned along a common axis within the environment.

The top component 260f may include features from both the top component 260e of the housing 200g and the top component 260d of the housing 200d. Specifically, the top component 260f may include the base section 261 of the top component 260d with the circular knockouts 270e and 270f, the Romex knockouts 270g, the retainers 206, the ground connection feature 283, and the openings 284. The top component 260f may further include the knockout tabs 263d of the top component 260e, which each include the knockout 270f and the end portion 266.

The bar hanger assembly 400d may also include the bar hangers 410 and the crossmembers 414 of the bar hanger assembly 400c. The bar hanger holder 430d may also include several of the same features as the bar hanger holder 430c with the addition of alignment marks 441 to aid the installer in adjusting the position of the housing 200h relative to the bar hanger holders 430d during installation. The bar hanger holder 430d may also include a wing nut 439b disposed within the cavity 210 of the housing 200h to lock the housing 200h to the bar hanger holders 430d from within the cavity 210.

A Round-Shaped Housing with Deep-Drawn Components

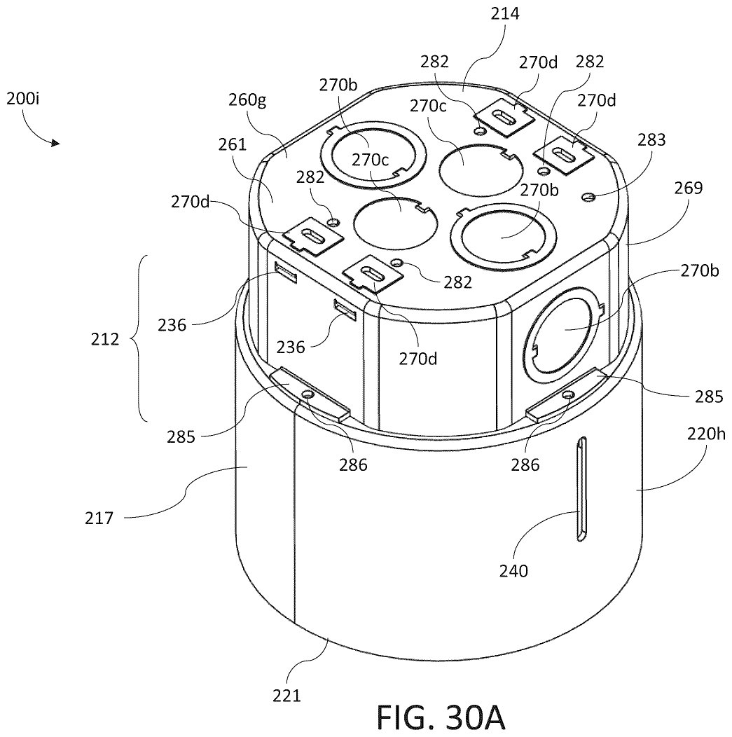

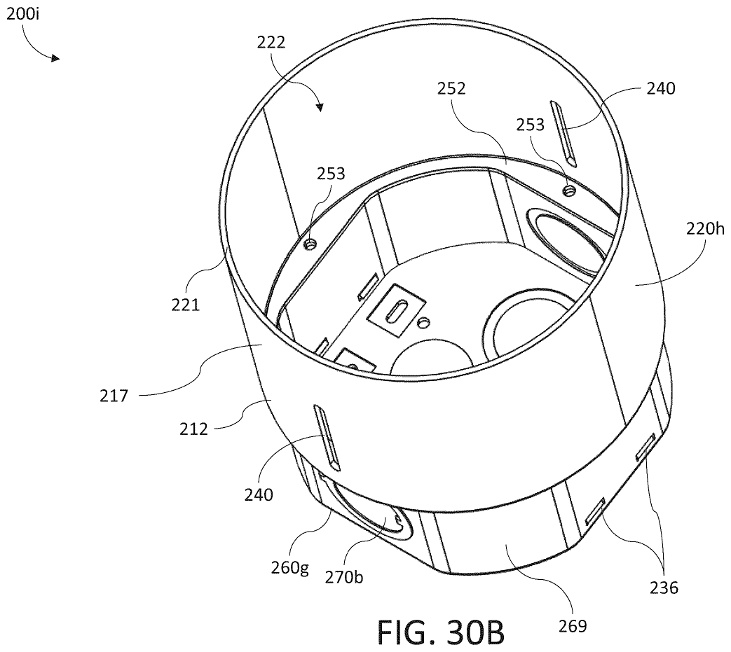

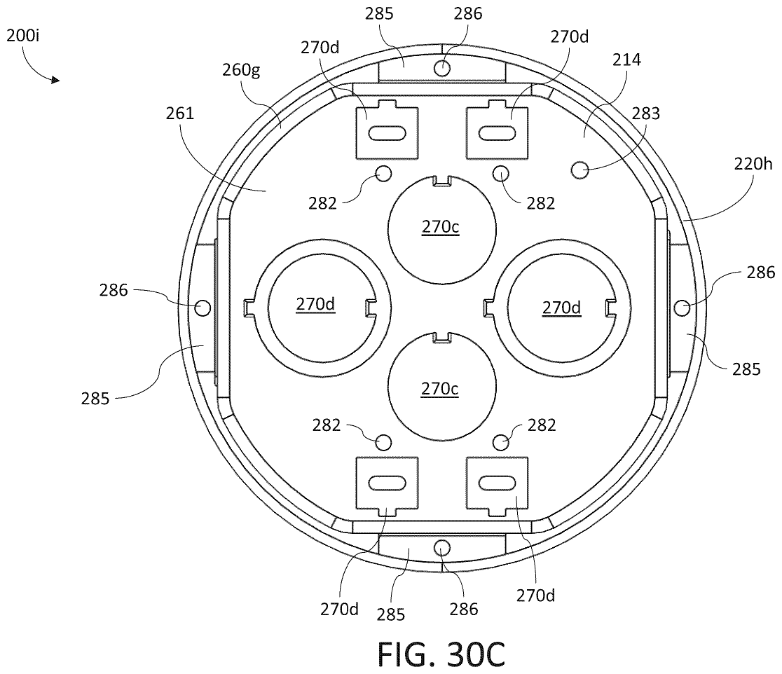

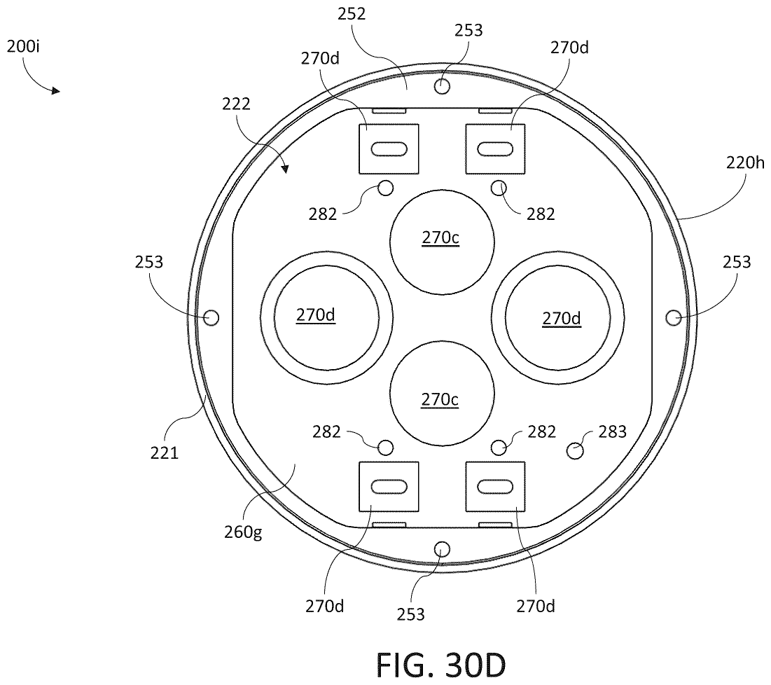

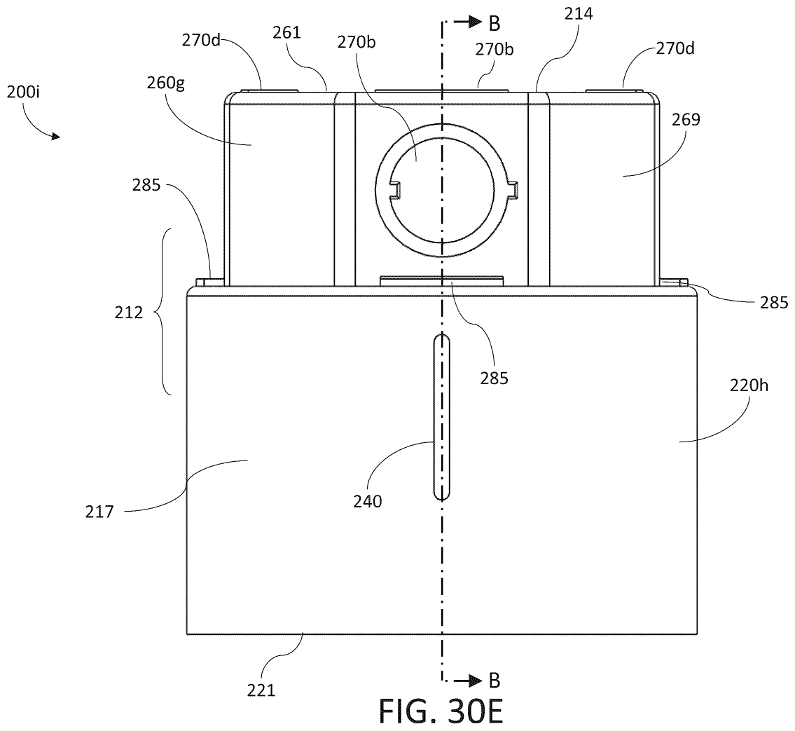

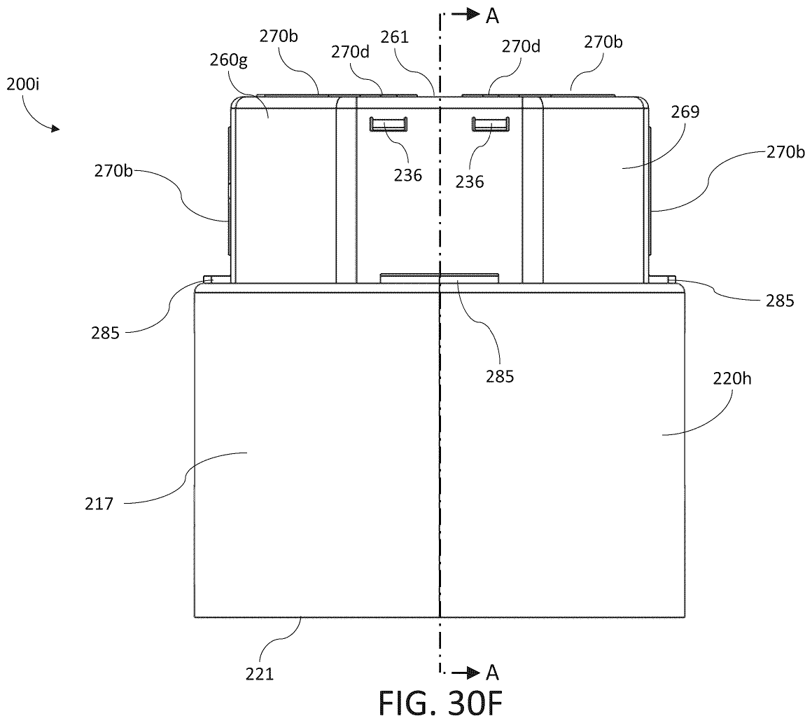

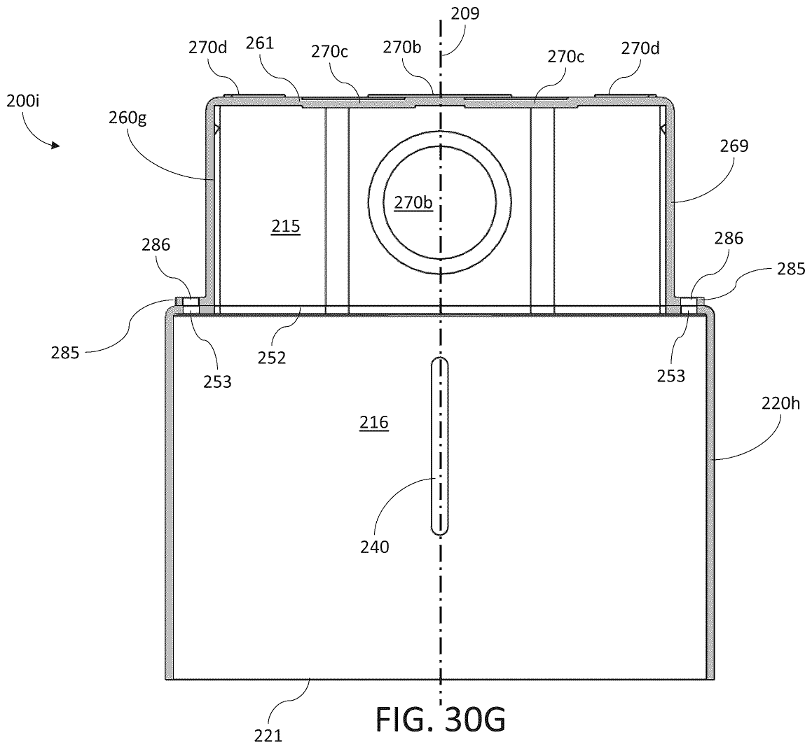

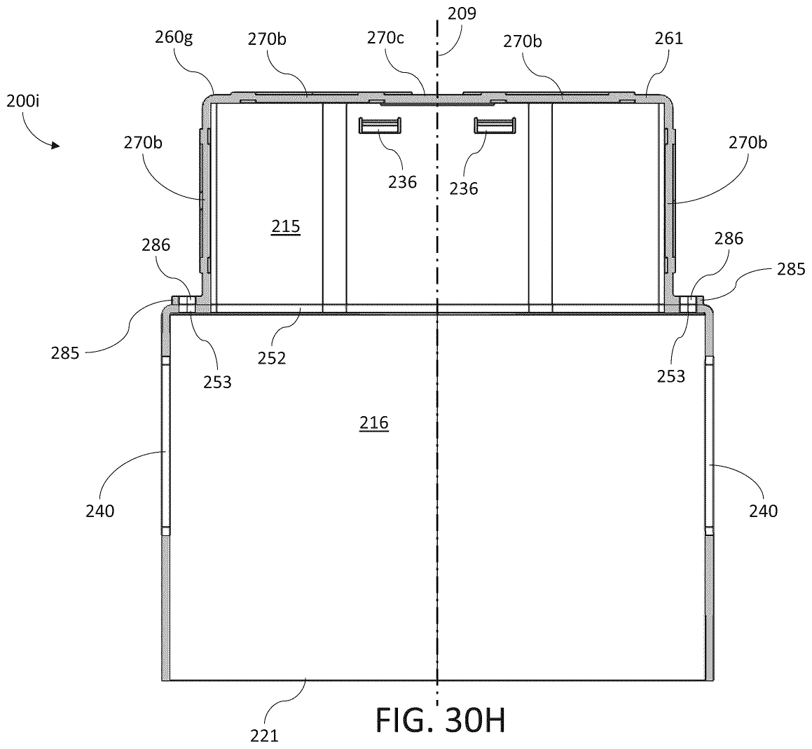

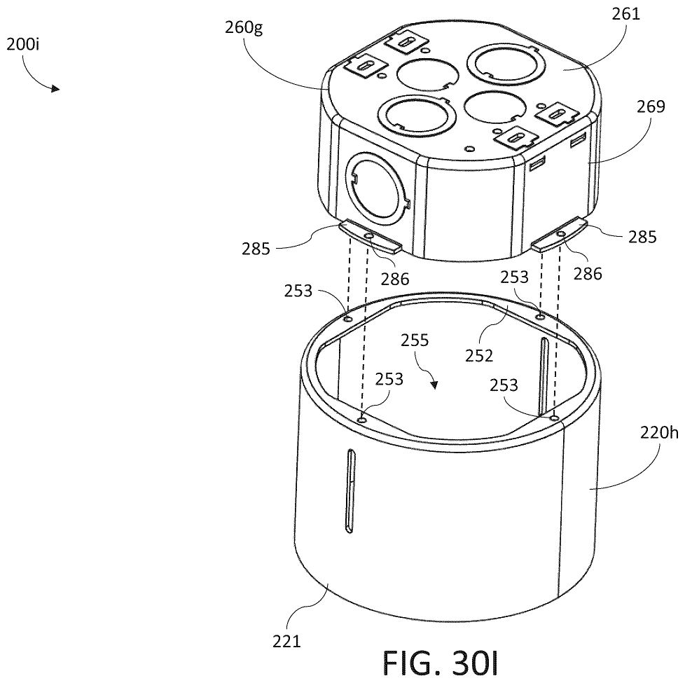

FIGS. 30A-30I show yet another exemplary housing 200i assembled using a top component 260g and a bottom component 220h. Similar to the housings 200b-200h, the top component 260g may provide several flat sections to support one or more knockouts while the bottom component 220h may define a round shape and, in particular, a round bottom end 221 disposed near or within an opening formed in a ceiling. In this implementation, however, the top component 260g may include a base section 261 and a sidewall 269 that defines an upper cavity 215 and the bottom component 220h may include a curved portion 217 that surrounds and defines a lower cavity 216.

For the purposes of defining the sidewall 212 and the base end 214, the sidewall 269 of the top component 260g and the bottom component 220h may together define the sidewall 212 and the top component 260g may define the base end 214 of the housing 200i. This arrangement may allow for a more complex-shaped sidewall 212 while still separating the various cable routing structural features and the curved shape between the top component 260g and the bottom component 220h for ease of manufacture. For example, the sidewall 269 of the top component 260g may be shaped such that the cross-section is a round square (i.e., four straight sections separated by four curved sections) while the curved portion 217 of the bottom component 220h may be shaped such that the cross-section is a circle. This may be accomplished, in part, by forming the top component 260g and the bottom component 220h using a deep drawing process.

As shown in FIGS. 30G and 30H, the upper cavity 215 may be disposed directly above and adjoin the lower cavity 216. In some implementations, the top component 260g may be shaped and/or dimensioned to provide a cavity 215 with a volume allowance that complies with Article 314.16 of the 2020 NEC. The bottom component 220h may be shaped and/or dimensioned to provide a cavity 216 that is sufficiently large to contain a lighting module, at least a portion of a trim, and any wires and/or wiring connections with wires and/or cables inserted into the housing 200i (e.g., the cable 96 from the external power supply system).

FIG. 30I shows the bottom component 220h may further include a flange 252 formed along the top end of the bottom component 220h that defines a top opening 255 so that the upper cavity 215 may be accessible from the lower cavity 216. As shown, the flange 252 may include multiple fastener openings 253 that align with fastener openings 286 of the top component 260g to facilitate attachment of the top component 260g to the bottom component 220h via corresponding fasteners (not shown). The bottom component 220h may further include a pair of elongated openings 240 to facilitate attachment of a bar hanger assembly (e.g., the bar hanger assemblies 400a-400d) to the housing 200i for a new construction installation. However, it should be appreciated that, in some implementations, the bottom component 220h may instead include various openings to facilitate attachment to a spring clip assembly (e.g., the spring clip assemblies 500a-500c).

FIGS. 30A and 30C show the base section 261 may support multiple circular knockouts 270b and 270c and multiple Romex knockouts 270d. The base section 261 may further include openings 282 to support retainers (not shown) to clamp wires and/or cables inserted through openings formed by the removal of the Romex knockouts 270d. Additionally, the base section 261 may include a ground connection feature 283, which is shown as an opening, to couple a ground cable (not shown) to the top component 260g via a fastener (not shown). The sidewall 269, as described above, may include multiple flat sections that supporting either one knockout 270b or a pair of slots 236 for the Romex knockouts 270d on the base section 261. In some implementations, the sidewall 269 may include a pair of knockouts 270b disposed on opposing sides. In some implementations, the sidewall 269 may also include two pairs of slots 236 disposed on opposing sides.

The bottom end of the sidewall 269 may further include tabs 285 that define the fastener openings 286 for attachment with the bottom component 220h. As shown in FIGS. 30E and 30F, the tabs 285 may abut the flange 252 after assembly. It should be appreciated that, in some implementations, the bottom end of the sidewall 269 may be welded to the flange 252. Thus, the top component 260g may not include the tabs 285 with the fastener openings 286 and the flange 252 of the bottom component 220h may not include the openings 253.

### CONCLUSION

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. (canceled)

2. A housing for a lighting system, the housing comprising:
a bottom component defining a lower cavity, the bottom component comprising:
a first sidewall surrounding the lower cavity, the first sidewall being shaped as a cylinder; and
a top component directly coupled to the bottom component and defining an upper cavity adjoining the lower cavity, the top component comprising:
a base end; and
a second sidewall joined to the base end and surrounding the upper cavity, the second sidewall comprising a plurality of flat sections.

3. The housing of claim 2, wherein the bottom component does not include a knockout.

4. The housing of claim 2, further comprising:
a plurality of knockouts disposed only on the top component.

5. The housing of claim 4, wherein the plurality of knockouts comprises:
a circular knockout; and
a Romex knockout.

6. The housing of claim 4, wherein the plurality of knockouts comprises:
a first knockout disposed on one flat section of the plurality of flat sections; and
a second knockout disposed on the base end.

7. The housing of claim 2, wherein the top component is coupled to the bottom component via a plurality of fasteners.

8. The housing of claim 7, wherein the top component further comprises:
a plurality of tabs joined to a bottom end of the second sidewall, each tab of the plurality of tabs having a fastener opening to receive a corresponding fastener of the plurality of fasteners.

9. The housing of claim 2, wherein the first sidewall comprises:
a first elongated opening configured for attachment to a first bar hanger assembly; and
a second elongated opening disposed diametrically opposite to the first elongated opening and configured for attachment to a second bar hanger assembly,
wherein the first elongated opening and the second elongated opening are configured to facilitate vertical adjustment of the housing with respect to the first bar hanger assembly and the second bar hanger assembly.

10. A housing assembly, comprising:
the housing of claim 9;
the first bar hanger assembly coupled to the first elongated opening of the housing; and
the second bar hanger assembly coupled to the second elongated opening of the housing,
wherein each of the first bar hanger assembly and the second bar hanger assembly comprises:
a bar hanger holder; and
a set of bar hangers.

11. The housing assembly of claim 10, wherein the vertical adjustment of the housing is sufficient to accommodate a drywall panel having a thickness ranging between about 0.5 inches to about 1.75 inches.

12. The housing of claim 2, wherein:
the bottom component has a first exterior width; and
the top component has a second exterior width less than the first exterior width.

13. The housing of claim 2, wherein the bottom component further comprises a plurality of notches disposed on a bottom end of the first sidewall.

14. The housing of claim 2, further comprising:
a ground cable directly coupled to the base end of the bottom component.

15. The housing of claim 2, wherein:
the housing has an exterior width between about 4 inches and about 4.5 inches; and
the housing has an exterior height between about 4 inches and about 5 inches.

16. A housing for a lighting system, the housing comprising:
a bottom component defining a lower cavity; and
a top component directly coupled to the bottom component via a plurality of fasteners, the top component defining an upper cavity adjoining the lower cavity, the top component comprising:
a base end;
a second sidewall joined to the base end and surrounding the upper cavity, the second sidewall comprising a plurality of flat sections; and
a plurality of tabs joined to a bottom end of the second sidewall, each tab of the plurality of tabs having a fastener opening to receive a corresponding fastener of the plurality of fasteners.

17. The housing of claim 16, wherein each tab of the plurality of tabs is directly coupled to a corresponding flat section of the plurality of flat sections.

18. The housing of claim 16, wherein the top component further comprises:
a first pair of Romex knockouts disposed on the base end next to a first flat section of the plurality of flat sections;
a second pair of Romex knockouts disposed on the base end next to a second flat section of the plurality of flat sections located opposite the first flat section;
a first circular knockout disposed on the base end between the first pair of Romex knockouts and the second pair of Romex knockouts; and
a second circular knockout disposed on a third flat section of the plurality of flat sections.

19. A housing for a lighting system, the housing comprising:
a bottom component defining a lower cavity, the bottom component comprising:
a first sidewall surrounding the lower cavity, the first sidewall being shaped as a cylinder, the first sidewall comprising:
a first elongated opening configured for attachment to a first bar hanger assembly; and
a second elongated opening disposed diametrically opposite to the first elongated opening and configured for attachment to a second bar hanger assembly,
the first elongated opening and the second elongated opening are configured to facilitate vertical adjustment of the housing with respect to the first bar hanger assembly and the second bar hanger assembly; and
a top component directly coupled to the bottom component via a plurality of fasteners, the top component defining an upper cavity adjoining the lower cavity, the top component comprising:
a base end;
a second sidewall joined to the base end and surrounding the upper cavity, the second sidewall comprising a plurality of flat sections;
a plurality of tabs, each tab of the plurality of tabs being directly coupled to a corresponding flat section of the plurality of flat sections and having a fastener opening to receive a corresponding fastener of the plurality of fasteners;
a first pair of Romex knockouts disposed on the base end next to a first flat section of the plurality of flat sections;
a second pair of Romex knockouts disposed on the base end next to a second flat section of the plurality of flat sections located opposite the first flat section;
a first circular knockout disposed on the base end between the first pair of Romex knockouts and the second pair of Romex knockouts;
a second circular knockout disposed on the base end between the first pair of Romex knockouts and the first circular knockout;
a third circular knockout disposed on a third flat section of the plurality of flat sections;
a fourth circular knockout disposed on a fourth flat section of the plurality of flat sections located opposite the third flat section; and
a ground connection feature disposed on the base end and configured to connect a ground cable to the housing,
wherein:
the bottom component has a first exterior width; and
the top component has a second exterior width less than the first exterior width.

20. The housing of claim 19, wherein:
the bottom component further comprises:
a first pair of diametrically opposed notches disposed on a bottom end of the first sidewall;
a second pair of diametrically opposed notches disposed on a bottom end of the first sidewall,
the first pair of notches and the second pair of notches dividing the bottom end into equal quadrants;
the housing further comprises:
a ground cable directly coupled to the ground connection feature of the base end;
the housing has an exterior width between about 4 inches and about 4.5 inches; and
the housing has an exterior height between about 4 inches and about 5 inches.

21. A housing assembly, comprising:
the housing of claim 20,
the first bar hanger assembly coupled to the first elongated opening of the housing; and
the second bar hanger assembly coupled to the second elongated opening of the housing,
wherein:
each of the first bar hanger assembly and the second bar hanger assembly comprises:
a bar hanger holder, and
a set of bar hangers; and
the vertical adjustment of the housing is sufficient to accommodate a drywall panel having a thickness ranging between about 0.5 inches to about 1.75 inches.
